(19) United States
(12) Patent Application Publication
(10) Pub. No.: US 2011/0139617 A1
(43) Pub. Date: Jun. 16, 2011

(54) FUNCTIONAL LAYERS OF BIOMOLECULES AND LIVING CELLS, AND A NOVEL SYSTEM TO PRODUCE SUCH

(75) Inventors: Jan FRANSAER, Leefdaal (BE); Malika Ammam, Colombes (FR)

(73) Assignee: Katholieke Universiteit Leuven, K.U.Leuven R&D, Leuven (BE)

(21) Appl. No.: 12/945,606

(22) Filed: Nov. 12, 2010

Related U.S. Application Data
(63) Continuation-in-part of application No. PCT/EP2009/062471, filed on Sep. 25, 2009.
(60) Provisional application No. 61/195,427, filed on Oct. 6, 2008.
(60) Provisional application No. 61/195,557, filed on Oct. 7, 2008.
(60) Provisional application No. 61/321,423, filed on Apr. 6, 2010.
(60) Provisional application No. 61/332,480, filed on May 7, 2010.

(30) Foreign Application Priority Data
Oct. 6, 2008 (GB) 0818310.5
Oct. 7, 2008 (GB) 0818332.9
Oct. 28, 2008 (GB) 0819715.4
Jun. 1, 2009 (GB) 0909379.0

(51) Int. Cl. G01N 27/327; C25D 1/12; C25D 13/18

(52) U.S. Cl. 204/403.14; 204/477; 204/622

(57) ABSTRACT

The present invention concerns a new process for depositing a thick compact layer of biomolecules for instance such a layer with thickness in the μm scale and, for depositing a thick compact layer of cells in the μm scale. The deposited layer is made by application of an unbalanced (asymmetrical) alternating voltage polarization between two electrodes to a dissolved biomolecule or cell from low conductivity solutions. The process allows the rapid manufacturing of sensors and the coating of devices with functional cells and biomolecules. Examples are provided on the preparation of functional sensors such as a glucose, a lactose sensor, a hydrogen peroxide sensor and a glutamate sensor. Examples are also provided on the deposition of eukaryoric cells such as saccharomyces cerevisiae. The examples demonstrate a process that can be applied to coat devices with biomolecules and biological cells.

### CROSS-REFERENCE TO RELATED PATENT APPLICATIONS

This application is a continuation in part of International Patent Application No. PCT/EP2009/062471, filed Sep. 25, 2009, which claims the benefit of Great Britain Application No. 0818310.5, filed Oct. 6, 2008; U.S. Provisional Application No. 61/195,427, filed Oct. 6, 2008; Great Britain Application No. 0818332.9, filed Oct. 7, 2008; U.S. Provisional Application No. 61/195,557, filed Oct. 7, 2008; Great Britain Application No. 0819715.4, filed Oct. 28, 2008; and Great Britain Application No. 0909379.0, filed Jun. 1, 2009, which are all hereby incorporated by reference. In addition, this application claims the benefit of U.S. Provisional Application No. 61/321,423, filed Apr. 6, 2010; and U.S. Provisional Application No. 61/332,480, filed May 7, 2010, which are both also hereby incorporated by reference.

### TECHNICAL FIELD OF THE INVENTION

The present invention concerns a novel procedure, system or process for rapid deposition of one or more types of biological agents such as biomolecules or cells or its components using, an unbalanced (asymmetrical) alternating voltage signal wherein the electrical field generated from the negative part of the signal is different of the electrical field generated from the positive part.

### BACKGROUND OF THE INVENTION

Immobilization of biological agents (biological molecules and cells) can be of importance in biosensors to detect the presence or the concentration of an analyte as a result of the biological recognition between the analyte or the biological ligand and the immobilized biological species such as enzymes or cells. For example, some glucose sensors are based on the rate of glucose oxidase—catalyzed oxidation of glucose by dioxygen. The rate of the reaction is measured by monitoring the formation of hydrogen peroxide or the consumption of oxygen.

Immobilization of biological agents (biomolecules or cells) with tissue response modifying properties can protect an implant or a sensor (for instance a body temperature sensor, a blood pressure sensor, a pH sensor, an oxygen sensor, a glucose sensor, a lactate sensor, or a combination comprising one or more of the foregoing sensors) after implantation from encapsulation by excess fibrous connective tissue by improper wound healing.

On the other hand immobilization of biological agents (biomolecules or cells) with antirestenosis properties can protect a translumnal implant (for instance vascular (arterial or venal) stent) after implantation from induction of excess wound healing, hyperproliferation of smooth muscle cells and restenosis.

Biomolecules such as enzymes have been immobilized using various processes such as by attachment to inorganic supporting matrix by covalent binding, adsorption, crosslinking in glutaraldehyde (U.S. Pat. No. 6,241,863), encapsulation in polymerized films or gels mixing and deposition using direct current (DC) electrical field. Deposition of enzymes based on application of a direct electrical field generally provides an easily automated and hence reproducible process for the formation of the enzyme films.

One method of over-coming problems in depositing biomolecules and biological cells such as microorganism relies on electrophoresis to promote migration of charged biological particles. In the appropriate medium, such biological particles contain positively or negatively charged moieties that are attracted to the opposing pole of a generated electrical field. Migration of the biomolecule or cell contained within the medium toward and deposition on an electrode having a polarity opposite that of the charged biomolecule. EP 0 463 859A2, U.S. Pat. No. 4,294,677, U.S. Pat. No. 5,126,024 describe electrophoretic deposition of enzymes and biological cells such as microorganism under DC field. For example in EP 0 463 859A2, relatively thick deposit of the enzyme crosslinked in glutaraldehyde can be made using high DC currents based on electrophoresis. The process for immobilizing molecules on a conductive substrate is used to produce a biosensor by electrophoresis. A biosensor electrode and a counter electrode are immersed in a container of a solution of at least one species of biomolecules. A potential difference of at least 1 volt is created between the two electrodes to permit the accumulation of the biomolecule. WO 2005/054838A2 describes an apparatus for a controlled deposition of biomolecules based on electrophoresis under DC field for the formation of monolayers in a range of 5 to 10 nm. U.S. Pat. No. 4,294,677 describes a method for electrodepositing a protein by electrophoresis onto an ion exchange membrane from a suspension in which the protein is dissolved. U.S. Pat. No. 5,126,024 discloses an apparatus and method for concentrating microorganisms from a liquid on an electrode by electrodeposition. Voltages up to 20 volts and short time deposition were used to avoid culturing of the microorganisms.

US 2008/0142366A1 describes a method of incorporating biomolecules in a thin film mounted on a substrate, with the film having a thickness of not more than about 10 microns, said method including: providing a metal structure on the substrate between the thin film and the substrate, positioning a medium containing biomolecules in contact with a side of the film remote from the metal substrate, and applying a predetermined electrical voltage between the metal substrate and the medium to cause biomolecules to migrate in an electrophoretic manner from the medium into the thin film. These known processes of immobilization of the enzyme under DC conditions and manufacturing of biosensors by prior art has many disadvantages, the preparation of such films have heretofore been relatively time-consuming because many steps for the preparation of the electrode including several formation layers such as enzyme, polymers and redox mediators are needed. Furthermore, such techniques are not readily adopted for the formation of active thick enzymatic layer (for instance layers with an average thickness in the high nm range (above 100 nm) or in the micrometer range or a layer that is larger or thicker than a monolayer or that contains multiple monolayers (a monolayer being a single, closely packed layer of atoms, molecules, particles or cells).

WO 2004/033724A describes a method of forming coatings of at least two different coating molecules on at least two electrodes, the method comprising: (a) providing an array of at least two individually-addressable electrodes, (b) allowing a layer of a masking molecule to adsorb onto all electrodes, (c) inducing electrochemical desorption of the masking molecule from at least one but not all electrodes to expose a first set of exposed electrodes, (d) allowing a first coating molecule to adsorb onto the first set of exposed electrodes, (e) exposing all electrodes to a masking molecule to allow adsorption of the masking molecule onto all electrodes, (f) inducing electrochemical desorption of masking molecule from a second set of electrodes to expose a second set of exposed electrodes, (g) allowing a second coating molecule to adsorb onto the second set of exposed electrodes. WO 2004/033724A further describes a preferred embodiment in which step (b) and/or step (d) also comprise application of an AC or DC electric field in order to induce orientation of the molecules being adsorbed.

Prior art methods employing DC electrical field have several shortcoming such as high porosity of the deposited film and significant decrease in the activity of the biomolecules or cells after deposition. The higher DC current or voltages leads to electrolysis of water and generation of hydrogen and oxygen gas, which will be in competition with the deposition of the biological particles. Formation of deposits with low DC current is slow and very time consuming. Depending on the applied potential, two different cases can be considered. First, at relatively low potentials or currents, porous films can be deposited on substrates. However, when the potential values are high enough, water electrolysis becomes the dominant process, which removes the particles wanting to adhere and deposit onto the electrode surface. The porosity of the deposited biofilms can be a problem in some application such as in biosensors, biobatteries or implants that require smooth coatings or compact biofilms or functional biological layers. For example, porous films allow the diffusion of the interferences to the electrode, while a compact biofilm helps to prevent or decrease the diffusion of these undesirable electroactive species. On the other hand, high DC voltages or currents decrease the activity of the biological deposited species. Recently, (HO S. Y. et al., Journal of Food Engineering. 1997, vol. 31, no 1, pp. 69-84) reported that the activity of some enzymes including glucose oxidase, lipase and α-amylase decreases by 70-85% after pulse treatment with high DC voltage. The decrease in the activity is probably due two important factors, the generated heat and change in the local pH due to the generated protons and hydroxyls from the electrolysis of water. Thus higher temperature and change in the acidity of the solution especially near the electrode can be a source of the denaturalization of the enzyme.

Aqueous deposition has, however, been studied by numerous researches and some solutions for the electrolysis problem have been published. J. Tabellion et al. in Materials Science volume 39, pages 803-811 (2004) proposed separating the reaction and deposition fronts; by means of a membrane; T. Uchikoski et al. in Journal of Materials Research volume 16, pages 321-324 (2001) proposed the use of palladium electrodes to absorb the hydrogen formed; Sakurada in Journal of the Ceramic Society of Japan volume 112, pages 156-155 (2004) proposed the addition of chemicals to suppress the electrolysis reaction; and R. C. Hayward et al. in Nature, volume 404, pages 56-59 (2000) and M. Bohmer in Langmuir, volume 12, pages 5747-5750 (1996) proposed lowering the voltages below the threshold for water electrolysis. With the first two solutions, the production of coatings is impractical because the deposit is not formed on the electrode, or the expensive electrode material is not suitable or economically infeasible as substrate material. The use of specialty chemicals is expensive and difficult to control. R. C. Hayward et al. and M Bohmer have reported high quality deposits from aqueous systems at low voltages. However, despite the high quality of the deposits claimed using these techniques they display low deposition rates (e.g. 30 minutes to form a mono-layer). Y. Hirata et al. in Journal of the Ceramic Society of Japan, volume 99, 108-113 (1991) reported the use of symmetric AC signals to form deposits by EPD from aqueous suspensions at high frequencies, but the deposition rate was extremely low and seemed to be controlled by the diffusion of alumina in the suspension.

JP 52-056143A describes alternating current electrodeposition coating using an aqueous paint containing a salt of a purified polycarboxylic acid resin as binder.

DD 215338 A1 describes electrophoretic precipitation from a suspension using asymmetrical alternating voltage in which the negative portion is 1 to 25% of the maximum value of the positive voltage (by superimposing DC signal onto an AC signal) to improve coating e.g. of ceramic moulds. As a result unwanted electrochemical reactions were slowed down, yet not fully stopped. DD 215338A1 reported that the electrochemical dissolution of the electrodes was reduced.

GB 253091A describes a method of depositing-organic material electrically on or in a fabric which comprises placing the fabric on the outer surface of a gas-permeable anode in contact with an aqueous electroconducting emulsion of the organic material to be deposited, passing a depositing current through the emulsion and the anode and withdrawing the gas formed at the outer surface of the anode through the anode by causing a lower pressure to be exerted on its inner surface than on its outer surface. GB 253091A further stated that the current should preferably be an effectively unidirectional one, it may be a current of constant value, or a direct current of pulsating character and in some instances it is useful to employ an unbalanced alternating current, which is most conveniently obtained by superimposing an alternating current upon a direct current.

U.S. Pat. No. 1,589,327 describes a process of depositing a cellulosic compound on an electroconducting surface of an object, which comprises the steps of bringing said surface into contact with an electroconducting emulsion containing droplets of the cellulosic compound and passing a depositing electric current through said surface and emulsion. U.S. Pat. No. 1,589,327 further describes that for some purposes it may be convenient to employ a considerably unbalanced alternating current.

### Glucose Sensors:

The efforts to develop and improve glucose sensors, particularly based on amperometry, have been made over four decades since Clark and Lyons in 1962 in Ann. N.Y. Acad. Sci., volume 102, pages 29-45, reported the first enzyme electrode. The majority of glucose sensors, especially those used for in vivo applications are based on the oxidation of glucose by dioxygen using glucose oxidase as a catalyst, where the rate of the reaction is measured by monitoring the formation of hydrogen peroxide or the consumption of oxygen. From an application standpoint, the final goal of biosensor technology lies in designing high-performance sensors with appropriate characteristics such as sensitivity, selectivity, response time, linear range, stability and reproducibility. For the sensitivity, the key factor is the strategy employed for the immobilization of enzyme on the electrode surface. One method relies on the electrochemical deposition of the enzyme as reported in 1996 by M. C. Shin et al. in Biosens. Bioelectron,. volume 11, pages 161-169 and pages 171-178; in 2001 by S. Bharathi et al. in Analyst, volume 126, pages 2067-2071; and in 2002 by N. Matsumoto et al. in Anal. Chem., volume 74, pages 362-367 and by X Chen et al. in Anal. Chem., volume 74, pages 368-372, because of the ease and control of the manufacturing process. Usually, the fabrication of the sensor based on electrochemistry involved a step of electropolymerization used to eliminate the interferences such as ascorbate, urate and certain drugs, i.e. acetaminophen.

The electrochemically mediated fabrication of biosensors based enzyme-polymer can be accomplished in three different ways: (i) a polymer layer is formed directly on the electrode by electropolymerization of monomers such as pyrrole, phenol or aniline before the enzyme deposition as reported in 1993 by B. F. J. Yon-Hin et al. in Anal. Chem., volume 65, pages 2067-2071; in 1996 by Z. Zhang et al. in Anal. Chem., volume 68, pages 1632-1638; and in 2000 by R. Garjonyte et al. in Biosens. Bioelectron., volume 15, pages 445-451; (ii) The polymer is electropolymerized after the enzyme deposition as reported in 1991 by R. J. Geise et al. in Biosens, Bioelectron., volume 9, pages 151-160; in 1995 by S Eddy et al. in Biosens. Bioelectron., volume 10, pages 831-839; in 1998 by W. Cho et al. in Anal. Chem., volume 70, pages 3946-3951; and in 2002 by X Chen et al. in Anal. Chem., volume 74, pages 368-372; (iii) Entrapment of enzyme in a growing polymer by co-polymerization of enzyme and polymer as reported in 1992 by D. Centonze et al. in J. Anal. Chem., volume 342, pages 729-733; J. P. Lowry et al. in Anal. Chem., volume 66, pages 1754-1761; in 1995 by F. Palmisano et al. in Anal. Chem., volume 67, pages 1005-1009; and in 1999 by J. C. Vidal et al. in Anal. Chim. Acta., volume 385, pages 213-222. It is well know that the presence of polymers in the enzyme film is a very efficient mean for interferences elimination, i.e. high selectivity. However, usually, this leads typically to a sensor of moderate activity. Electrophoretic deposition (EPD) is an attractive process because it allows formation of thick enzymatic layers, which might be efficient, on the one hand, for the enzyme activity and, on the other hand, because the enzyme layer is thick and compact, a major part of the interferences can be rejected as reported online on Jul. 1, 2009 by M. Ammam et al. in Biosens Bioelectron., volume 25, pages 191-197. The basic principle of the electrophoretic deposition process implies the use of direct current (DC). This, however, restricts the process to either the use of non-aqueous solvents, which is not adequate for the enzyme or use of low DC voltages in order to prevent electrolysis of water, which results in low deposition rates as reported in 1995 by G. M. Im et al. in Sens. Actuators B, volume 24, pages 149-155, and in 2002 by N. Matsumoto et al. in Anal. Chem., volume 74, pages 362-367.

In the present application, we show that high voltages can be used in aqueous systems for the production of thick compact enzyme layers if an asymmetrical alternating current (AC) source is used. The non-linear dependence between electric field and the electrophoretic mobility causes a net migration of the enzyme to one of the electrodes as reported in 2005 by A. S. Dukhin et al. in Electrophoresis, volume 26, pages 2149-2153. This method was used to manufacture a glucose sensor. The high thickness of the deposited enzyme under asymmetrical alternating current electrophoretic deposition (ACEPD) leads to the rejection of a big part of the interferences, thus eliminating the need for the use of a permselective membrane. The procedure is rapid, easy and can be automated for the large scale manufacturing of such sensors. The second and the final step in the sensor preparation involves the application of an outer layer of polyurethane, which is deposited by spray-coating, in order to optimize the linearity of the sensor response and, especially to provide a biocompatible interface for in vivo applications as reported by D. S. Bindra et al. in 1991 in Anal. Chem., volume 63, pages 1692-1696.

### Lactose Sensors:

Lactose is a disaccharide that consists of galactose and glucose fragments bonded through a β-1→4 glycosidic linkage. It is present most notably in milk and makes up around 2-8% of milk (by weight), although the amount varies among species and individuals. For example, the lactose percentage found in milk of healthy humans might reach 8% as reported by L. A. Nommsen et al. in Am. J. Clin. Nutr. 53 (1991) 457-465, and the level of lactose in unprocessed milks from animals such as cow, goat, buffalo, yak and sheep are respectively about 4.7%, 4.1%, 4.86%, 4.93%, and 4.6% according to A. Sharif et al. in Int. J. Agri. Biol. 9 (2007) 267-270; W. Heine et al. in Acta Paediatrica 66 (2008) 699-703; X. P. Jiang et al. in J. Appl. Genet. 45 (2004) 215-224; T. Peeva in Bulg. J. Agric. Sci. 7 (2001) 329-335; and N. Chaiyabuter et al. in Br. J. Nurr. 45 (1981) 149-157. In industry, determination of lactose in milk and dairy products is important since the lactose content is a basic indication for evaluating milk quality and detecting abnormal milk. In this regard, it has been reported by A. Sharif et al. in Int. J. Agri. Biol. 9 (2007) 267-270 that milk from cows suffering from mastitis shows lower lactose levels. On the other hand, the precise control of the amount of lactose in dairy food products is very important, as most people are unable to digest the sugar. This medical condition is called lactose intolerance, which is related to the inability to metabolize lactose into galactose and glucose, because of a lack of the required enzyme lactase (β-galactosidase) in the digestive system, see D. M. Paige et al. in Chapter 12, pp 191-206, ACS Symposium Series, Vol. 15, 1975. Therefore, the precise determination of lactose is important for industry and public health. Many methods have been developed for lactose determination including physical methods such as gas, liquid, and high-pressure liquid chromatography [see J. S. Smith et al. in J. Food Sci. 51 (1986) 1373-1375; H. F. Betschart et al. in J. Chromatogr. 299 (1984) 498-502; and M. T. Yang et al. in J. Chromatogr. 209 (1981) 316-322], gravimetric analysis [see R. Kern et al. in J. Schormuller (ed) Handbuch der lebensmittelchemie. Springer, Berlin Heidelberg, New York, pp 226-233], titrimetry by chloramine-T method [see International dairy Federation Standard 28A: Determination of the lactose content of milk (1974), International Dairy Federation, Brussels] and infrared spectroscopy [see D. A. Biggs et al. in Int. Dairy Fed. 208 (1987) 21-30]. However, many of these methods are complex, expensive and time consuming.

Electrochemical methods are advantageous over the other methods in terms of cost and time. In the last decade, the immobilization of enzymes on electrodes for the design of amperometric biosensors for lactose determination has been an area of intense research. Several types of enzymatic electrodes have been developed for lactose, based on two immobilized enzymes, β-galactosidase and glucose oxidase. The enzymes were immobilized on a Clark-type oxygen electrode [see L. C. Jr. Clark et al. in Ann. N.Y. Acad. Sci. 102 (1962) 29-45; M. Filipiak et al. in Biosens. Bioelectronics 11 (1996) 355-364; and E. Watanabe et al. in Biotech. Bioeng. 38 (1991) 99-103], on a commercial hydrogen peroxide sensor [see J. L. Garcia et al. in Enzyme Microb. Technol. 13 (1991) 672-675] or on Pt electrode [see J. Abdulhamid et al. in Analyst 14 (1989) 1587-1592]. In these types of biosensors, the electrochemical response is based on direct measurement of peroxide. In another type, the enzymes are attached to electrodes and a mediator, such as benzoquinone, is present in the solution [see M. Tessema et al. in Anal. Chim. Acta 310 (1995) 161-171]. Enzymes have also been immobilized onto electrodes together with a mediator such as tetrathiafulval-inium tetracyanoquinodimethanide that reacts with glucose oxidase [see J. W. Albery et al. in J. Electroanal. Chem. 325 (1992) 83-93 and P. D. Hale et al. in Anal. Chem. 63 (1991) 677-682]. The mediators increase the rate of the enzymatic reaction and amplify the electrochemical signal. All these modification methods have their advantages and disadvantages.

M. Ammam et al. in Biosensors and Bioelectronics 25 (2009) 191-197; in Sensors and Actuators B: Chemical, 145 (2010) 46-53; and in Biosensors and Bioelectronics 25 (2010) 1597-1602 described glucose and glutamate sensors based on deposition of glucose oxidase and glutamate oxidase on the transducer platinum electrode using asymmetrical alternating current electrophoretic deposition (AC-EPD), and showed that this method was good to manufacture sensors with improved characteristics. They demonstrated that compared to other electrochemical deposition methods, thick and highly active layers of enzyme could be deposited.

Thus, there is a need in the art for a process of preparing biological active layers, coatings or biological films which can be prepared fast and have at least one or a combination of the following features: enhanced activity, thick, compact, long time stability and non cytotoxic, thus recommended for in vivo applications.

### SUMMARY OF THE INVENTION

The present invention concerns a novel procedure, system or method for rapid deposition of one or more types of biological agents such as biomolecules or cells or its components using, an unbalanced (asymmetrical) alternating voltage signal wherein the electrical field generated from the negative part of the signal is different of the electrical field generated from the positive part but of which, the integral of the AC-signal over one period is zero whereby the signal has no net DC component or, the integral of the AC-signal over one period is zero and a coating of functional biomolecules and biological cells obtainable by this method and the use of such method for producing functional bio devices such as sensing devices (e.g. analyte sensing devices or sensors), bio implants, bio batteries.

The AC-EPD process can be used to manufacture bi-enzyme films by deposition of a mixture of the two enzymes. For example a lactose sensor can be realised by the simultaneous deposition of two enzymes, β-galactosidase (β-Gal) and glucose oxidase (Gox). The triangular asymmetrical AC-waveform was found to provide a higher current response compared to sine and square waves. Surprisingly deposition from low conductivity solutions results in high sensitivity sensors. Using low conductivity solutions, the optimal deposition parameters of 30 Hz, 120 Vₚ₋ₚ, 30 min and the optimal testing conditions of pH 4.9 and 30° C., the sensor provided a sensitivity of up to 111 nA/mM·mm², which is surprisingly high considering the low activity of the enzymes used (9 units/mg for β-Gal and 5.6 units/mg for GOx). Moreover, the sensor has a large linear range up to 14 mM lactose, fast response time (˜8 s) and reasonable stability without employing any stabilizers or outer polymer membrane. Furthermore, it is easy and simple to manufacture, highly reproducible and cheaper because low activity enzymes can be used and is demonstrably accurate when used for the amperometric determination of lactose in milk samples.

In accordance with the purpose of the invention, as embodied and broadly described herein, the invention concerns the electrophoretic deposition of biological agents on a substrate. The present invention solves the problems of the related art of depositing biological agents from aqueous solutions by subjected the biological agents (biomolecules or cells) in fluid, usually an aqueous solution, to an unbalanced (asymmetrical) alternating voltage signal generated between a working electrode and a counter electrode under control of a signal generator adapted to generate such an unbalanced (asymmetrical) alternating voltage signal, wherein the electrical field generated from the negative part of the signal is different of the electrical field generated from the positive part for example for depositing a coating of biomolecules on such cardiovascular implants of biomolecules that induce the in vivo seeding of endothelial cells. Another aspect of the invention is depositing enzymes on a substrate by electrophoretic deposition. The enzymes and working electrode in an aqueous solution are subjected to an unbalanced (asymmetrical) alternating voltage signal generated by a signal generator, adapted to generate such unbalanced (asymmetrical) alternating voltage signal.

The present invention provides such biofilms. In addition, the present invention demonstrates that by submission of different species of biological materials dissolved or suspended in a liquid, preferably an aqueous solution, to an asymmetric AC field of which the integral of the AC signal over one period is zero (whereby the signal has no net DC component), helps to preserve the activity and smooth films and deposits can be produced.

The present invention provides a new immobilisation method for microorganisms, since unbalanced AC electrophoretic deposition permits the formation of thick layers of any microorganism in a short period of time e.g. deposition of Saccharomyces cerevisiae (SC) cells at 30 Hz and 200 Vₚ₋ₚ permits the formation of 75.9 μm thick cell layers in 30 minutes.

The coating process, according to the present invention, is used to manufacture a glucose sensor. The thickness and compactness of the deposited enzyme under asymmetrical AC-signal permits the rejection of a big part of the interferences, thus eliminating the need for the use of a permselective membrane. The procedure is rapid, easy and automated manufacturing of the sensor and, because no polymers or mediators are employed for the stabilization of the enzyme, the sensor is probably suitable for in-vivo applications.

A particular embodiment of the present invention is the coating of implantable medical devices such as, medical implants or the manufacture of a medical implant for instance an implantable sensor that comprises a coating of biological agents, which in a condition of implantation and tissue contact prevents fibrosis. A biological agent selected from the group consisting of enzymes, organic catalysts, ribozymes, organometallics, proteins, glycoproteins, peptides, polyamino acids, antibodies, nucleic acids, steroidal molecules, antibiotics, antimycotics, cytokines, carbohydrates, oleophobics, lipids, viruses, and prions can be coated by unbalanced (asymmetrical) alternating voltage EPD on the implant.

In accordance with the purpose of the invention, as embodied and broadly described herein, the invention concerns the electrophoretic deposition of biological agents on a substrate. The present invention solves the problems of the related art of depositing biological agents from aqueous solutions by subjected the biological agents (biomolecules or cells) in fluid, usually an aqueous solution, to an unbalanced (asymmetrical) alternating voltage signal generated between a working electrode and a counter electrode under control of a signal generator adapted to generate such an unbalanced (asymmetrical) alternating voltage signal (FIG. 1).

A first aspect of the present invention is realised by a coating process comprising the steps of: a) immersion of a conductive substrate in an aqueous dispersion with a conductivity lower than 100 μS/cm, said aqueous dispersion containing at least one biological agent, and b) application of an unbalanced (asymmetrical) AC signal between a counter electrode and said conductive substrate at defined frequency and amplitude between said counter electrode and said conductive substrate to induce said at least one biological agent to migrate electrophoretically, accumulate and form a bioactive deposit or bioactive coating on said conductive substrate over a period of time, wherein said bioactive deposit or bioactive coating is a biologically active film with a stacking of more than one monolayer. The counter electrode is preferably also immersed in the aqueous dispersion. An electrical field must be realised between the counter electrode and the electrode in the aqueous medium comprising charged, partially charged or self-charging organic or metallo-organic molecules or colloidal particles for electrophoretic deposition to occur. This can also be realised with the counter electrode outside the vessel containing the aqueous medium, if an electric field can still be realised between the counter electrode and the electrode in the medium.

A second aspect of the present invention is realized by an EPD system for electrocoating a conductive substrate, said system comprising a power supply connected to a signal generator to generate an unbalanced (asymmetrical) alternating current (AC) signal with a frequency in the range of 15 to 80 Hz and an amplitude of 80 to 300 Vp-p and preferably with a frequency in the range of 30 to 50 Hz and an amplitude of 160 to 200 Vₚ₋ₚ and, furthermore comprises a control system connected to signal generator for determining the parameters of the unbalanced (asymmetrical) AC, wherein said system is for electrocoating a conductive substrate with at least one bioactive layer, or bioactive coating comprising at least one type of a biological agent at a controllable average thickness above 100 nm, from a suspension in a aqueous working medium of one or more type of biological agents.

A third aspect of the present invention is realized by an EPD system for electrocoating a conductive substrate, said system comprising a amplifier connected to a function generator to generate an unbalanced (asymmetrical) alternating current (AC) signal with a frequency in the range of 15 to 80 Hz and an amplitude of 80 to 300 Vₚ₋ₚ and, preferably with a frequency in the range of 30 to 50 Hz and an amplitude of 160 to 200 Vₚ₋ₚ and furthermore comprises a control system connected to signal generator for determining the parameters of the unbalanced (asymmetrical) AC, wherein said system is for electrocoating a conductive substrate with a stacking of more than one bioactive monolayer comprising at least one type of a biological agent at a controllable thickness from a suspension in a aqueous working medium comprising one or more type of biological agents.

A fourth aspect of the present invention is realised by the use of the above-mentioned process or of the above-mentioned systems to form smooth deposits of at least one biological agent on a conductive substrate, for instance an implant, said smooth deposits having no visible defects and having a surface with a Ra of 10 to 50 μm, preferably a Ra of 10 to 10000 nm, more preferably a Ra of 10 to 500 nm, and most preferably a Ra of 10-200 nm.

A fifth aspect of the present invention is realised by the use of the above-mentioned process or of the above-mentioned systems in the manufacture of a biobattery, wherein electrodes of a biobattery are coated.

A sixth aspect of the present invention is realised by the use of the above-mentioned process or of the above-mentioned systems in the manufacture of a sensor, wherein said conductive substrate is a sensor electrode, said at least one biological agent is at least one enzyme and said thereby coated sensor electrode is used for detecting an analyte.

A seventh aspect of the present invention is realised by a sensor comprising an electrode with a electrophoretically deposited enzyme layer on said surface thereof and a layer of polyurethane coating in this order, wherein said electrophoretic deposition is realised with an unbalanced (asymmetrical) AC signal between a counter electrode and said electrode at defined frequency and amplitude between said counter electrode and said conductive substrate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The present invention will become more fully understood from the detailed description given herein below and the accompanying drawings which are given by way of illustration only, and thus are not limitative of the present invention, and wherein: The detailed description particularly refers to the accompanying figures in which:

FIG. 1 is a drawing of the setup and equipment used for the electrophoretic deposition of the enzymes and cells, where 1 is a function generator, 2 is an amplifier, 3 is an oscilloscope, 4 is a potential divider, 5 is output, 6 is common, 7 is the working electrode, 8 is the enzyme solution and 9 is the counter electrode;

FIG. 2A is a typical example of the unbalanced (asymmetrical) triangular waveform as amplitude, AM, versus time, t, mostly used in the present invention;

FIG. 2B is a typical example of the unbalanced (asymmetrical) sine waveform as amplitude, AM, versus time, t;

FIG. 2C is a typical example of the unbalanced (asymmetrical) square waveform as amplitude, AM, versus time, t;

FIG. 2D is a typical example of the symmetrical triangular waveform as amplitude, AM, versus time, t;

FIG. 3A is a typical example of the current, I, versus time, t, response to 0.1 mM of PA (acetaminophen), UA (uric acid) and AA (ascorbic acid) on a platinum disk electrode 1 mm in diameter showing interference on the standard platinum electrode;

FIG. 3B is a typical example of the current, I, versus time, t, response to 0.1 mM of PA (acetaminophen), UA (uric acid) and AA (ascorbic acid) and successive injections of 5 mM glucose (Glu) on a platinum disk electrode modified by glucose oxidase (5.6 units/mg) deposit; conditions: 25 min alternating current electrophoretic deposition (AC-EPD) using the unbalanced (asymmetrical) triangular waveform (FIG. 2A) at 30 Hz and 160 Vₚ₋ₚ;

FIG. 3C is a typical example of the current, I, versus time, t, response to 0.1 mM of PA (acetaminophen), UA (uric acid) and AA (ascorbic acid) and successive injections of 5 mM Glu (glucose) on platinum disk electrode modified by glucose oxidase (200 units/mg) deposit; conditions: 20 min AC-EPD using the unbalanced (asymmetrical) triangular waveform (FIG. 2A) at 30 Hz and 160 Vₚ₋ₚ;

FIG. 3D is a typical example of the current, I, versus time, t, response to 0.1 mM of PA (acetaminophen), UA (uric acid) and AA (ascorbic acid) and successive injections of 5 mM Glu (glucose) on platinum disk electrode modified by glucose oxidase (5.6 units/mg) deposit; conditions: 20 min AC-EPD using the unbalanced (asymmetrical) triangular waveform (FIG. 2A) at 30 Hz and 160 Vₚ₋ₚ+10 V offset DC;

FIG. 4A is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 5 min AC-EPD using the unbalanced (asymmetrical) triangular waveform (FIG. 2A) at 30 Hz and 160 Vₚ₋ₚ;

FIG. 4B is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 15 min AC-EPD using the unbalanced (asymmetrical) triangular waveform (FIG. 2A) at 30 Hz and 160 Vₚ₋ₚ;

FIG. 4C is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 30 min AC-EPD using the unbalanced (asymmetrical) triangular waveform (FIG. 2A) at 30 Hz and 160 Vₚ₋ₚ;

FIG. 4D is a resume of the current, I, versus time, t, response to 0.1 mM of PA (acetaminophen) (stars), UA (uric acid) (squares) and AA (ascorbic acid) (diamonds) and first injection of 5 mM Glu (glucose) (dots) on platinum disk electrode modified by Gox (5.6 units/mg) deposit at 30 Hz and 160 Vₚ₋ₚ versus time of AC-EPD using the unbalanced (asymmetrical) triangular waveform (FIG. 2A);

FIG. 5A is a typical example of the current response to 0.1 mM of PA, UA and AA and successive injections of 5 mM Glu on platinum disk electrode modified by Gox (5.6 units/mg) deposit; conditions: 20 min AC-EPD using the unbalanced (asymmetrical) triangular waveform (FIG. 2A) at 30 Hz and 20 Vₚ₋ₚ;

FIG. 5B is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 20 min AC-EPD using the unbalanced (asymmetrical) triangular waveform (FIG. 2A) at 30 Hz and 80 Vₚ₋ₚ;

FIG. 5C is another example of the current, I, versus time, t, response to 0.1 mM of PA, UA (uric acid) and AA and successive injections of 5 mM Glu (glucose) on a platinum disk electrode modified by Gox (5.6 units/mg) deposit; conditions: 20 min AC-EPD using the unbalanced (asymmetrical) triangular waveform (FIG. 2A) at 30 Hz and 160 Vₚ₋ₚ;

FIG. 5D is a resume of the current, I, response to 0.1 mM of PA (acetaminophen) (stars), UA (uric acid) (squares) and AA (ascorbic acid) (diamonds) and first injection of 5 mM Glu (glucose) (dots) on a platinum disk electrode modified by Gox (5.6 units/mg) deposit at 30 Hz for 20 min AC-EPD using the unbalanced (asymmetrical) triangular waveform (FIG. 2A) versus the applied amplitude, AM;

FIG. 6A is a typical example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit; conditions: 20 min AC-EPD using the unbalanced (asymmetrical) triangular waveform (FIG. 2A) at 60 Hz and 80 Vₚ₋ₚ;

FIG. 6B is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 20 min AC-EPD using the unbalanced (asymmetrical) triangular waveform (FIG. 2A) at 60 Hz and 160 Vₚ₋ₚ;

FIG. 6C is a resume of the current, I, response to 0.1 mM of PA (acetaminophen) (stars), UA (uric acid) (squares) and AA (ascorbic acid) (diamonds) and first injection of 5 mM Glu (glucose) (dots) on platinum disk electrode modified by Gox (5.6 units/mg) deposit at 60 Hz for 20 min AC-EPD using the unbalanced (asymmetrical) triangular waveform (FIG. 2A) versus the applied amplitude, AM;

FIG. 7A is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 20 min AC-EPD using the unbalanced (asymmetrical) triangular waveform (FIG. 2A) at 10 Hz and 160 Vₚ₋ₚ;

FIG. 7B is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 20 min AC-EPD using the unbalanced (asymmetrical) triangular waveform (FIG. 2A) at 50 Hz and 160 Vₚ₋ₚ;

FIG. 7C is a typical example of the current, I, versus time, t, response to 0.1 mM of PA (acetaminophen), UA (uric acid) and AA (ascorbic acid) and successive injections of 5 mM Glu (glucose) on platinum disk electrode modified by Gox (5.6 units/mg) deposit; conditions: 20 min AC-EPD using the unbalanced (asymmetrical) triangular waveform (FIG. 2A) at 170 Hz and 160 Vₚ₋ₚ;

FIG. 7D is a resume of the current, I, response to 0.1 mM of PA (acetaminophen) (stars), UA (uric acid) (squares) and AA (ascorbic acid) (diamonds) and first injection of 5 mM Glu (glucose) (dots) on platinum disk electrode modified by Gox (5.6 units/mg) deposit at 160 Vₚ₋ₚ for 20 min AC-EPD using the unbalanced (asymmetrical) triangular waveform (FIG. 2A) versus the applied frequency, f;

FIG. 8A is another example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit; conditions: 20 min AC-EPD using the unbalanced (asymmetrical) triangular waveform (FIG. 2A) at 30 Hz and 80 Vₚ₋ₚ;

FIG. 8B is a typical example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit; conditions: 20 min AC-EPD using the unbalanced (asymmetrical) triangular waveform (FIG. 2A) at 80 Hz and 80 Vₚ₋ₚ;

FIG. 8C is a resume of the current, I, response to 0.1 mM of PA (acetaminophen) (stars), UA (uric acid) (squares) and AA (ascorbic acid) (diamonds) and first injection of 5 mM Glu (glucose) (dots) on a platinum disk electrode modified by Gox (5.6 units/mg) deposit at 80 Vₚ₋ₚ for 20 min AC-EPD using the unbalanced (asymmetrical) triangular waveform (FIG. 2A) versus the applied frequency, f;

FIG. 9 is a drawing of the controlled PU spray system used for the application of the outer membrane layer of polyurethane on the enzyme electrode, where 10 is the electrode, 11 is the holders, 12 is the distance between the holders and 13 is the PU spray;

FIG. 10A is a typical example of the current, I, versus time, t, response to 0.1 mM of PA (acetaminophen), UA (uric acid) and AA (ascorbic acid) and 2 successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (5 sprays);

FIG. 10B is an example of the current, I, versus time, t, response to 0.1 mM of PA (acetaminophen), UA (uric acid) and AA (ascorbic acid) and 2 successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (8 sprays);

FIG. 10C is a typical example of the current, I, versus time, t, response to 0.1 mM of PA (acetaminophen), UA (uric acid) and AA (ascorbic acid) and 2 successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (11 sprays);

FIG. 10D is a typical example of the current, I, versus time, t, response to 0.1 mM of PA (acetaminophen), UA (uric acid) and AA (ascorbic acid) and 2 successive injections of 5 mM Glu (glucose) of a platinum disk electrode modified by Gox deposit for 20 min AC-EPD using the unbalanced (asymmetrical) triangular waveform (FIG. 2A) at 30 Hz and 160 Vₚ₋ₚ, followed by PU membrane (20 sprays);

FIG. 11A is a typical example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (15 sprays);

FIG. 11B is a extrapolation of FIG. 11A representing the relationship between the amperometric response and the glucose concentration C_{Glu} for successive 5 mM Glu (glucose) injections;

FIG. 12A is a typical example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (15 sprays); the test is carried out at 50 torr oxygen partial pressure;

FIG. 12B is a resume of the current (amperometric), I, versus glucose concentration, C_{Glu}, for successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (15 sprays) at three different oxygen concentrations of 150, 50 and 30 torr respectively;

FIG. 13A is a typical example of the current, I, versus time, t, response to 0.1 mM of PA (acetaminophen), UA (uric acid) and AA (ascorbic acid) and successive injections of 5 mM Glu (glucose) on a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (15 sprays) tested on day 1;

FIG. 13B is a typical example of the current, I, versus time, t, response to 0.1 mM of PA (acetaminophen), UA (uric acid) and AA (ascorbic acid) and successive injections of 5 mM Glu (glucose) of a platinum disk electrode modified by Gox (5.6 units/mg) deposit for 20 min AC-EPD using the unbalanced (asymmetrical) triangular waveform (FIG. 2A) at 30 Hz and 160 Vₚ₋ₚ, followed by PU membrane (15 sprays) tested on day 34;

FIG. 13C is showing the stability of the sensor as current, I, versus time in days to the response to glucose (dots) and interferences (PA+UA+AA) (stars) over a period of 45 days;

FIG. 14A is a typical example of the current, I, versus time, t, response to 10 μM hydrogen peroxide injections (as indicated by arrows) on a platinum disk electrode modified by catalase deposit; conditions: 30 min AC-EPD using the unbalanced (asymmetrical) triangular waveform (FIG. 2A) at 30 Hz and 160 Vₚ₋ₚ;

FIG. 14B is a typical example of the current, I, versus time, t, response to 20 μM glutamate injections (as indicated by arrows) on a platinum disk electrode modified by glutamate oxidase deposit; conditions: 30 min AC-EPD using the unbalanced (asymmetrical) triangular waveform (FIG. 2A) at 30 Hz and 220 Vₚ₋ₚ;

FIG. 15A is a picture of the platinum electrode under an optical microscope;

FIG. 15B is a picture of the platinum electrode under the optical microscope after 10 minutes AC-EPD using the unbalanced (asymmetrical) triangular waveform (FIG. 2A) of saccharomyces cerevisiae cells at 30 Hz and 130 Vₚ₋ₚ;

FIG. 15C is a picture of the platinum electrode under the optical microscope after 30 minutes of AC-EPD using the unbalanced (asymmetrical) triangular waveform (FIG. 2A) of saccharomyces cerevisiae cells at 30 Hz and 130 Vₚ₋ₚ;

FIG. 15D is a picture of FIG. 15C at higher amplification;

FIG. 16 is typical example of the current, I, versus time, t, response to 0.1 mM of PA (acetaminophen), UA (uric acid) and AA (ascorbic acid) and successive injections of 5 mM Glu (glucose) on platinum disk electrode modified GOx deposit; conditions: 20 min AC-EPD at 30 Hz and 160 Vₚ₋ₚ;

FIG. 17 shows the mass, m, of SC cells deposited at 30 Hz and 200 Vₚ₋ₚ on a stainless steel electrode as a function of deposition time, t.

FIG. 18 shows a typical example of the current response to 0.1 mM AP, UA and AA and successive injections of 5 mM Glu. Manufacturing: 20 min AC-EPD of GOx at 30 Hz and 160Vp-p. Test in phosphate buffer solution pH 7.4 at ambient temperature. Polarization: +0.6V vs. AgCl/Ag.

FIG. 19 shows a FT-IR spectrum of the free (A) and immobilized GOx (B) towards glucose oxidation as a function of time. Immobilized GOx: 20 min AC-EPD of GOx at 30 Hz and 160Vp-p.

FIG. 20 shows the stability of GOx electrodes manufactured at 30 Hz, 160Vp-p for 20 min without an outer membrane. Test in phosphate buffer solution pH 7.4 at ambient temperature. The sensor was stored under air at room temperature. Polarization: +0.6V vs. AgCl/Ag.

FIG. 21 shows the current response of GOx electrodes without PU layer manufactured at 30 Hz, 160Vp-p for 20 min in (A) 5 mL human serum at 37° C. and (B) in 200 μL blood of sick rabbits. Polarization: +0.6V vs. AgCl/Ag.

FIG. 22 shows (A) Current response to 0.1 mM AP, UA and AA and successive injections of 5 mMGlu. Manufacturing: 20 min AC-EPD of GOx at 30 Hz and 160Vp-p followed by PU membrane (15 sprays). (B) Enlarged view of (A), showing the current response to the interferences in more detail. Test in phosphate buffer solution pH 7.4 at ambient temperature. Polarization: +0.6V vs. AgCl/Ag.

FIG. 23 shows the calibration plot of glucose concentration in human serum at 37° C. by use of the standard addition method. Manufacturing: 20 min AC-EPD of GOx (5.6 U/mg) at 30 Hz and 160Vp-p followed by 15 PU sprays. Polarization: +0.6V vs. AgCl/Ag.

FIG. 24 shows the sensor response to glucose and interferences over a period of 45 days. Manufacturing: 20 min AC-EPD of GOx (5.6 U/mg) at 30 Hz and 160Vp-p followed by 15 PU sprays. Test in phosphate buffer solution pH 7.4 at ambient temperature every 3-4 days. Sensor was stored under air at room temperature. Polarization: +0.6V vs. AgCl/Ag.

FIG. 25 shows the calibration plot of glucose concentration in human serum at 37° C. by use of the standard addition method. Manufacturing: 20 min AC-EPD of GOx (5.6 U/mg) at 30 Hz and 160Vp-p followed by 15 PU sprays. Polarization: +0.6V vs. AgCl/Ag.

FIG. 26 shows a typical example of amperometric response of the bi-enzyme electrode (β-Gal+GOx) to two injections of 1.4 mM lactose prepared using (A) triangular, (B) sine and (C) square waveform. Sensor preparation: enzyme proportions (10 mg GOx+90 mg β-Gal)/1 mL ultrapure water, deposition at 30 Hz, 120 Vₚ₋ₚ for 30 min. Test in phosphate citrate buffer solution pH 4.9 at 30° C. Polarization: +0.65 V vs. AgCl/Ag.

FIG. 27 shows the effect of pH (A) and temperature (B) on the current response to 1.4 mM lactose. Sensor preparation: enzyme proportions (10 mg GOx+90 mg β-Gal)/1 mL ultrapure water, deposition at 30 Hz, 120 Vₚ₋ₚ for 30 min using triangular waveform. Test in phosphate citrate buffer solution at different pHs and temperatures. Polarization: +0.65 V vs. AgCl/Ag.

FIG. 28 shows in: (A) Typical example of amperometric response of the bi-enzyme electrode (β-Gal+GOx) to successive injections of 1.4 mM lactose. (B) Linear relationship between sensor response and lactose concentration. Sensor preparation: enzyme proportions (10 mg GOx+90 mg β-Gal)/1 mL ultrapure water, deposition at 30 Hz, 120 Vₚ₋ₚ for 30 min using triangular waveform. Test in phosphate citrate buffer solution pH 4.9 at 30° C. Polarization: +0.65 V vs. AgCl/Ag.

FIG. 29 shows the stability of the bi-enzyme (β-Gal+GOx) electrodes manufactured at 30 Hz, 120 Vₚ₋ₚ for 30 min in absence and presence of the outer membrane of polyurethane (1 PU spray). Sensor preparation: enzyme proportions (10 mg GOx+90 mg β-Gal)/1 mL ultrapure water, deposition at 30 Hz, 120 Vₚ₋ₚ for 30 min using triangular waveform. Test in phosphate citrate buffer solution pH 4.9 at 30° C. Polarization: +0.65 V vs. AgCl/Ag. Sensor stored in air at room temperature. The sensor with PU outer layer is prepared using 1 PU spray, the procedure being previously reported by M. Ammam et al. in Sensors and Actuators B: Chemical, 145 (2010) 46-53; and in Biosensors and Bioelectronics 25 (2010) 1597-1602].

FIG. 30 shows in: (A) Current response to 50 μL whole (S1), skimmed (S2), semi-skimmed (S3) and whole extra concentrated milk (S4), respectively of the clean unmodified Pt electrode. (B) Current response to respectively 50 μL whole (S1), skimmed (S2), semi-skimmed (S3), whole extra concentrated milk (S4) and 0.05 mM glucose of Pt modified GOx. (C) Current response to respectively 50 μL whole (S1), skimmed (S2), semi-skimmed (S3), whole extra concentrated milk (S4) and 0.6 mM lactose of Pt modified (β-GAl+GOx). Sensors preparation: (B) 10 mg GOx/1 mL ultrapure water, (C) (10 mg GOx+90 mg β-Gal)/1 mL ultrapure water. Deposition at 30 Hz, 120 Vₚ₋ₚ for 30 min using triangular waveform (B and C). Test in phosphate citrate buffer solution pH 4.9 at 30° C. Polarization: +0.65 V vs. AgCl/Ag.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms “first,” “second,” “third,” and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms “top,” “bottom,” “over,” “under,” and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof. The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

The following terms are provided solely to aid in the understanding of the invention.

### DEFINITIONS

Bio agents as used herein are living cells, bio molecules, oligomers or multimers that naturally occur in living organisms such as enzymes and antibodies. On the other hand, cells are the structural and functional unit of all known living organism. It is the smallest unit of an organism that is classified as living, and is sometimes called the building block of life. Some organisms, such as most bacteria are unicellular (comprising a single cell). Other organisms, such as humans are multicellular.

The term “bio-active agent” as used herein broadly includes any compound, composition of matter, or mixture thereof, that has biological activity and can be delivered in the subject, preferably a mammal, to whom it is administered.

A biomolecule is any organic molecule that is produced by living organisms, including large polymeric molecules such as proteins, polysaccharides, and nucleic acids as well as small molecules such as primary metabolites, secondary metabolites, and natural products. As organic molecules, biomolecules comprise primarily carbon and hydrogen, nitrogen, and oxygen, and, to a smaller extent, phosphorus and sulphur. Other elements sometimes are incorporated but are much less common. Typical biomolecules are of the group of the nucleosides and nucleotides, the saccharides, lignin, lipids, amino acids, protein structures (for vitamins. A diverse range of biomolecules exist, including: small molecules (lipid, phospholipids, glycolipid, sterol, vitamin, hormone, neurotransmitter, carbohydrate, sugar, disaccharide) monomers (amino acids, nucleotides, monosaccharides), polymers (peptides, oligopeptides, polypeptides, proteins, nucleic acids, i.e. DNA, RNA oligosaccharides, polysaccharides (including cellulose) and lignin.

Nucleosides are molecules formed by attaching a nucleobase to a ribose ring. Examples of these include cytidine, uridine, adenosine, guanosine, thymidine and inosine. Nucleosides can be phosphorylated by specific kinases in the cell, producing nucleotides, which are the molecular building blocks of DNA (deoxyribonucleic acid) and RNA (ribonucleic acid). DNA or RNA have a negative charge.

The terms “polymer,” “poly,” and “polymeric” as used herein mean the product of a polymerization reaction and are inclusive of homopolymers, copolymers, terpolymers, etc., whether natural or synthetic, including random, alternating, block, graft, crosslinked, blends, compositions of blends and variations thereof.

The term “pre-polymer” refers to a low molecular weight material, such as oligomers, that can be further polymerized regardless of the mechanism of polymerization.

### Coating Process Using Unbalanced (Asymmetrical) AC-Electrophoretic Deposition (UAC-EPD)

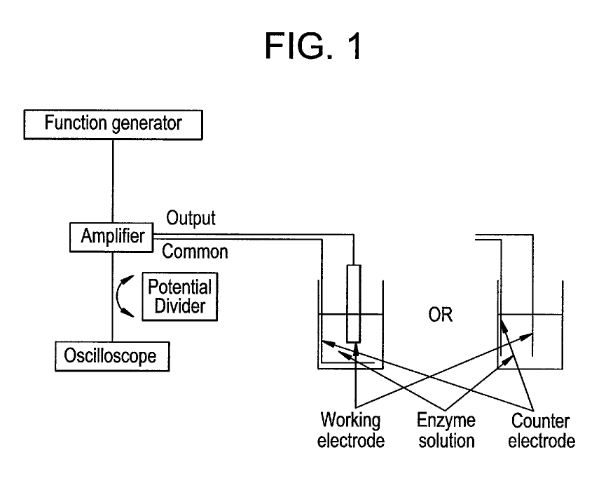

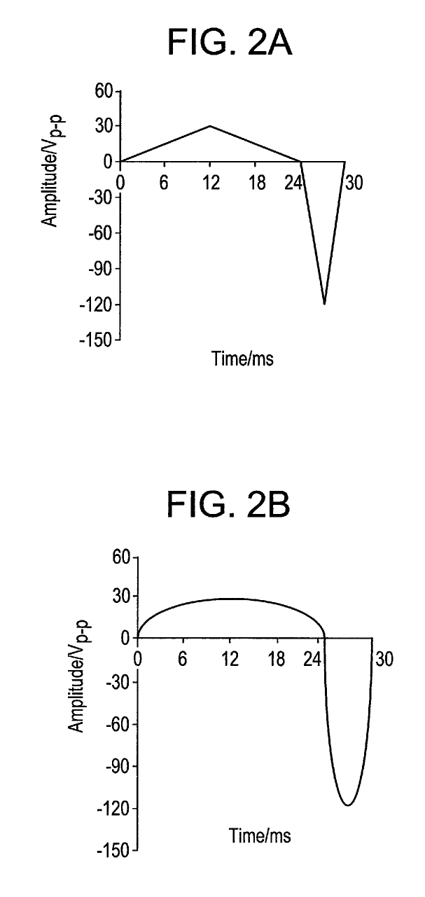

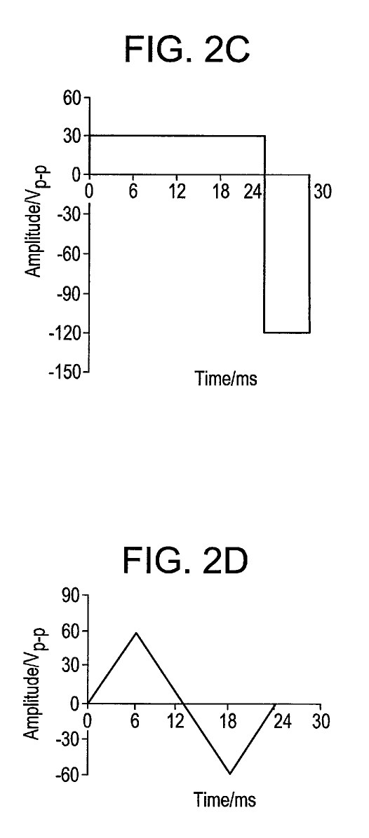

FIG. 1 gives a schematic overview of the set-up. An appropriate electrical signal is generated using a signal generator. This signal is amplified and applied across two electrodes submerged in a liquid dispersion. Appropriate electrical signal are asymmetric, such that the positive and negative parts differ in amplitude and duration in such a way that the integral of the signal over one period, which is the DC component of the signal, is zero or smaller than the electrochemical decomposition voltage of the solvent. FIGS. 2A, 2B and 2C show some examples of possible asymmetric signals. For instance, FIG. 2A is a suitable signal which consists of an unbalanced triangular waveform where the surface areas of the positive and negative triangular parts are similar, but where the amplitude and duration of the positive and negative part of the signal are different. Due to the non-linear dependence between the electrical field and electrophoretic mobility, charged biomolecules move during one period over a greater distance in one direction than the other. As a consequence, biomolecules are driven towards one of the electrodes and deposit on this electrode. However, it is clear that other forms of the unbalanced (asymmetrical) wave such as sine wave, square waves, etc. can also be used. For instance, FIG. 2B shows a suitable signal which consist of an unbalance sinusoidal waveform where the surface areas of the positive and negative sinusoidal parts are similar, but where the amplitude and duration of the positive and negative part of the signal are different. Another appropriate waveform is shown in FIG. 2C which shows an unbalance square waveform where the surface areas of the positive and negative parts are similar, but where the amplitude and duration of the positive and negative part of the signal are different. As can be understood from these examples, the precise form of the signal is not important. What is important is that the amplitudes of the positive and negative parts of the signal differ substantially such that the electrical field generated from the negative part of the signal is different from the electrical field generated from the positive part but in such a way that the integral of the AC-signal over one period is zero (and hence the signal has no net DC component).

Since the electrophoretic migration under the influence of aforementioned asymmetric signals is due to the non-linear dependence of the electrophoretic mobility on the electric field, appreciable migration only takes place when the maximum amplitudes of the positive and negative parts of the electric field differ enough, preferably by a factor of 1.5 or more. Also, the maximum amplitude of the electric field needs to be high enough so that the electrophoretic deposition proceeds at an appreciable rate. The upper limit for the applied electric field is set by the electrochemical decomposition of the solvent. Several parameters can be controlled to decrease the electrochemical decomposition of water such as lowering the conductivity of the solution, increasing the distance between the deposition and the counter electrode and strive for a current density distribution on the electrodes which is as uniform as possible. Thus for better deposition results it is recommended to use low conductivity electrolytes, a relatively large distance between the deposition electrode and the counter electrode and use electrodes with a primary current distribution that is as uniform as possible. In view of obtaining a uniform current distribution, it is recommended that the deposition electrode and the counter electrode should be as parallel as possible to each other.

As appreciable decomposition of the liquid needs to be avoided, the period of the signal needs to be small enough, so that during both the negative and the positive part of the signal, no appreciable decomposition of the solvent takes place. In water, the period of the signal is preferably smaller than 1 second.

An important feature of the deposition process consists to connect the deposition electrode (or other conductive substrates for receiving the biological agent) to the electrical pole which is polarized negatively during the high amplitude section of the signal of FIG. 2A, B or C and, connect the counter electrode to the electrical pole corresponding to the small amplitude section of the signal if the bio-molecule to be deposited is positively charged. However, if the bio-molecule to be deposited is negatively charged, the bio-molecule will migrate and deposit on the electrode which is negatively charged during the small amplitude section of the signal.

Essentially, any type of conductive medical device may be coated in some fashion with biological agents (biomolecules or cells), which enhance their biocompatibility or prevent a pathological tissue reaction after implantation may be made from virtually any biocompatible material, such as bioabsorbable or biostable biopolymers.

More particularly the present invention relates to a system and method of subjecting these biological agents (for instance a growth factor, a protein, an enzyme, a hormone, a nucleic acid, an RNA, a DNA, a gene, a vector, a phage, an antibody) or biological cells to an unbalanced (asymmetrical) alternating voltage wherein the electrical field generated during the negative part of the signal is different from the electrical field generated during the positive part but of which, the integral of the AC-signal over one period is zero (and hence the signal has no net DC component) for rapid depositing (for instance within 10 minutes, within 20 minutes or within less than 40 minutes) such biomolecules and biological cells into compact layers with maintained or enhanced activity on a conductive substrate or on a membrane positioned between the two electrodes.

The unbalanced (asymmetrical) AC signal at defined frequency and amplitude across the two electrodes causes the biological agent to migrate electrophoretically, accumulate and immobilize the biological agent on said working electrode or to form a biologically active or functional coating or a biologically active or functional film. Preferably thick films for instance in the μm scale, preferably more than 5 μm, more preferably more than 20 μm, yet more preferably more than 40 μm, yet more preferably more than 60 μm, yet more preferably more than 80 μm, yet preferably between 5 and 100 μm.

Another aspect of the invention is depositing enzymes on a substrate by electrophoretic deposition. The enzymes and working electrode in an aqueous solution are subjected to an unbalanced (asymmetrical) alternating voltage signal generated by a signal generator, adapted to generate such unbalanced (asymmetrical) alternating voltage signal.

The signal generator can comprises a controller to deliver an unbalanced (asymmetrical) AC signal at defined frequency and amplitude across the two electrodes, and cause the enzyme to migrate electrophoretically, accumulate immobilized enzyme on said working electrode, or to form a biologically active or functional coating or a biologically active or functional film of enzymes, with an average thickness in the high nm scale for instance more than 100 nm thick film, for instance in the μm scale, preferably more than 5 μm, more preferably more than 20 μm, yet more preferably more than 40 μm, yet more preferably more than 60 μm, yet more preferably more than 80 μm, yet preferably between 5 and 100 μm.

The signal generator can comprises a controller to change to deliver an unbalanced (asymmetrical) AC signal at defined frequency and amplitude across the two electrodes to cause the enzyme to migrate electrophoretically, accumulate immobilized enzyme on said the working electrode or to form a biologically active or functional coating or a biologically active or functional film of enzymes, with comprise a stack of multiple monolayers.

This process can also be used to produce a coating of immobilized biological agents on both electrodes at the same time. For instance, when both positively and negatively charged biological molecules or cells are present in the solution, the positively charged biomolecules or cells will deposit on one electrode while the negatively charged biomolecules or cells will deposit on the other electrode.

This method can also be used to produce a coating of immobilized biological agents on both electrodes at the same time. For instance, when both positively and negatively charged biological molecules or cells are present in the solution, the positively charged biomolecules or cells will deposit on one electrode while the negatively charged biomolecules or cells will deposit on the other electrode.

The method of present invention can even be used to produce and anode and cathode each with a functional film of enzymes for use in a biobattery. For instance enzyme for catalyzing an electro oxidation of a reducing agent can be deposited on an anode, and enzymes for catalyzing an electro reduction of an oxidizing agent can be deposited on a cathode, for contacting of said anode with an aqueous solution containing said reducing agent and said oxidizing agent, and said cathode with enzymes for catalyzing an electro reduction of an oxidizing agent with an aqueous solution containing a reducing agent and an oxidizing agent. If the solution is in contact with said enzymes for catalyzing an electro oxidation of a reducing agent, an electro oxidation of a reducing agent occurs and with said enzymes for catalyzing an electro reduction of an oxidizing agent, an electro reduction of an oxidizing agent occurs.

According to an preferred embodiment of the first aspect of the present invention, the counter electrode is immersed in said aqueous dispersion.

According to another preferred embodiment of the first aspect of the present invention, the unbalanced (asymmetrical) AC signal is a signal that has no net DC component or of which the net DC component is lower than the threshold value for the electrolytic decomposition of water.

According to another preferred embodiment of the first aspect of the present invention, the net DC component of the applied unbalanced (asymmetrical) AC-signal over one period is in absolute value lower than 1.23 V in order not to decompose the water.

According to another preferred embodiment of the first aspect of the present invention, the integral of the unbalanced (asymmetrical) AC-signal over one period is zero or almost zero or of which the DC component is lower than the threshold value for the electrolytic decomposition of water.

According to another preferred embodiment of the first aspect of the present invention, the unbalanced (asymmetrical) AC signal is a signal wherein the negative part of the signal is different from the positive part but of which the integral of the AC-signal over one period is zero or almost zero.

According to another preferred embodiment of the first aspect of the present invention, the unbalanced (asymmetrical) AC signal does not cause electrolysis or decomposition of water in an extend to disturb the formation of a smooth coating.

According to another preferred embodiment of the first aspect of the present invention, the biologically active film has an average thickness above 100 nm.

According to another preferred embodiment of the first aspect of the present invention, the biologically active film has an average thickness in the μm scale for instance more than 10 μm.

According to another preferred embodiment of the first aspect of the present invention, the very low conductivity is no more than 50 μS/cm.

According to another preferred embodiment of the first aspect of the present invention, the very low conductivity is no more than 30 μS/cm.

According to another preferred embodiment of the first aspect of the present invention, the applied frequency is in a range of 15 to 80 Hz, with applied frequency in the range of 30 to 50 Hz being preferred.

According to another preferred embodiment of the first aspect of the present invention, the applied amplitude is in a range of 80 to 300 Vₚ₋ₚ, with the applied amplitude in the range of 160 to 200 Vₚ₋ₚ being preferred.

According to another preferred embodiment of the first aspect of the present invention, the AC signal is applied over a period of 20 to 40 minutes to achieve more than one monolayer on said substrate.

According to another preferred embodiment of the first aspect of the present invention, the conductive (deposition) substrate is a non corrosive metal.

According to another preferred embodiment of the first aspect of the present invention, the conductive (deposition) substrate is a platinum electrode.

According to another preferred embodiment of the first aspect of the present invention, the process according to any one of the preceding claims, whereby said conductive (deposition) substrate is a biosensor electrode.

According to another preferred embodiment of the first aspect of the present invention, the at least one biological agent is a biomolecule.

According to another preferred embodiment of the first aspect of the present invention, the biological agent is a living cell or a component thereof.

According to another preferred embodiment of the first aspect of the present invention, the at least one biological agent is at least one enzyme.

According to another preferred embodiment of the first aspect of the present invention, the at least one biological agent is glucose oxidase and may further comprise β-galactosidase.

According to another preferred embodiment of the first aspect of the present invention, the at least one biological agent is β-galactosidase.

According to another preferred embodiment of the first aspect of the present invention, wherein 50 mg of Gox 5.6 units/mg enzyme is dissolved per 0.5 mL NaOH-water at conductivity lower than 100 μS/cm.

According to another preferred embodiment of the first aspect of the present invention, the thickness of the deposit is controllable.

According to another preferred embodiment of the first aspect of the present invention, the process further comprises the provision of a polyurethane coating of controllable thickness, the polyurethane coating being preferably provided by using a polyurethane spray.

### Conductive Substrates

Suitable materials to be coated by biological agents by electrophoretic deposition under an unbalanced (asymmetrical) alternating electric field are electrically conductive, and may include metals (e.g., aluminum, titanium, tantalum, niobium zirconium, antimony, chromium, cobalt, copper, gold, iron, lead, magnesium, nickel, palladium, platinum, rhodium, ruthenium, osmium, iridium, silver, tin, tungsten, zinc), metal alloys (steel, brass, bronze, etc.), semiconductors (e.g., silicon, germanium, gallium arsenide and other compound semiconductor materials), and/or conductive polymers (e.g., polypyrrole).

More particularly, this invention is related to a method for depositing biomolecules such as enzymes and biological cells onto a conductive noble substrate.

Also, material may be deposited on membranes that are placed in the electric field in between the two electrodes.

### Coating of Implants Using Unbalanced (Asymmetrical) AC-Electrophoretic Deposition (UAC-EPD)

A particular embodiment of the present invention is the coating of implantable medical devices such as, medical implants or the manufacture of a medical implant for instance an implantable sensor that comprises a coating of biological agents, which in a condition of implantation and tissue contact prevents fibrosis. A biological agent selected from the group consisting of enzymes, organic catalysts, ribozymes, organometallics, proteins, glycoproteins, peptides, polyamino acids, antibodies, nucleic acids, steroidal molecules, antibiotics, antimycotics, cytokines, carbohydrates, oleophobics, lipids, viruses, and prions can be coated by unbalanced (asymmetrical) alternating voltage EPD on the implant.

Implantable medical devices which often fail due to tissue in-growth or accumulation of proteinaceous material in, on and around the device, such as shunts for hydrocephalus, dialysis grafts, colostomy bag attachment devices, ear drainage tubes, leads for pace makers and implantable defibrillators can also benefit from coatings of the present invention. Such coating can consist of or can comprise tissue response modifiers, which as used herein are factors that control the response of tissue adjacent to the site of implantation. One facet of this response can be broadly divided into a two-step process, inflammation and wound healing. An uncontrolled inflammatory response (acute or chronic) results in extensive tissue destruction and ultimately tissue fibrosis. Wound healing includes regeneration of the injured tissue, repair (fibrosis), and in-growth of new blood vessels (neovascularization and angiogenesis). For fibrosis, the body utilizes collagen from activated fibroblasts to “patch and fill” the unregenerated areas resulting from trauma and inflammation.

Fibrosis formation or development of excess fibrous connective tissue by improper wound healing can lead to “encapsulation” or “entombment” of the implant or sensor in fibrotic tissue which is not always wanted. For instance for an implanted sensor this can lead to loss of analyte supply and loss of functionality of the sensor. A number of other responses are also included within this category, for example fibroblast formation and function, leukocyte activation, leukocyte adherence, lymphocyte activation, lymphocyte adherence, macrophage activation, macrophage adherence, thrombosis, cell migration, cell proliferation including uncontrolled growth, neoplasia, and cell injury and death. Adverse tissue responses to implantation may also arise through genetic disorders, immune diseases, infectious disease, environmental exposure to toxins, nutritional diseases, and diseases of infancy and childhood.

In particular, it is desired that bioactive substances, such as compositions of a biopolymer, bio solvent, and therapeutic biomolecules or cells, with anti fibrosis activity are used to provide implantable devices with a coating that prevents such fibrosis.

Present invention also provides a technique of asymmetric alternating current EPD for efficiently coating conductive implants with biological agents and to form biological active layers that act as tissue response modifier. Examples of such tissue response modifiers can be of the group of the peptides, polypeptides, proteins, lipids, sugars, carbohydrates, certain RNA and DNA molecules, and fatty acids, as well metabolites and derivatives of each. Tissue response modifiers may also take the form of, or be available from genetic material, viruses, prokaryotic or eukaryotic cells. The tissue response modifiers can be in various forms, such as unchanged molecules, components of molecular complexes, or pharmacologically acceptable salts or simple derivatives such as esters, ethers, and amides. Tissue response modifiers may be derived from viral, microbial, fungal, plant, insect, fish, and other vertebrate sources. More specifically exemplary tissue response modifiers include, but are not limited to neovascularization biomolecules such as cytokines. Cytokines are growth factors such as transforming growth factor alpha (TGFA), epidermal growth factor (EGF), vascular endothelial growth factor (VEGF), Placental Growth Factor (PLGF) and anti-transforming growth factor beta (TGFB). TGFA suppresses collagen synthesis and stimulates angiogenesis. It has been shown that epidermal growth factor tethered to a solid substrate retains significant mobility and an active conformation. VEGF stimulates angiogenesis, and is advantageous because it selectively promotes proliferation of endothelial cells and not fibroblasts or collagen synthesis, in contrast to other angiogenic factors. In addition to promoting wound healing, the improved blood flow resulting from the presence of neovascularization agents should also improve the accuracy of sensor measurements. Another type of tissue response modifier is a neutralizing antibody including, for example, anti-transforming growth factor beta antibody (anti-TGFB); anti-TGFB receptor antibody; and anti-fibroblast antibody (anti-CD44). Anti-TGFB antibody has been shown to inhibit fibroblast proliferation, and hence inhibit fibrosis. Because of the importance of TGFB in fibrosis, anti-TGFB receptor antibodies inhibit fibrosis by blocking TGFB activation of fibroblasts. Recent studies have demonstrated that anti-CD 44 antibody induces programmed cell death (apoptosis) in fibroblasts in vitro. Thus, use of anti-CD44 antibody represents a novel approach to inhibition of fibroblast formation, and therefore fibrosis. Other anti-proliferative agents include Mitomicyin C, which inhibits fibroblast proliferation under certain circumstances, such as after vascularization has occurred.

Such coating of the conductive implant by subjecting the tissue response modifying biological agent and the implant in a watery environment to an unbalanced (asymmetrical) alternating voltage, results in the deposition of such biological agent on said conductive medical implant until a coating has been formed. Such coating if implanted in a subject for instance a mammal and preferably a human promotes neovascularization at the implant/tissue interface, where the surface density of binding motifs has an effect on the cellular response, variation in the density of the binding motifs allows control of the response. Exemplary adhesive ligands include but are not limited to the arginine-glycine-aspartic acid (RGD) motif, and arginine-glutamic acid-aspartic acid-valine (REDV) motif, a fibronectin polypeptide. The REDV ligand has been shown to selectively bind to human endothelial cells, but not to bind to smooth muscle cells, fibroblasts or blood platelets when used in an appropriate amount. Sensors detecting body temperature, blood gases, ionic concentrations and analyte can be incorporated in the implantable sensor platform.

Devices which serve to improve the structure and function of tissue or organ may also show benefits when coated according the method of deposition of biological agents using unbalanced (asymmetrical) alternating voltage of present invention. For example, improved osteointegration of orthopaedic devices to enhance stabilization of the implanted device could potentially be achieved by combining it with biomolecules such as bone-morphogenic protein. Similarly, other surgical devices, sutures, staples, anastomosis devices, vertebral disks, bone pins, suture anchors, hemostatic barriers, clamps, screws, plates, clips, vascular implants, tissue adhesives and sealants, tissue scaffolds, various types of dressings, bone substitutes, intraluminal devices, and vascular supports could also provide enhanced patient benefit method of deposition of bio molecules and biological cells using unbalanced (asymmetrical) alternating voltage of present invention if, the biomolecules or cells render this devices more biocompatible.

Vascular grafts may be used to replace, bypass, or reinforce diseased or damaged sections of a vein or artery. These grafts can be made from coating a conductive corn or support by using unbalanced (asymmetrical) alternating voltage to deposit from a watery solution any suitable material including, but not limited to materials such as polyurethanes, absorbable polymers, and combinations or variations thereof. Or the bioabsorbable materials such as polycaprolactone (PCL), poly(lactic acid) (PLA), poly(glycolic acid) (PGA), polyanhydrides, polyorthoesters, polyphosphazenes, and components of extracellular matrix (ECM).

In other embodiments of the first aspect of the present invention, the implantable device to be coated is a covering for a self-expandable or balloon-expandable stent. This covering can be formed of materials similar to those from which the above-described graft may be formed with various types of coating substances, which may be applied to coat implantable device in accordance with the present invention. In one embodiment, the coating substance includes a polymer loaded with a therapeutic substance. The polymer or combination of polymers can be applied to a stent based on the polymer's or polymers' ability to carry and release, at a controlled rate, various therapeutic agents such as antithrombogenic or anti-proliferative drugs. The polymeric material is most suitably biocompatible, including polymers that are non-toxic, non-inflammatory, chemically inert, and substantially non-immunogenic in the applied amounts. The polymer is typically either bioabsorbable or biostable. A bioabsorbable polymer breaks down in the body and is not present sufficiently long after implantation to cause an adverse local response. Bioabsorbable polymers are gradually absorbed or eliminated by the body by hydrolysis, metabolic process, bulk erosion, or surface erosion. Examples of bioabsorbable materials include but are not limited to polycaprolactone (PCL), poly-D, L-lactic acid (DL-PLA), poly-L-lactic acid (L-PLA), poly(lactide-co-glycolide), poly(hydroxybutyrate), poly(hydroxybutyrate-co-valerate), polydioxanone, polyorthoester, polyanhydride, poly(glycolic acid), poly(glycolic acid-cotrimethylene carbonate), polyphosphoester, polyphosphoester urethane, poly (amino acids), cyanoacrylates, poly(trimethylene carbonate), poly(iminocarbonate), copoly(etheresters), polyalkylene oxalates, polyphosphazenes, polyiminocarbonates, and aliphatic polycarbonates. Biomolecules such as heparin, fibrin, fibrinogen, cellulose, starch, and collagen are typically also suitable. Examples of biostable polymers include Parylene® and Parylast® (available from Advanced Surface Technology of Billerica, Mass.), polyurethane, such as a segmented polyurethane solution containing a dimethylacetamide (DMAc) solvent developed by the Polymer Technology Group, Inc. of Berkeley, Calif., and known by the trade name BioSpan®, polyethylene, polyethlyene teraphthalate, ethylene vinyl acetate, silicone and polyethylene oxide (PEO).

Another specific embodiment of present invention is the coating of vascular implants, for instance a stent or cathether (e.g. an intracoronary balloon catheter) or a continuous blood sensor (e.g. a continuous blood glucose sensor). The method is particularly suitable for coating of transluminal implants such as vascular implant for instance a stents or vascular sensors for continuous blood sensing comprising coatings of biomolecules or cells that prevents restenosis. Typically, stents are balloon-expandable slotted metal tubes (usually, but not limited to, stainless steel), which, when expanded within the lumen of an angioplastied coronary artery, provide structural support through rigid scaffolding to the arterial wall. This support is helpful in maintaining vessel lumen patency. Intravascular stents are sometimes implanted within vessels in an effort to maintain the patency thereof by preventing collapse and/or by impeding restenosis. Implantation of a stent is typically accomplished by mounting the stent on the expandable portion of a balloon catheter, manoeuvring the catheter through the vasculature so as to position the stent at the desired location within the body lumen, and inflating the balloon to expand the stent so as to engage the lumen wall. The stent maintains its expanded configuration, allowing the balloon to be deflated and the catheter removed to complete the implantation procedure. A covered stent, in which a graft-like covering is slip-fit onto the stent, may be employed to isolate the brittle plaque from direct contact with the stent, which is rigid. The materials from which such stents are formed may include metals such as, but not limited to, stainless steel, “MP35N,” “MP20N,” elastinite (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from standard Press Steel Co., Jenkintown, Pa. “MP35N” comprises of 35% cobalt, 35% nickel, 20% chromium, and 10% molybdenum. “MP20N” comprises of 50% cobalt, 20% nickel, 20% chromium, and 10% molybdenum.

To reduce the chance of the development of restenosis, therapeutic substances may be administered to the treatment site. For example, anticoagulant and antiplatelet agents are commonly used to inhibit the development of restenosis. In order to provide an efficacious concentration to the target site, systemic administration of such medication may be used, which often produces adverse or toxic side effects for the patient. Local delivery is a desirable method of treatment, in that smaller total levels of medication are administered in comparison to systemic dosages, but are concentrated at a specific site. Therefore, local delivery may produce fewer side effects and achieve more effective results. Restenosis after percutaneous transluminal coronary angioplasty is a more gradual process initiated by vascular injury. Multiple processes, including thrombosis, inflammation, growth factor and cytokine release, cell proliferation, cell migration and extracellular matrix synthesis each contribute to the restenotic process. While the exact mechanism of restenosis is not completely understood, the general aspects of the restenosis process have been identified. In the normal arterial wall, smooth muscle cells proliferate at a low rate, approximately less than 0.1 percent per day. Smooth muscle cells in the vessel walls exist in a contractile phenotype characterized by eighty to ninety percent of the cell cytoplasmic volume occupied with the contractile apparatus. Endoplasmic reticulum, Golgi, and free ribosomes are few and are located in the perinuclear region. Extracellular matrix surrounds the smooth muscle cells and is rich in heparin-like glycosylaminoglycans, which are believed to be responsible for maintaining smooth muscle cells in the contractile phenotypic state (Campbell and Campbell, 1985). It is known that after pressure expansion of an intracoronary balloon catheter during angioplasty, smooth muscle cells within the vessel wall become injured, initiating a thrombotic and inflammatory response. Cell derived growth factors such as platelet derived growth factor, basic fibroblast growth factor, epidermal growth factor, thrombin, etc., released from platelets, invading macrophages and/or leukocytes, or directly from the smooth muscle cells provoke a proliferative and migratory response in medial smooth muscle cells. These cells undergo a change from the contractile phenotype to a synthetic phenotype characterized by only a few contractile filament bundles, extensive rough endoplasmic reticulum, Golgi and free ribosomes. Proliferation/migration usually begins within one to two days post-injury and peaks several days thereafter (Campbell and Campbell, 1987; Clowes and Schwartz, 1985). Daughter cells migrate to the intimal layer of arterial smooth muscle and continue to proliferate and secrete significant amounts of extracellular matrix proteins. Proliferation, migration and extracellular matrix synthesis continue until the damaged endothelial layer is repaired at which time proliferation slows within the intima, usually within seven to fourteen days post-injury. The newly formed tissue is called neointima. The further vascular narrowing that occurs over the next three to six months is due primarily to negative or constrictive remodelling. Simultaneous with local proliferation and migration, inflammatory cells adhere to the site of vascular injury. Within three to seven days post-injury, inflammatory cells have migrated to the deeper layers of the vessel wall. In animal models employing either balloon injury or stent implantation, inflammatory cells may persist at the site of vascular injury for at least thirty days (Tanaka et al., 1993; Edelman et al., 1998). Inflammatory cells therefore are present and may contribute to both the acute and chronic phases of restenosis.

In particular, it is desired that therapeutic biological agents (biomolecules or bioactive substances), such as compositions of a biopolymer, biosolvent, and therapeutic biomolecule or cell, can be used to coat vascular implants such as stents or cardiovascular sensors. In accordance with various aspects of the present invention, asymmetric alternating current EPD is used to form multiple monolayers of functional biological agents on the vascular implant

One commonly applied technique for the local delivery of a therapeutic substance is through the use of a medicated implantable device, such as a stent or graft. Because of the mechanical strength needed to properly support vessel walls, stents are typically constructed of metallic materials. The metallic stent may be coated with a polymeric carrier, which is impregnated with a therapeutic agent. The polymeric carrier allows for a sustained delivery of the therapeutic agent. The present invention involves using unbalanced (asymmetrical) alternating voltage for deposition of such therapeutics, especially the therapeutic biomolecules and cells directly from a watery medium to the conductive vascular implant and the formation of a fixed coat or layer on such medical implant. This method allows forming a therapeutic coating directly on the implant. The method is particularly suitable to make a coat of biomolecules or cells on the vascular implant to prevent or treat restenosis. However in principle a coat of different therapeutics can be formed. The therapeutic agent may be, for example, antineoplastic, antimitotic, antiinflammatory, antiplatelet, anticoagulant, antifibrin, antithrombin, antiproliferative, antibiotic, antioxidant, and antiallergic substances, as well as combinations thereof. Examples of such antineoplastics and/or antimitotics include paclitaxel (e.g., TAXOL® by Bristol-Myers Squibb Co., Stamford, Conn.), docetaxel (e.g., Taxotere® from Aventis S.A., Frankfurt, Germany) methotrexate, azathioprine, actinomycin-D, vincristine, vinblastine, fluorouracil, doxorubicin hydrochloride (e.g., Adriamycin® from Pharmacia & Upjohn, Peapack, N.J.), and mitomycin (e.g., Mutamycin® from Bristol-Myers Squibb Co., Stamford, Conn.). Examples of such antiplatelets, anticoagulants, antifibrin, and antithrombins include sodium heparin, low molecular weight heparins, heparinoids, hirudin, argatroban, forskolin, vapiprost, prostacyclin and prostacyclin analogues, dextran, D-phe-pro-arg-chloromethylketone (synthetic antithrombin), dipyridamole, glycoprotein IIb/IIIa platelet membrane receptor antagonist antibody, recombinant hirudin, and thrombin inhibitors such as Angiomax® (Biogen, Inc., Cambridge, Mass.). Examples of such cytostatic or antiproliferative agents include angiopeptin, angiotensin converting enzyme inhibitors such as captopril (e.g., Capoten® and Capozide® from Bristol-Myers Squibb Co., Stamford, Conn.), cilazapril or lisinopril (e.g., Prinivil® and Prinzide® from Merck & Co., Inc., Whitehouse Station, N.J.); calcium channel blockers (such as nifedipine), colchicine, fibroblast growth factor (FGF) antagonists, fish oil (omega 3-fatty acid), histamine antagonists, lovastatin (an inhibitor of HMG-CoA reductase, a cholesterol lowering drug, brand name Mevacor® from Merck & Co., Inc., Whitehouse Station, N.J.), monoclonal antibodies (such as those specific for Platelet-Derived Growth Factor (PDGF) receptors), nitroprusside, phosphodiesterase inhibitors, prostaglandin inhibitors, suramin, serotonin blockers, steroids, thioprotease inhibitors, triazolopyrimidine (a PDGF antagonist), and nitric oxide. An example of an antiallergic agent is permirolast potassium. Other therapeutic substances or agents that may be used include alpha-interferon, Trapidil antiplatelet (manufactured by DAITO Corporation, Japan; referenced herein after as “Trapidil”), genetically engineered epithelial cells, and dexamethasone. In yet other embodiments, the therapeutic substance is a radioactive isotope used in radiotherapeutic procedures. Examples of radioactive isotopes include, but are not limited to, phosphoric acid (H₃P₃₂O₄), palladium (Pd103), cesium (Cs131), and iodine (I125). One aspect of present invention is a method or system to coat cardiovascular implants with a with medicated coating using an unbalanced (asymmetrical) alternating voltage signal wherein the electrical field generated from the negative part of the signal is different of the electrical field generated from the positive part but of which the integral of the AC-signal over one period is zero (whereby the signal has no net DC component).

It still another aspect of the invention, the method of present invention concerns coating cardiovascular implants with a coating comprising biomolecules for recruiting cells circulating in the blood stream of a subject to the blood contacting coating. Such coating can be particularly useful for recruiting endothelial cells from the blood to the coating of the cardiovascular implant. This way a self-endothelializing graft in vivo by recruitment of circulating endothelial progenitor cells (EPCs) to form a neo-endothelium on the cardiovascular implant is obtained.

One of the major challenges in the development of blood contacting implant surfaces is to overcome the risk of acute thrombosis and chronic instability—such as calcification—of the implant surface. Surfaces of cardiovascular devices which are implanted as part of the circulatory system, such as heart valves and synthetic grafts, and in particular small diameter conduits used as vessel bypass grafts (such as for bypassing a blocked coronary artery), are the crucial factor governing the functionality and patency rates of these synthetic prosthesis. Poor blood compatibility of these surfaces is almost always the predominant reason for the limitations of these implants, such as the loss of heart valve functionality over time or poor patency rates in small diameter conduits due to acute thrombosis or intimal hyperplasia. Attempts to modify the surfaces of synthetic grafts to overcome the patency problems associated with thrombosis or intimal hyperplasia have generally shown poor long-term outcomes, as these surfaces are unable to maintain a sustained anti-thrombogenic bioactivity (Hayward, Johnston et el, 1985; Hayward, Durrani et al. 1986; Hall, Bird et al, 1989; Segesser, Olah et al. 1993; Walpoth, Rogulenko et al. 1998; Wagner, Deibl et al. 1999). One surface modification approach which has been utilized for blood contacting implants such as synthetic grafts is “endothelial seeding”. In vitro endothelial seeding utilizes viable endothelial cells, which are seeded onto the blood contacting surface of a prosthesis such as, the lumen surface of a vascular graft to mimic the surface of natural blood vessels. This surface modification technique aims to produce a confluent, biologically active surface of viable endothelial cells which by definition, is anti-thrombogenic (Graham, Burkel et al. 1980; Graham, Vinter et al. 1980; Pasic and Mulle-Cilause 1996; Williams and Jarrdl 1997; Bowlin and Rittgers 1997; Bos, Scharenborg et al. 1998; Bos, Scharenborg et al. 1999). For endothelial seeding, autologous endothelial cells are harvested from the graft recipient to prevent immunogenic reaction. The endothelial cells can be seeded directly onto the lumen surface of the graft or after expansion in a cell culture. The synthetic grafts which are seeded by in vitro attachment of endothelial cells can be made of inert substances and/or biodegradable/resorbable materials which, after endothelial seeding, can be implanted in the graft recipient (Greisler, Joyce et al. 1992; Petsikas et al 1993; Shum-Tim, Stock et al. 1999; Greenwald and Berry 2000; U.S. Pat. No. 5,916,585, Cook; U.S. Pat. No. 6,238,687, Mao; U.S. Pat. No. 5,968,092, Buscemi; Huynh et al. Nature Biotech. 17(11): 1083-1086, 1999). Although “endothelial seeding” is an improvement, the need to harvest, expand, and seed endothelial cells brings with it additional complications. To obtain a sufficient amount of cells to seed a synthetic graft, endothelial cells must be isolated from the graft recipient, purified from a mixture of different cells and then expanded in vitro to produce enough endothelial cells for seeding the graft. Furthermore, the retention of endothelial cells on the surface of the graft is often insufficient, resulting in poor patency rates. This is very impractical. Solutions have been proposed for overcoming these limitations by facilitating in vivo tissue engineering through the recruitment of circulating cells to graft and/or prosthesis surfaces to ensure the permanent population and modification of implant surfaces by in vivo colonizing cells.

The method of present invention can for instance be used to coat surface molecules of said specific target cells on said the cardiovascular implant. Suitable surface molecule for the recruitment of endothelial progenitor cells to implant surfaces are for instance such ligands that bind to CD34, CD133, polysaccharides, KDR (VEGFR-2), P-selectin, E-selectin, αvp3, glycophorin, CD4, integrins, lectins or VE-I Cadherin. Such ligand can be a specific ligand such as an antibody or a fragment thereof. The method of present invention can be used to deposit ligand on a conductive implant which ligand is a bio compound, bio molecule or biocomponent selected from the group consisting of enzymes, organic catalysts, ribozymes, organometallics, proteins, glycoproteins, peptides, polyamino acids, antibodies, nucleic acids, steroidal molecules, antibiotics, antimycotics, cytokines, carbohydrates, oleophobics, lipids, viruses, and prions.

In one embodiment of the first aspect of the present invention, the process of present invention is used to deposit a bio molecule or a bio component on a conductive implant which bio molecule or bio component promotes endothelial cell spreading or retention for instance bio molecule or a bio component consisting of Arg-Gly-D, Arg-Glu-D-Val, fibrin, fibronectin, laminin, gelatin, collagen, basement membrane proteins, and partial sequences of fibrin, fibronectin, laminin, gelatin, collagen, and basement membrane proteins.

In a specific embodiment of present invention of present invention the unbalanced (asymmetrical) alternating voltage is used for directly deposing endothelial progenitor cells to implant surfaces to enhance biocompatibilization of the surface especially to enhance blood compatibility for implanting such implant into the blood circulation.

### EPD System for Electrocoating a Conductive Substrate

According to a preferred embodiment of the second or third aspect of the present invention, the control system is connected to said signal generator for determining the frequency or amplitude of the unbalanced (asymmetrical) AC.

According to preferred another embodiment of the second or third aspect of the present invention, the biological agent is a living cell or biomolecule.

According to preferred another embodiment of the second or third aspect of the present invention, the signal generator is an auxiliary electrode that is powered by the power supply under control of the control system generating the asymmetric electrical potential, without electrolysing the aqueous working solution between the conductive working substrate between said the auxiliary electrode in an extend to disturb the deposition of smooth layers.

According to another preferred embodiment of the second or third aspect of the present invention, the control system comprises a function generator and an amplifier (amp).

According to another preferred embodiment of the second or third aspect of the present invention, the control system comprises an oscilloscope (O-scope).

According to another preferred embodiment of the second or third aspect of the present invention, the system further comprises a sensor system for transmitting information regarding the electrophoretic deposition response to the unbalanced (asymmetrical) alternating current in the electrophoretic deposition aqueous medium, and a pump system acting in response to the information communicated to the pump system to deliver a responsive dose of appropriate cells, biological agents, biomolecules or a responsive of a dose of an appropriate conductivity regulating agent in the electrophoretic deposition aqueous medium.

### Use of the Process or System to Form Deposits of at Least One Biological Agent on a Conductive Substrate

According to a preferred embodiment of the fourth aspect of the present invention, the conductive substrate is an implant.

According to another preferred embodiment of the fourth aspect of the present invention, the substrate is selected from the group consisting of a cardiovascular implants [for instance cathether or stent (e.g. a self-expandable, balloon-expandable stent or heart valve)] and blood contacting implants (e.g. a continuous blood glucose sensor).

According to another preferred embodiment of the fourth aspect of the present invention, the biological agent prevents fibrosis formation or the development of excess fibrous connective tissue and said biological agent is selected from the group consisting of enzymes, organic catalysts, ribozymes, organometallics, proteins, glycoproteins, peptides, polyamino acids, antibodies, nucleic acids, steroidal molecules, antibiotics, antimycotics, cytokines, carbohydrates, oleophobics, lipids, viruses, and prions.

According to another preferred embodiment of the fourth aspect of the present invention, the biological agent is a bone-morphogenic protein.

According to another preferred embodiment of the fourth aspect of the present invention, the biological agent is a bioabsorbable biological agents such as heparin, fibrin, fibrinogen, cellulose, starch, and collagen.

According to another preferred embodiment of the fourth aspect of the present invention, the biological agent is a biological agent which enhances the biocompatibility of said conductive substrate or prevents a pathological tissue reaction after implantation.

According to another preferred embodiment of the fourth aspect of the present invention, the biological agent promotes endothelial cell spreading or retention.

According to another preferred embodiment of the fourth aspect of the present invention, the biological agent promotes endothelial cell spreading or retention and said biological agent is selected from the group consisting of Arg-Gly-D, Arg-Glu-D-Val, fibrin, fibronectin, laminin, gelatin, collagen, basement membrane proteins, and partial sequences of fibrin, fibronectin, laminin, gelatin, collagen, and basement membrane proteins.

According to another preferred embodiment of the fourth aspect of the present invention, the biological agent is a biological agent for recruiting cells circulating in the blood stream of a subject to the blood contacting coating.

According to another preferred embodiment of the fourth aspect of the present invention, the biological agent is a biological agent for the recruitment of endothelial progenitor cells to implant surfaces.

According to another preferred embodiment of the fourth aspect of the present invention, the biological agent is a biological agent for the recruitment of endothelial progenitor cells to implant surfaces whereby the biological agents is selected from the group consisting of ligands that bind to CD34, CD133, polysaccharides, KDR (VEGFR-2), P-selectin, E-selectin, αvp3, glycophorin, CD4, integrins, lectins and VE-I Cadherin.

According to another preferred embodiment of the fourth aspect of the present invention, the biological agent is a biological agent that prevents thrombosis or chronic instability, such as calcification, of the implant surface.

According to another preferred embodiment of the fourth aspect of the present invention, the biological agent is a biological agent that prevents restenosis.

According to another preferred embodiment of the fourth aspect of the present invention, the conductive substrate is a sensor electrode and said biological agent is at least one enzyme and said thereby coated sensor electrode is preferably used for detecting an analyte.

According to another preferred embodiment of the fourth aspect of the present invention, said coated conductive substrate is an electrode of a biobattery.

### Use of the Process or System in the Manufacture of a Sensor

According to another preferred embodiment of the sixth aspect of the present invention, the analyte is monitored in real-time.

According to another preferred embodiment of the sixth aspect of the present invention, the analyte is measured in a biological sample, preferably in an animal sample. The biological sample is preferably an animal sample e.g. a rabbit and the sample may be taken from a healthy or a sick animal e.g. a sick rabbit.

### Sensors

The present invention provides a fast and easy way for the formation of biofilms or biological active layers for sensing purposes. The deposition of the biological agent (biomolecule or biological cell) during the manufacturing of the biomolecule-based biosensor and cells-based biosensors can be obtained in maximum of 60 minutes, preferably even less than 45 minutes, yet more preferably in less than 30 minutes for instance 10 to 30 minutes by subjecting these biological agents to unbalanced (asymmetrical) alternating electric field. Immobilization of biomolecules and cells on a substrate is necessary for many commonly employed analytical or industrial applications utilizing biomolecules and cells.

An important analytical use for the immobilized biomolecules and cells is in biosensors that detect the presence or the concentration of an analyte as a result of the biological recognition between the analyte or the biological ligand and the immobilized biological species such as enzymes or cells. For example, some glucose sensors are based on the rate of glucose oxidase—catalyzed oxidation of glucose by dioxygen. The rate of the reaction is measured by monitoring the formation of hydrogen peroxide or the consumption of oxygen. Detailed example of a glucose sensor comprising such a deposited enzyme layer having enhanced sensitivity and stability characteristics, coupled with rapid and easy automated manufacture is given. In addition, other examples of the deposition of catalase, glutamate oxidase and saccharomyces cerevisiae cells are also given.

Two enzymes such as β-galactosidase and glucose oxidase can also be simultaneously deposited by means of AC-EPD to manufacture a lactose sensor. Applied parameters such as nature of the AC-signal, enzyme proportions, frequency, amplitude, pH and temperature have been shown to affect the response of the sensor towards lactose.

Enzyme concentrations ˜(10 mg GOx+90 mg β-Gal)/mL, amplitudes ˜120 Vₚ₋ₚ, frequencies ˜30 Hz and deposition times of 20 minutes or longer were found to be optimal for a good sensor response. The high ratio of β-Gal used for enzyme mixture demonstrates that the sensor response is specially β-Gal rate dependent. This is understandable since our approach for determining lactose concentration is based on the following cascaded biochemical and electrochemical reactions.

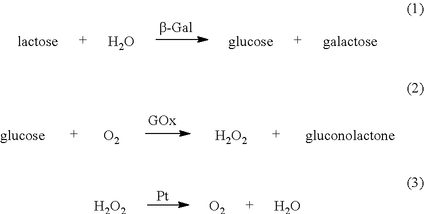

The enzyme β-galactosidase cleaves the disaccharide lactose, producing glucose and galactose. The glucose reacts with the immobilized GOx to produce H₂O₂, which in turn oxidizes at the platinum electrode polarized at +0.65 V vs. AgCl/Ag resulting in an amperometric signal proportional to the lactose concentration.

According to a preferred embodiment of the seventh aspect of the present invention, the sensing enzyme layer is a layer of glucose sensing enzyme with an average thickness of at least 10 micrometer, said sensor electrode has an activity response that exceeds 4600 nA/mm² for a 5 mM glucose injection (according to the test described in U.S. Pat. No. 6,814,845 B2), and has a maintained selectivity stability after being repeatedly used for glucose sensing (e.g. 100 times a day), having a selectivity stability of up to about ±90% relative to the initial selectivity of the sensor for a period of at least 45 days.

According to another preferred embodiment of the seventh aspect of the present invention, the sensing enzyme layer has been electrocoated on said electrode.

According to another preferred embodiment of the seventh aspect of the present invention, the sensor having a response time of 5 seconds or less.

According to another preferred embodiment of the seventh aspect of the present invention, the sensor is bio compatible and non toxic.

According to another preferred embodiment of the seventh aspect of the present invention, the sensor can maintain more than 90% of its response up to 20 mM glucose when the oxygen concentration is over 50 torr.

According to another preferred embodiment of the seventh aspect of the present invention, the sensor has a response time of 5 seconds or less and can maintain more than 90% of its response up to 20 mM glucose when the oxygen concentration is over 50 torr.

According to another preferred embodiment of the seventh aspect of the present invention, the enzyme layer comprises glucose oxidase and optionally further comprises β-galactosidase.

According to another preferred embodiment of the seventh aspect of the present invention, the sensor is a glucose microbiosensor.

According to another preferred embodiment of the seventh aspect of the present invention, the sensor is a lactose microbiosensor.

### EXAMPLES

The following examples demonstrate the AC-EPD deposition of biomolecules and biological cells. The first example shows the AC-EPD-based process for the deposition of the glucose oxidase on a substrate for the production of a glucose sensor. The second example shows the deposition of catalase and glutamate oxidase and the third example illustrate the AC-EPD deposition of saccharomyces cerevisiae cells. It is important however to keep in mind that these examples are provided by way of illustration and should not be seen as a limitation of the overall scope of the invention.

### Materials

Ultrapure water milliQ grade with a resistance of 18.2MΩcm was used for all the experiments. Glucose oxidase (GOx) crude from Aspergillus niger 5.6 units/mg and 200 units/mg was purchased from Sigma. d-Glucose (Glu) 99% from Fisher Scientific, and the solution was prepared 24 h before use. 1-Ascorbic acid (AA) 99% from Acros, uric acid (UA) 99% and acetaminophen (AP) were purchased from Aldrich, and the solutions were prepared immediately before testing. Phosphate salts (NaH₂PO₄ and Na₂HPO₄) and sodium chloride analytical grade were purchased from Acros Organic. The buffered saline pH 7.4, used for the testing of the sensors, was prepared from phosphate salts (0.1M) and sodium chloride (0.15 M). Sodium hydroxide pellets, puriss analytical grade from Riedel de Haen were used for the preparation of the low conductivity solution (23 μS/cm), in which the glucose oxidase enzyme is dissolved.

Polyurethane Selectophore grade for biosensors and chemosensors was purchased from Sigma-Aldrich. Platinum wire with a diameter of 250 μm is used for the sensor preparation. It is 99.99% pure and was purchased from Goodfellow.

The milk samples were purchased from SPAR supermarket Belgium. The whole, skimmed and semi-skimmed milk were products from SPAR (mark everyday) and the whole milk extra concentrated was a product from Nutroma.

### Apparatus

FIG. 1 gives a schematic overview of the set up and equipment used for the AC-EPD of the enzyme. The equipment consisted of an arbitrary waveform generator (ww5061, Tabor electronics) connected to a bipolar high-voltage operational amplifier (BOP 1000M, Kepco) which amplified the signal of the function generator 100 times. The shape and the parameters of the applied wave-form were monitored using a digital oscilloscope (Explorer III oscilloscope, Nicolet Instrument Corporation) connected to the amplifier via a potential divider. In addition, before each experiment the AC signal was integrated using Labview program from National Instruments, to verify that the integral of the applied signal over one period is as small as possible in order to minimize the amount of electrolysis. The two electrical outputs of the amplifier are connected to an electrochemical cell. This electrochemical cell contains two electrodes, a platinum counter electrode and electrode that will be used for the biosensor. For the biosensor electrode, a platinum disk electrode of 1 mm in diameter (surface area around 0.78 mm²) and platinum insolated wire with a diameter of 180 μm and a length of 1 mm working surface (surface area of 0.57 mm²) were used. Platinum is often used in electrochemistry because it does not corrode easily and the surface can be regenerated easily just by polishing the surface, followed by abundant cleaning. However, other materials such as gold, carbon, stainless steel . . . etc, can be used as well. The deposition electrode and the counter electrode must be as parallel as possible to permit current distribution that is as uniform as possible between the two electrodes. The distance between the biosensor electrode and the counter electrode is around 10 mm, and the surface area of the counter electrode was slightly bigger than the biosensor electrode.

FT-IR experiments were carried out with an AVATAR 370 FT-IR from Thermo Nicolet. The spectrum of 50 mM glucose in phosphate buffer pH 7.4 was taken as the reference spectrum and was subtracted from all subsequently measured spectra. An enzyme modified platinum wire (1 mm diameter, 10 mm length, surface area ca. 32 mm²) was immersed in a small glass tube containing 100 μL of the phosphate buffered glucose solution (50 mM). Every few minutes, the electrode was removed, the glucose solution was mixed, a 5 μL drop was placed in the FT-IR window and the absorbance spectrum was recorded. For the control experiment, ˜0.1 mg of GOx was dissolved in 100 μL of the glucose solution (buffer solution containing 50 mMglucose). The mixture was taken immediately as a background and the spectrum at t=0, then 5 μL aliquots were periodically taken for recording the FT-IR spectrum.

### Sensor Preparation

A 4 mm long platinum wire (250 μm diameter) was soldered to bare end of an insulated copper wire to provide electrical connection. A 4 mm heat-shrink tube was used to insulate the platinum-copper junction. The platinum end was then cut to a length of 1 mm, and the tip was sealed with acrylic glue. The sensing area was ca. 78 mm². The sensing area was cleaned by dipping into a mixture of nitric acid (7%) and hydrogen peroxide (30%) for a few minutes, and then rinsed abundantly with ultrapure water and acetone.

### Example 1

### Glucose Sensor

In this example, the procedure for the deposition of an enzyme is illustrated. The main parameters which influence the response to glucose and interferences are discussed in details.

The electrophoretic deposition (EPD) of the enzyme was carried out by the application of the unbalanced (asymmetrical) triangular AC signal shown in FIG. 2A, with applied parameters of 30 Hz frequency and 160 Vₚ₋ₚ amplitude. In FIG. 2A, one period of the AC-signal is composed of two triangular waves of opposite amplitude and with different amplitude and duration. However, the area of both triangular waves is equal, so that the signal has no net DC component, i.e. the integral of the AC-signal over one period is zero. In comparison, FIG. 2D shows a symmetrical triangular waveform.

The dispersion serving for the deposition of enzyme was prepared following this procedure: 0.05 grams of the Gox 5.6 units/mg was dissolved in a small glass tube containing 0.5 mL (ultrapure water+NaOH with a conductivity of 23 μS/cm at 25° C., measured pH is 7.8) and a platinum counter electrode. The measured pH of the enzymatic dispersion is 6.95. An enzyme with low activity (5.6 units/mg) is used for the experiments, except when indicated otherwise. The electrophoretic deposition of the enzyme comprised dipping the deposition electrode and the counter electrode in the enzyme dispersion, the distance between the two electrodes was preferably around 10 mm. The unbalanced (asymmetrical) triangular AC signal was then applied at specific frequency and amplitude over a period of time t. Next, the electrode was rinsed with ultrapure water and then tested in 5 mL phosphate buffer solution by injecting 10 μl of acetaminophen (0.1 mM), uric acid (0.1 mM), ascorbic acid (0.1 mM) and several injections of glucose (5 mM). The enzyme dispersion and interferences solutions were prepared fresh every day. In contrary, glucose solution is prepared 24 hours before use. A potentiostat GAMRY model CMS 100 connected to a computer for the data acquisition was used for the testing of the sensors (amperometry). AgCl/Ag was used as a reference electrode, and the polarization was set at +0.6 V vs. AgCl/Ag.

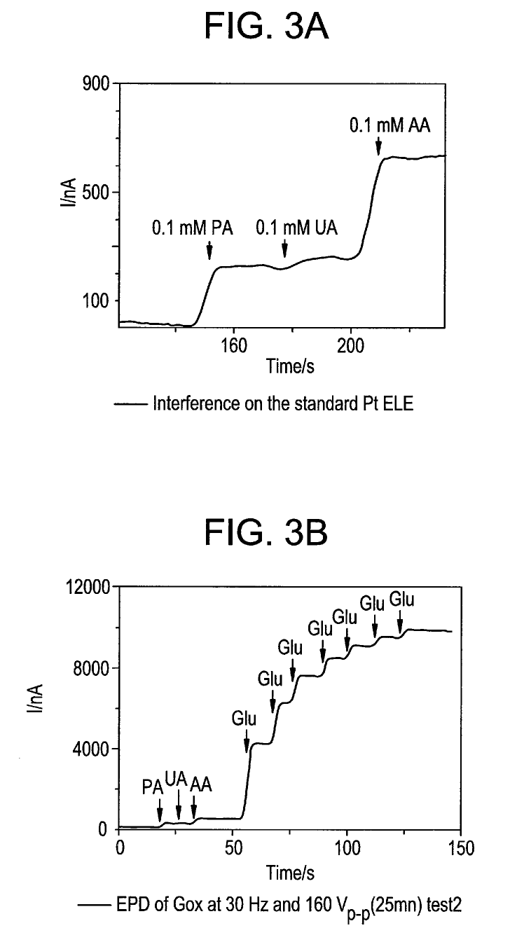

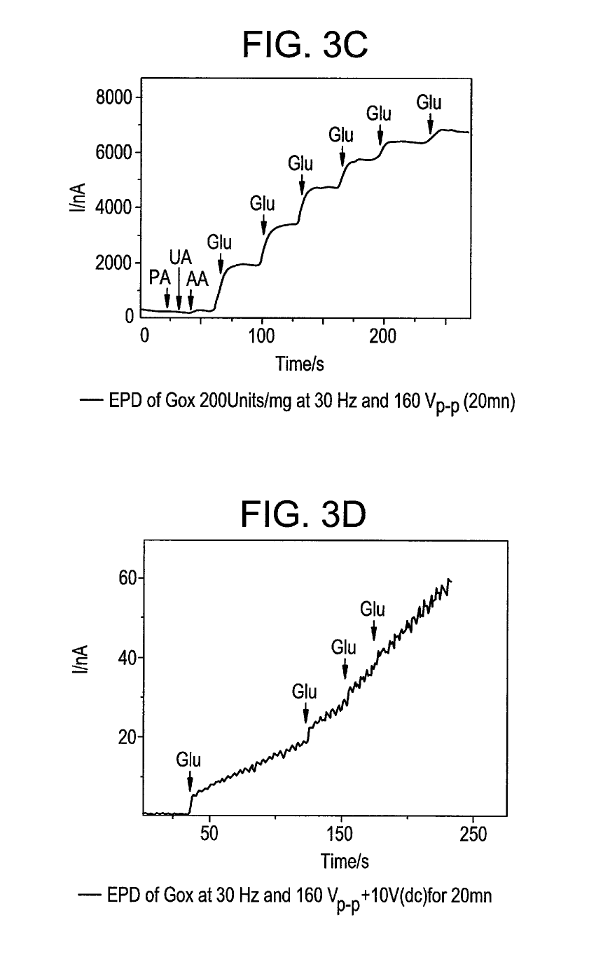

FIG. 3A illustrates a typical example of the current response to injections of 0.1 mM AP, UA and AA, respectively on the platinum disk electrode with around 1 mm in diameter. This initial test permits to extract the difference in the current response when a film of the enzyme is deposited on the same electrode. FIG. 3B shows a typical example of the current response to the same concentration of the interference AP, UA and AA and successive additions of 5 mM glucose on the same platinum disk electrode modified with glucose oxidase (5.6 units/mg). The AC-EPD of the glucose oxidase was carried out at a frequency of 30 Hz and 160 Vₚ₋ₚ amplitude for a period of 25 minutes. It can be seen from FIG. 3B that the response to the interferences is very small in comparison to the previous current response observed on the platinum electrode without Gox film (FIG. 3A). However, the response to glucose injections is very significant. The current response corresponding to the first injection of 5 mM exceed 4600 nA/mm², which means that the range of the current response to glucose is a factor of 10 to 200 times larger than of prior art glucose sensor. For example, in U.S. Pat. No. 6,814,845 B2 a current response of only a few tenths of nA is observed for an enzyme with a much higher activity than the one used here while, the enzyme layer was deposited for a much longer time going from 60 to 80 min. Subsequent, in FIG. 3B injections of 5 mM glucose result in stepwise increases of the current response, with decreasing step size. The decrease in the current response can be mainly due to a decrease in the oxygen supply. The relatively high response of the sensor vis-à-vis of the analyte glucose is probably related to the formation of thick compact enzymatic layer. Further experiments showed that the thickness of the deposited layer is at least 10 μm, which means that the enzyme is accumulated on the substrate by electrophoresis. Moreover, it can be seen in FIG. 3B which illustrates the second test of the manufactured glucose sensor using the triangular unbalanced (asymmetrical) AC waveform. In other words, the sensor have been tested using amperometry in a buffer solution to obtain a first curve similar to FIG. 3B, then removed and washed delicately with ultrapure water and tested amperometrically a second time in new 5 mL buffer solution. The current response of the sensor during the second test is very similar to the response of the first test. The latter is particularly important since most of the commercialized glucose sensors including for example glucose sensors from Pinnacles Technology Inc. (U.S.) or Sarissa Biomedical (U.K.) can only be used once. Their sensors show a net deterioration after the first test.

The mechanisms of the electrophoretic deposition under DC electrical field are known. The dispersed charged particle placed on the DC electrical field move toward the opposite charged electrode to deposit. For example, the process EPD under DC conditions was employed by [Ikariyama et al., J. Eleetrochem. Soc., 1989, 136 (6), pp. 702-706] to codeposit platinum particles and the enzyme glucose oxidase at (pH=3.5). However, this technique results in inactivation of the enzyme. The deposition of the enzyme under AC electrophoresis is mainly related to the asymmetry of the signal. The non-linear dependence between electrical field and the electrophoretic mobility causes enzymes to move towards the electrode. Moreover, supplementary experiments show no significant response to glucose when a symmetrical AC wave such as triangle and sine are applied to the enzyme dispersion in the same previous conditions. Table 1 summarizes the current response to the first injection of 5 mM glucose obtained with application of several AC waveforms. The deposition conditions of the Gox were carried out at 30 Hz, 160 Vₚ₋ₚ for 20 min. Virtually, no response to glucose should be registered when a symmetrical AC wave is applied. However, as it is shown in table 1, a small response of around hundred nA is observed. The later can be related simply to a small deformation in the AC symmetrical wave after amplification or to the adsorption of the enzyme on the electrode. In contrary, as it is shown in table 1 the current response to glucose observed with application of the unbalanced (asymmetrical) triangle and sine waves are very important. Among the advantages of the deposition using AC electrical field instead of the DC field we found: i) preservation of the enzyme activity, ii) formation of thick layer of the enzyme, which leads to a higher current response, iii) formation of smooth enzymes films, which can be useful as a barrier for the undesirable electroactive species such ascorbate, urate and acetaminophen. Further experiments were done to confirm this statement. FIG. 3D shows a typical example of the Gox deposition under the unbalanced (asymmetrical) triangular waveform (FIG. 2A) at 30 Hz and 160 Vₚ₋ₚ for 20 min, when an offset DC of 10 V is applied. As it can be seen from FIG. 3D, only few tens of nA were registered when 5 mM glucose was injected. The Gox film shows a bizarre behavior, no plateau was observed after the first injection. In addition, for the subsequent injections, practically no response to glucose was observed. The enzyme response behaves as in diffusion control. The film maybe is too thick, but because most of the enzyme is denaturalized, only some of them respond to glucose. Moreover, after the first deposition experiment under these conditions, the enzyme dispersion gelled is. Overheating of the glass tube and excessive electrolysis of water were observed during these experiments, which can be the principal causes of the denaturalization of the enzyme.

TABLE 1
Current response to the first injection of 5 mM glucose versus the
nature of the AC wave. Applied potential, +0.6 V vs. AgCl/Ag.

| | asymmetric | symmetric | asymmetric | symmetric |
|---|---|---|---|---|
| AC wave | triangular wave | triangular wave | sine wave | sine wave |
| current | 3533 | 151 | 2987 | 111 |
| response to 5 | | | | |
| mM glucose | | | | |
| (nA) | | | | |

FIG. 3C illustrates another example of the current response when more active glucose oxidase enzyme (200 units/mg) is used. For this sensor, 0.005 grams of Gox was dissolved in 0.5 mL ultrapure water. It can be seen that the concentration is 10 times lower than the concentration employed for the deposition of the Gox (5.6 units/mg). Furthermore, the enzyme is dissolved in ultrapure water instead of a mixture of ultrapure water and NaOH at 23 μS/cm. These conditions are found to be the best for a better sensor response manufactured with this high activity enzyme. Next, the unbalanced (asymmetrical) triangular waveform was applied at 30 Hz and 160 Vₚ₋ₚ for 20 min. FIG. 3C shows insignificant current response with respect to the interferences compared to the current response of the glucose sensor manufactured with the low activity enzyme (FIG. 3B). The current response of the sensor to 5 mM glucose is not greater than the response obtained with the low activity enzyme. However, the response is almost linear up to 20 mM glucose without employing any mass transfer limiting outer membrane. This behavior can be related to the morphology of the formed Gox film, which is probably thick and compact enough that it can regulate the diffusion of the glucose to the different formed layers of the Gox film, hence regulating in some sort the oxygen consumption. On the other hand, the glucose oxidase (200 units/mg) used for this sensor contains at least 4% catalase. The presence of catalase, which is a very active enzyme, can consume lots of hydrogen peroxide generated from the simultaneous reaction of oxidation of glucose into gluconic acid and reduction of oxygen to hydrogen peroxide. The latter, may explain the similar current response to glucose observed with the high activity enzyme (200 units/mg) compared to the low activity enzyme (5.6 units/mg). In addition, the presence of catalase can also contribute to the regulation of the amount of the hydrogen peroxide reaching the surface of the platinum, hence the linearity up to 20 mM glucose.

For the rest of the study Gox (5.6 units/mg) is used. However, it is important to keep in mind that this thus not imply that the similar glucose sensors cannot be prepared with higher activity enzymes.

### Influence of the Deposition Time

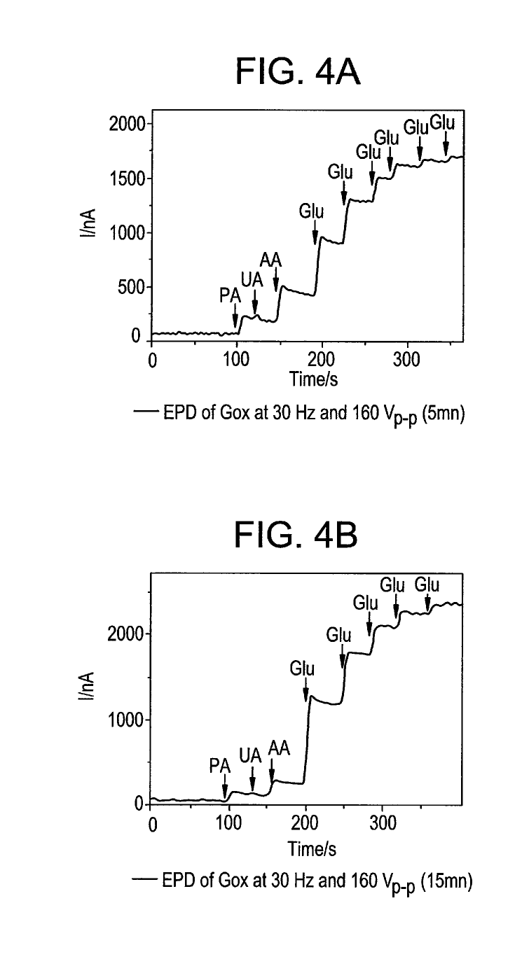

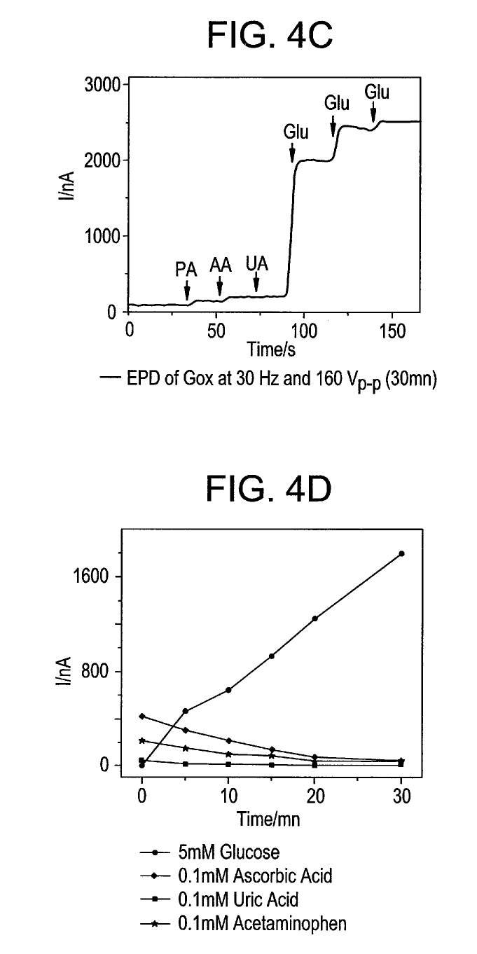

In order to investigate the influence of the deposition time for a better sensor response, the previous experiments were repeated except for the fact that the deposition time was systematically changed. FIG. 4A, FIG. 4B and FIG. 4C show three typical examples of the current response to the injection of the interferences PA, UA and AA and successive additions of 5 mM glucose. The three electrodes have been manufactured with AC-EPD of the Gox using the unbalanced (asymmetrical) triangular waveform (FIG. 2A) at 30 Hz frequency, 160 Vₚ₋ₚ amplitude, and three different deposition time of 5, 15 and 30 minutes, respectively. The relationship between the current response to the interferences and the first injection of 5 mM glucose, and the deposition time under otherwise optimized conditions is summarized in FIG. 4D. The current response to glucose increases linearly with the deposition time up to 30 minutes. On the other hand, it can be seen that the current response to the interferences decreases continuously with the deposition time, and is minimum for 30 min deposition time. The latter, may give an idea about the morphology of the formed enzyme film. The more the deposition time increases, the more the deposited film is compact, which may explain the exclusion of a high amount of the interferences. The obtained values are gathered in table 2.

TABLE 2
Current response to the interferences and glucose versus
enzyme deposition time at 30 Hz and 160 Vₚ₋ₚ.

| EPD time/min | 0 | 5 | 10 | 15 | 20 | 30 |
|---|---|---|---|---|---|---|
| 0.1 mM AP/(nA) | 213 | 148 | 101 | 87 | 37 | 45 |
| 0.1 mM UA/(nA) | 45 | 17 | 14 | 11 | 7 | 11 |
| 0.1 mM AA/(nA) | 420 | 300 | 213 | 137 | 75 | 44 |
| 5 mM Glu/(nA) | 0 | 463 | 643 | 929 | 1244 | 1811 |

Applied potential, +0.6 V vs. AgCl/Ag.

### Effect of the Amplitude

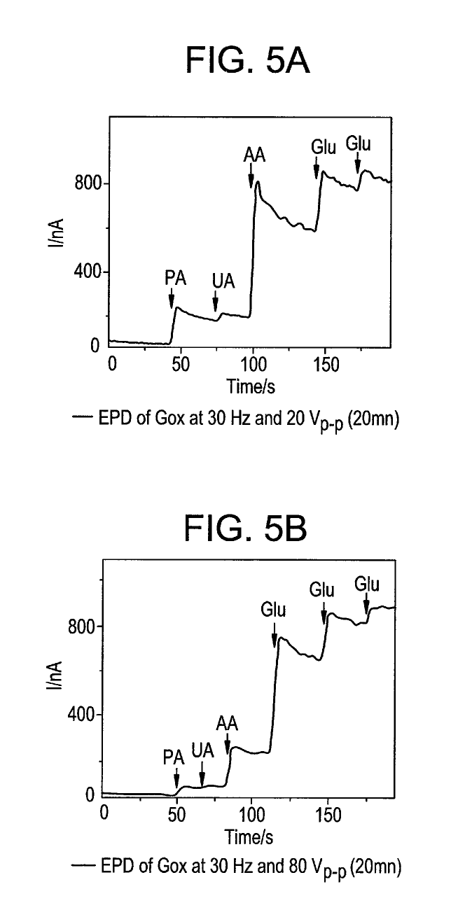

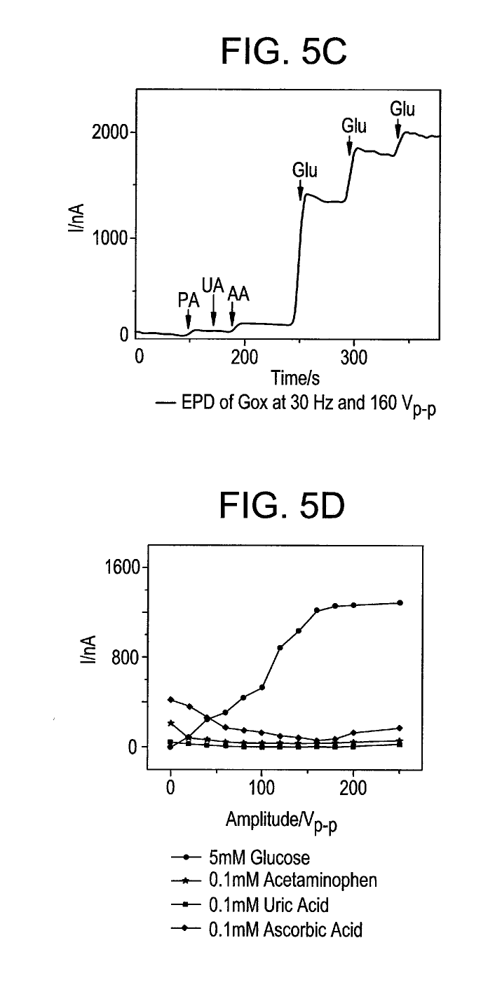

The influence of the applied amplitude on the AC-EPD of Gox was investigated at two different frequencies of the applied triangular unbalanced (asymmetrical) wave (FIG. 2A): a relatively low frequency of 30 Hz and a high frequency of 60 Hz. The deposition time was 20 minutes for all the experiments. FIG. 5A, FIG. 5B and FIG. 5C illustrate typical examples of the current response to 0.1 mM PA, UA, AA and successive injection of 5 mM glucose for the three different Gox films deposited at 30 Hz frequency and respectively at 20, 80 and 160 Vₚ₋ₚ amplitude. The relationship between the current response to the interferences and the first injection of 5 mM glucose as a function of the applied deposition amplitude is summarized in FIG. 5D. The current response to glucose increases linearly with the applied amplitude up to 160 Vₚ₋ₚ. For higher amplitudes, the current output of the sensor remains constant. On the other hand, the current response to the interferences decreases up to approximately 160 Vₚ₋ₚ, after which it increases. The latter can be related to electrolysis of water, which increases at higher amplitudes. (J. W. Shipley and Chas F. Goodeve., The Engineering Journal, 1927, vol 10, pp. 1-8) reported that the primary factor in AC-electrolysis is the current density. In other words, for a given set of conditions, i.e., frequency, temperature, pressure voltage and electrolyte, there is a critical current density for the electrode, below which no gas is evolved. Above the critical current density gas is evolved according to Faraday's law. The formation of a small amount of the gases on the electrode induces formation of pores in the deposited Gox film, thus the infiltration of the interferences through the film to reach the substrate. According to these data, it can be seen that the optimal amplitude to apply for this particular experiment will be situated between 160 and 200 Vₚ₋ₚ.

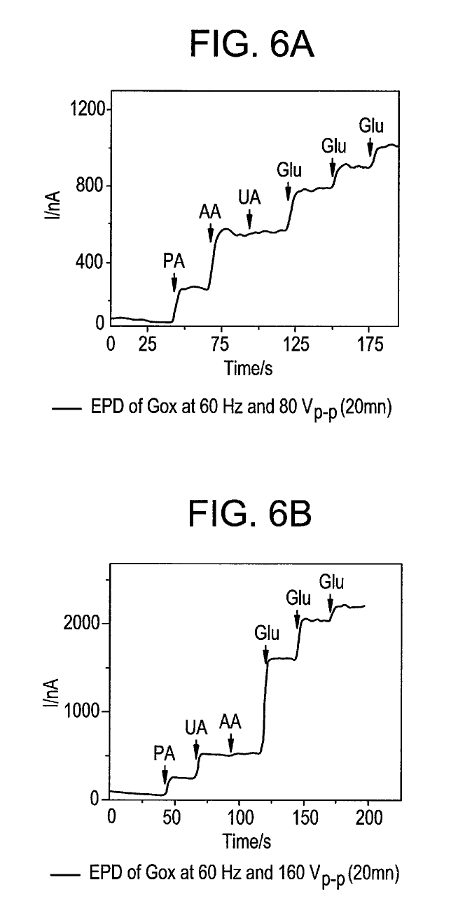

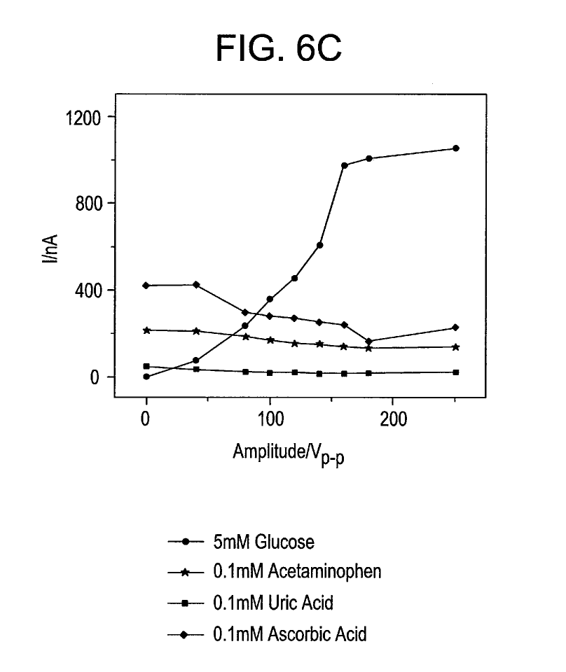

For more illustrations about the influence of the amplitude, the same series of experiments have been done at 60 Hz instead of the previous frequency of 30 Hz. FIG. 6A and FIG. 6B show two others typical example of the current response to the injection of 0.1 mM PA, UA, AA and successive additions of 5 mM glucose for two different Gox films deposited at frequency of 60 Hz and, respectively at 80 and 160 Vₚ₋ₚ amplitude. FIG. 6C gathers the current response to the interferences and the first 5 mM glucose injection versus the applied amplitude. As it is seen previously at 30 Hz, the variation of the current response to glucose increases with the increases of the applied amplitude, then reaches certain stability at higher amplitudes. Also, the variation of the current response to the interferences decreases with the applied amplitude up to approximately 200 Vₚ₋ₚ, then increases again at higher amplitude. However, it can be easily seen that the current response to the interferences is more important at 60 Hz than at 30 Hz, even though the response to glucose is practically the same. In addition, the best applied amplitudes for the sensor response at 60 Hz are located at amplitudes higher than 180 Vₚ₋ₚ instead of 160 Vₚ₋ₚ at 30 Hz. In other words, higher frequencies need higher amplitudes for the formation of a compact enzymatic layer.

Prior to these data the optimal amplitude values to apply in order to manufacture a good sensor response will be situated in the range of 160 to 200 Vₚ₋ₚ. However, further studies show that this range of optimal values can change from one enzyme to another and from one material electrode to another.

### Effect of the Applied Frequency

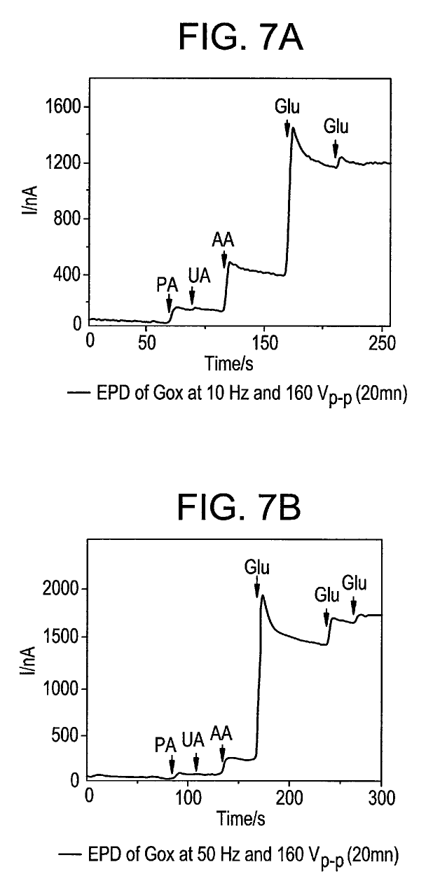

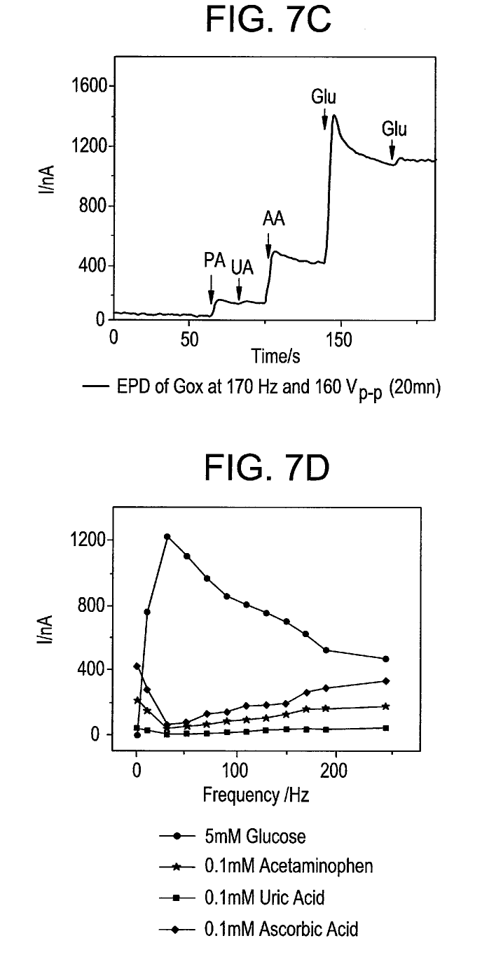

For the same purpose, find out the optimum frequency to apply for the manufacturing of the better response sensor, the effect of the applied frequency for the deposition of the Gox is investigated at two different amplitudes of 80 and 160 Vₚ₋ₚ of the unbalanced (asymmetrical) triangular waveform (FIG. 2A.), to permit a maximum conclusions. FIG. 7A, FIG. 7B and FIG. 7C show three typical examples of the current response to the interferences and successive injection of 5 mM glucose of three different Gox films deposited at a fixed amplitude of 160 Vₚ₋ₚ and respective frequencies of 10, 50 and 170 Hz. The relationship between the current response to interferences and the first injection of 5 mM glucose, and the applied frequency is gathered in figure FIG. 7D. The current response to the glucose shows an important increase up to 30 Hz, and then followed by a continuous decrease and reaching a minimum value at 250 Hz. However, for the response to the interferences the curve shows a decrease of the current response from 0 to around 30 Hz, and then continuous increasing until 250 Hz. It can be observed that the optimum value of the applied frequency for a better sensor response will be situated between 30 to 50 Hz at this applied amplitude of 160 Vₚ₋ₚ. Lower than 30 Hz, probably AC electrolysis of water takes place which pushes the enzyme from the surface of electrode. Therefore, the ratio of the deposition is low, and thus the response to glucose is low and to the interferences is important. At frequencies above 50 Hz, maybe Gox particles situated in the bulk oscillate instead of moving to reach the electrode and deposit. Therefore, only a thin layer of Gox particles situated near the surface of electrode can be deposited.

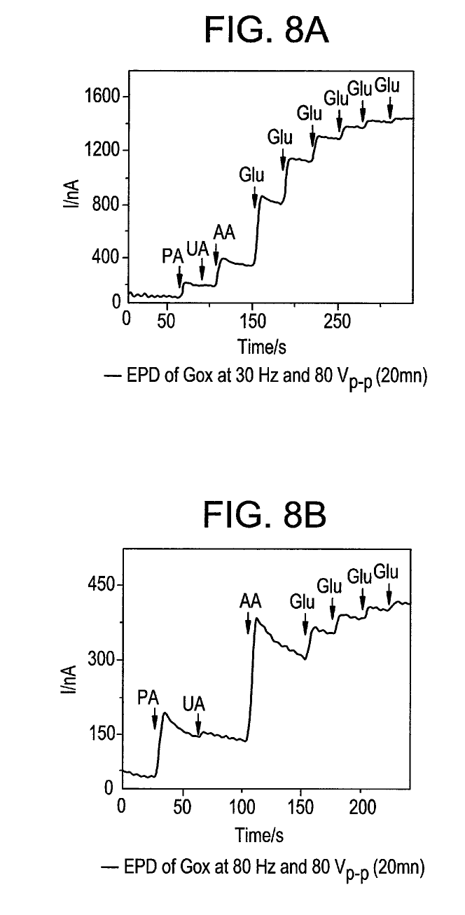

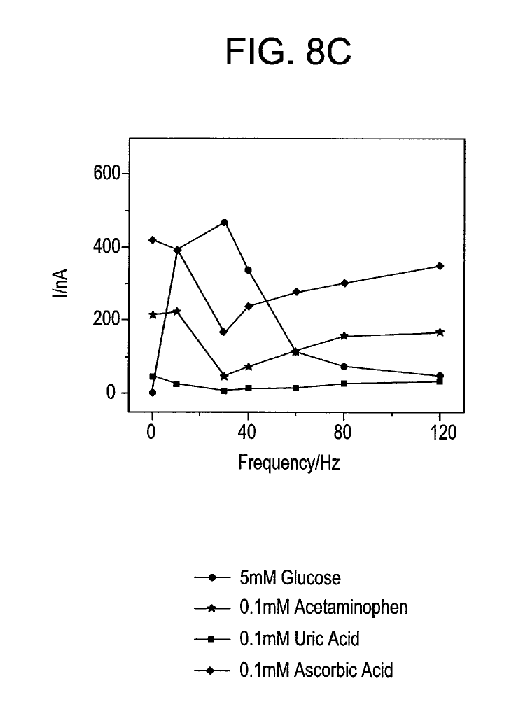

For more illustrative data about the optimal frequency to apply for a better sensor response, the same experiments were done at a fixed applied amplitude of 80 Vₚ₋ₚ. FIG. 8A and FIG. 8B show two other typical examples of Gox films deposited at an applied amplitude of 80 Vₚ₋ₚ and at respective frequencies of 30 and 80 Hz. The variation of the current response to the interferences and the first injection of 5 mM glucose at this applied amplitude versus the applied frequency is gathered in figure FIG. 8C. The same range of the optimal frequency situated at 30 to 50 Hz is also noticed at this lower amplitude of 80 Vₚ₋ₚ. However, comparison between FIG. 7D and FIG. 8C show that the results obtained at 160 Vₚ₋ₚ are much better than those obtained at 80 Vₚ₋ₚ. For example, in FIG. 8C practically no response to glucose is observed at a frequency of 120 Hz, which means no Gox film is deposited; while in FIG. 7D even at a frequency of 250 Hz we still observe a response to glucose.

In summary, the optimal frequency for a better sensor response is situated between 30 to 50 Hz. In addition, higher amplitudes are required as is previously demonstrated.

Glucose Sensor with the Outer Layer of Polyurethane

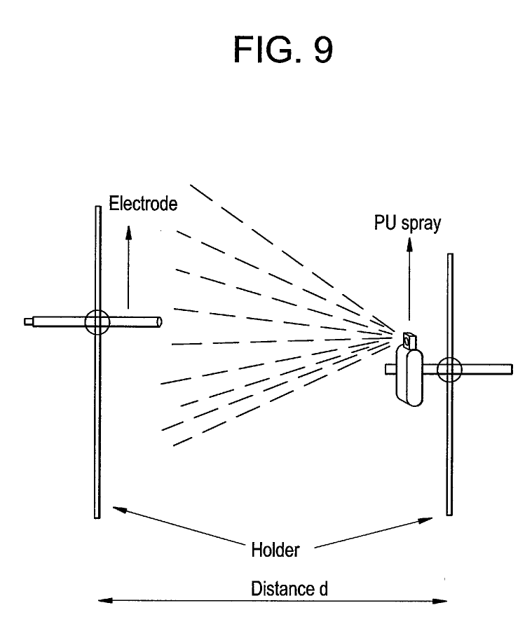

The polyurethane (PU) is prepared from a mixture of Polyol (A) and Isocyanate (B), 1 portion of (A) is mixed with 1.12 portions of (B). Precisely, 0.224 grams of Isocyanate (B) were added to 0.200 grams of Polyol (A). Without mixing, 13.4 grams of tetrahydrofurane (THF) extra dry (water <50 ppm) from Acros Organic and 0.24 gram of dimethylformamide (DMF) from Acros organic were added. The quality of the THF and DMF is a very important. Anhydrous grade are recommended to permit a good polymerization of the membrane. Next, the mixture is stirred for two minutes and transferred to the PU spray. As shown in FIG. 9 the PU spray system comprises on the one hand the PU spray, which in the present invention is a small perfume bottle. On the other hand, the sensor electrode is fixed at distance d from the spray system and sprayed n times. In the present invention, the PU spray or the perfume bottle is permanently fixed at a distance of 15 cm from the surface of the sensor electrode. After AC-EPD of the Gox, the electrode is washed delicately with ultrapure water, and then dried at ambient temperature for 20 minutes. Then, it is fixed on the left side of the PU spray as shown in FIG. 9 and sprayed n times with the freshly prepared PU mixture. The sensor electrode is then left to dry at room temperature for 24 hours. The number of sprays and the time between successive sprays are important features for a successful sensor. The time between successive sprays should be short as possible. For the cylindrical electrode a rotating handle for the sensor electrode or the PU spray can be used to allow to the entire electrode surface to be sprayed and covered homogeneously by the outer layer of PU.

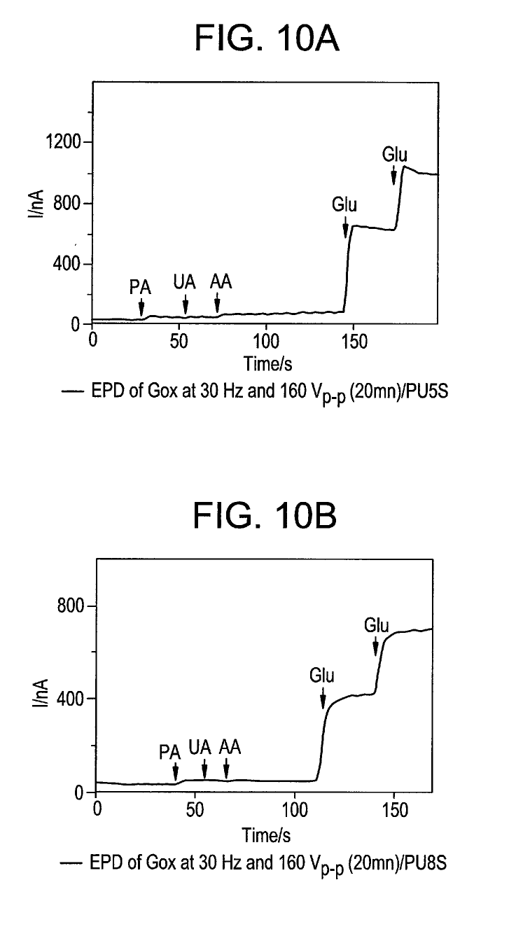

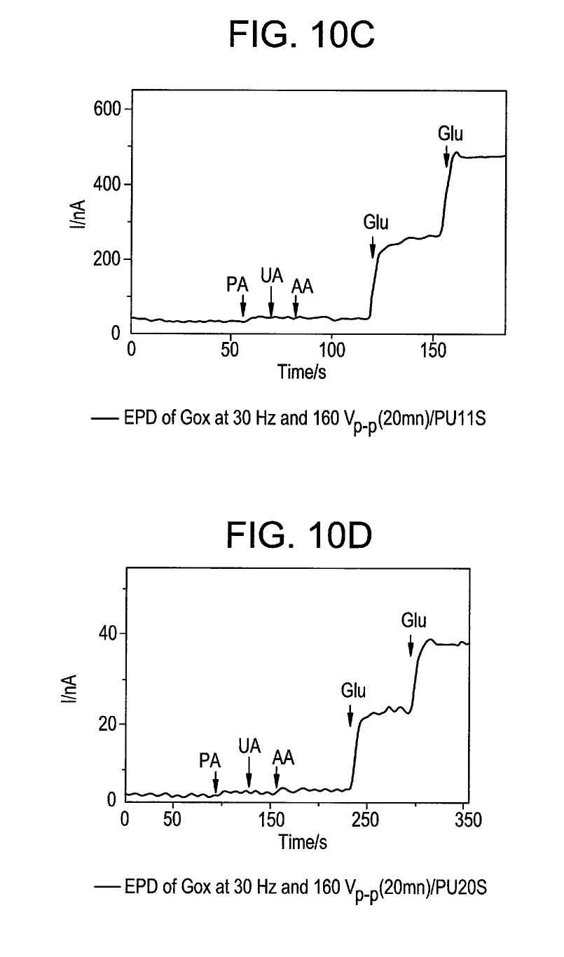

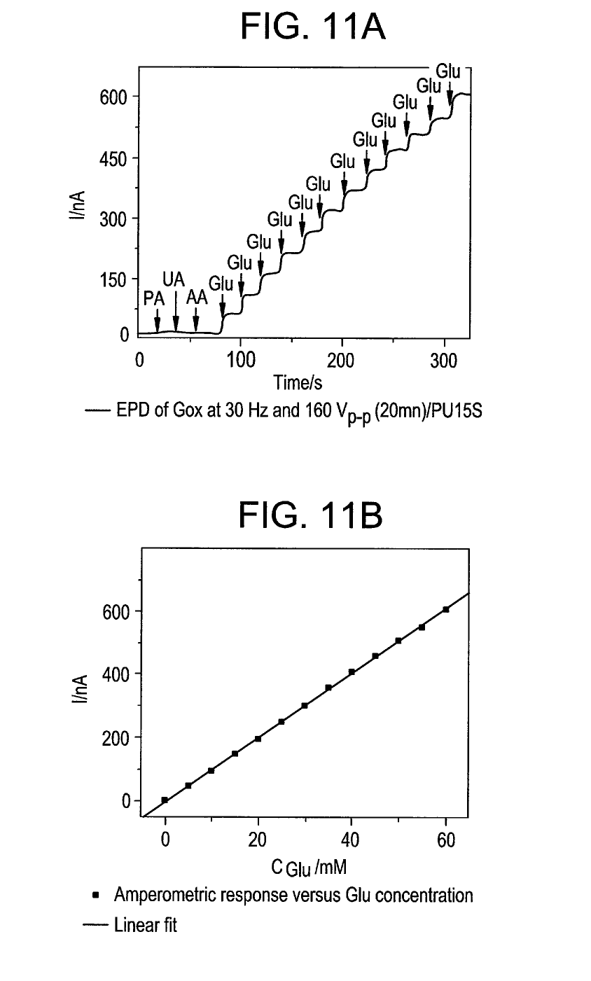

The PU outer membrane plays an important role in control of the glucose and oxygen fluxes in order to optimize the linearity of the sensor response and minimize the dependence on the oxygen concentration. In addition, it constitutes a supplementary barrier for the diffusion of the interferences. The oxygen concentration can be 100-1000 times lower than the concentration of glucose, making the oxygen the rate limiting substrate. This is also the reason why the linearity of this glucose sensor manufactured with Gox 5.6 units/mg is far from satisfactory without an outer layer of polyurethane. The outer membrane is especially important for IN VIVO measurements because of its ability to make the enzymatic reactions essentially independent of the oxygen partial pressure over a wide range while excluding erythrocytes, tissues, catalase and others oxidative interfering substrate at the electrode. The conventional method for the application of the polyurethane outer membrane is by dip coating, which leads to a poor control of the thickness of the membrane which may affect the sensitivity of the sensor. According to the present invention, using the PU spray, the linearity and current response to the interferences and glucose can be controlled. The optimal number of sprays is an issue. It is possible using the PU spray to keep higher sensitivity with good linearity to high glucose concentration and approach the current response of the interferences to zero. FIG. 10A to FIG. 10D shows the relationship between the current response to the interferences and two successive injections of 5 mM glucose, and the number of PU sprays. For the four cases, the deposition of the enzyme is made in the same experimental conditions with AC-EPD of Gox using the unbalanced (asymmetrical) triangular waveform (FIG. 2A) for 20 min at 30 Hz and 160 Vₚ₋ₚ, followed by delicate washing with ultrapure water and drying at ambient temperature, and then a PU membrane is applied to each case using 5, 8, 11 and 20 sprays, respectively. Going from FIG. 10A with 5 PU sprays to FIG. 10D with 20 PU sprays the current response to glucose and to the interferences decreases continuously. In FIG. 10A for example, the current response to glucose is very important, but the current response to the interferences is still high. In addition, the linearity is not good enough because after 4 or 5 glucose injections a net decrease in the current response is observed. In contrast, in FIG. 10D with 20 sprays practically no current response to the interferences is observed because the PU outer layer membrane is much thicker. However, the current response to glucose is also low, which is inconvenient. These and further studies show that the optimal number of the PU sprays to apply for a good sensor response including the sensitivity, linearity and response time is situated in the range of 12 to 17. FIG. 11A shows a typical current response to the interferences and successive additions of 5 mM glucose for a glucose oxidase sensor, which is manufactured as follow: the sensor electrode and the counter electrode were immersed in the Gox dispersion, unbalanced (asymmetrical) triangular signal (FIG. 2A) is applied for 20 minutes at 30 Hz and 160 Vₚ₋ₚ, then the electrode is slightly rinsed with ultrapure water, dried and finally sprayed 15 times with a fresh PU mixture. Practically no response to the interferences is observed and linear response of the sensor to the successive additions of 5 mM glucose is shown. The relationship between the current response to glucose and the concentration of the added glucose is illustrated in FIG. 11B The response to glucose seems to be linear up to 60 mM glucose, which means that the range of the linearity has broadened 0.5 to 2 times compared to prior art glucose sensor. At glucose concentrations above 60 mM, the response decreases progressively because of the oxygen supply and especially of the dilution effects. The response time is around 5 seconds, which was much shorter than most others reported glucose sensors (Guerrieri et al., Biosens. Bioelectron., 1998, 13, pp. 103-112). Furthermore, the sensitivity of this biosensor is around 13 nA/(mM·mm²), which is slightly higher than what is reported previously in biosensors with an outer layer membrane. In addition, the sensitivity can be increased significantly with decreasing the number of sprays, at the expense of the linearity. Finally, the response to the interferences significantly decreases thanks to the outer PU layer. Table 3 gathers the main characteristics of the sensor shown in FIG. 11A.

TABLE 3
Main characteristics of the glucose oxidase sensor shown
in FIG. 11A. Applied potential, +0.6 V vs. AgCl/Ag.

| area | 0.78 | mm² |
|---|---|---|
| sensitivity | 46.8 ± 3.2 nA/5 Mm Glu | |
| linear range of sensor | 60 | mM |
| response time | 5 ± 1 | s |

| | |
|---|---|
| interferences (AP + UA + AA) | 1.47 ± 0.2 nA/0.3 mM |

### Influence of Oxygen on the Sensor Performance

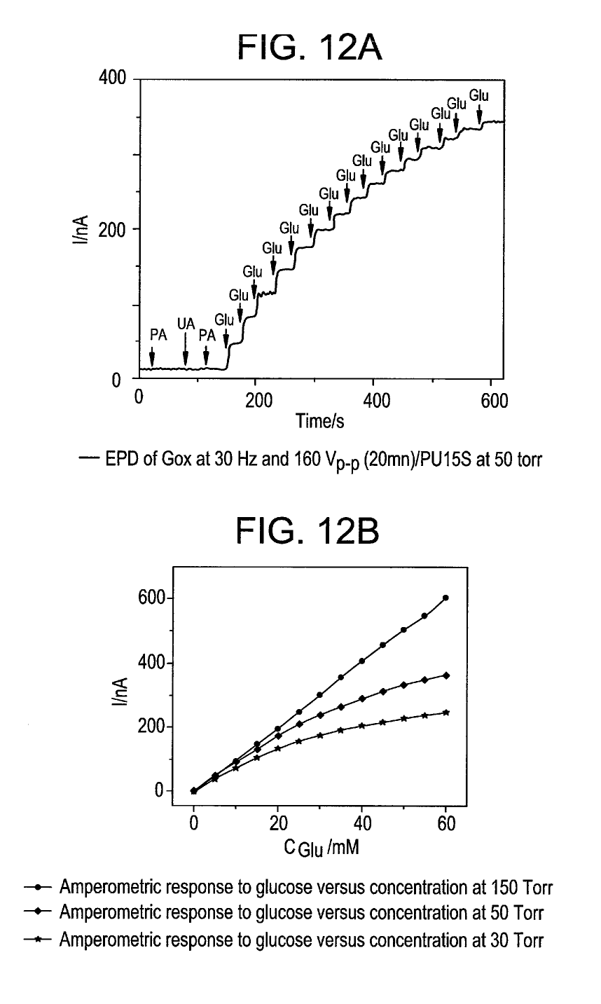

Since the oxidase-based sensor requires oxygen as the co-substrate to carry out oxidation, the effect of oxygen concentration on the sensor response was tested at different oxygen concentrations. In vitro measurements were performed in a closed electrochemical cell with glucose and oxygen sensor together in the same buffer solution pH=7.4. FIG. 12A illustrates another example of current response of a glucose oxidase sensor to the interferences and successive additions of 5 mM glucose manufactured using AC-EPD of the Gox with the unbalanced (asymmetrical) triangular waveform shown in FIG. 2A at 30 Hz and 160 Vₚ₋ₚ followed by 15 PU sprays, at around 50 torr oxygen partial pressure. The response of the sensor vis-à-vis of the interferences is negligible. The sensor at this oxygen concentration is linear up to 30 mM. FIG. 12B shows the relationship between the current response to successive additions of 5 mM glucose versus the concentration of glucose at three oxygen partial pressures of 150, 50 and 30 torr. The electrodes can maintain more than 90% of their response up to 20 mM glucose when the oxygen concentration was over 50 torr. When the oxygen partial pressure decreased to 30 torr, more than 70% of response is retained and the response to glucose is satisfactory linear up to 20 mM glucose. The sensor becomes oxygen dependent, when the oxygen partial pressure is under 50 torr, especially at higher glucose concentrations over 20 mM. This is understandable because of the high sensitivity electrodes manufactured according to the present invention (Y. Zhang and G. S. Wilson, Anal. Chim. Acta., 1993, vol 281, pp. 513-520).

### Stability of the Glucose Oxidase Sensor

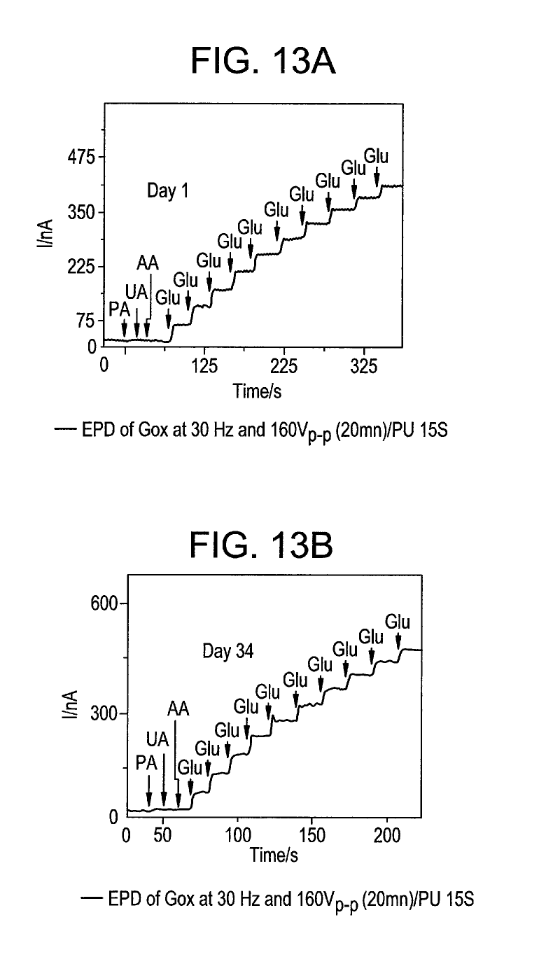

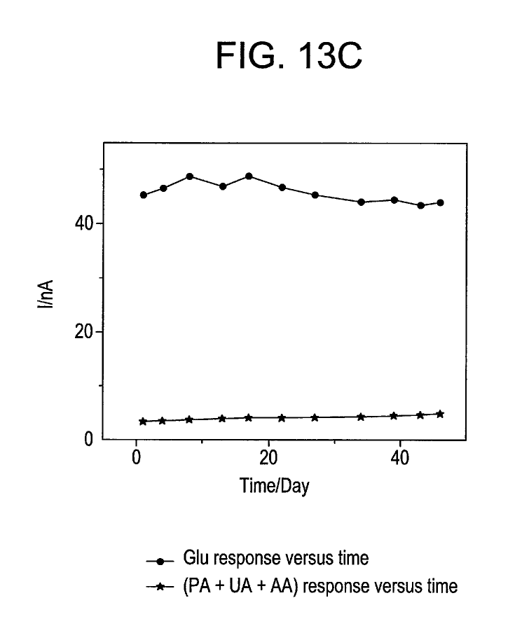

The stability of the glucose sensor manufactured according to this invention is investigated over a period of 45 days. The electrode was stored at room temperature and the response to glucose and interferences was checked regularly. FIG. 13A and FIG. 13B show two examples of current response to interferences and successive additions of 5 mM glucose of a manufactured glucose sensor tested on day 1 and day 34, respectively. The sensor is manufactured by deposition of the enzyme at 30 Hz and 160 Vₚ₋ₚ for 20 minutes using the unbalanced (asymmetrical) triangular waveform from glucose oxidase dispersion followed by 15 PU sprays and left to dry for 24 hours. The response of the sensor was then monitored day after day. No significant difference is observed between the two figures, except that the response to the interferences increases slightly at day 34 compared to day 1. FIG. 13C shows the stability of the sensor to the sum of the interferences and glucose over a period of 45 days. The response to glucose shows a slight increase initially than reaches a relatively stable value. However, the response to the sum of interferences shows a slight increase over this period of time, which maybe due to a partial deterioration of the mass transfer-limiting outer layer membrane of PU. The good stability of this sensor can be attributed to two points: on the one hand, a large amount of enzyme has been deposited on the surface of the electrode and this leads to a higher stability. On the other hand, the denaturalization of the enzyme is prevented because the environment from which the enzyme is deposited under unbalanced (asymmetrical) AC signal is not aggressive for the enzyme to leak out of the structure. Contrary to DC-fields, AC-fields lead to almost no electrolysis of water, thus a small change in the local pH which may affect the activity of the enzyme.

### Example 2

### Deposition of Catalase and Glutamate Oxidase

Deposition of catalase and glutamate oxidase under unbalanced (asymmetrical) triangular AC signal, are two other examples of the deposition of enzymes according to the process of the present invention. A brief description of the manufacturing of these sensors is given.

### Deposition of Catalase

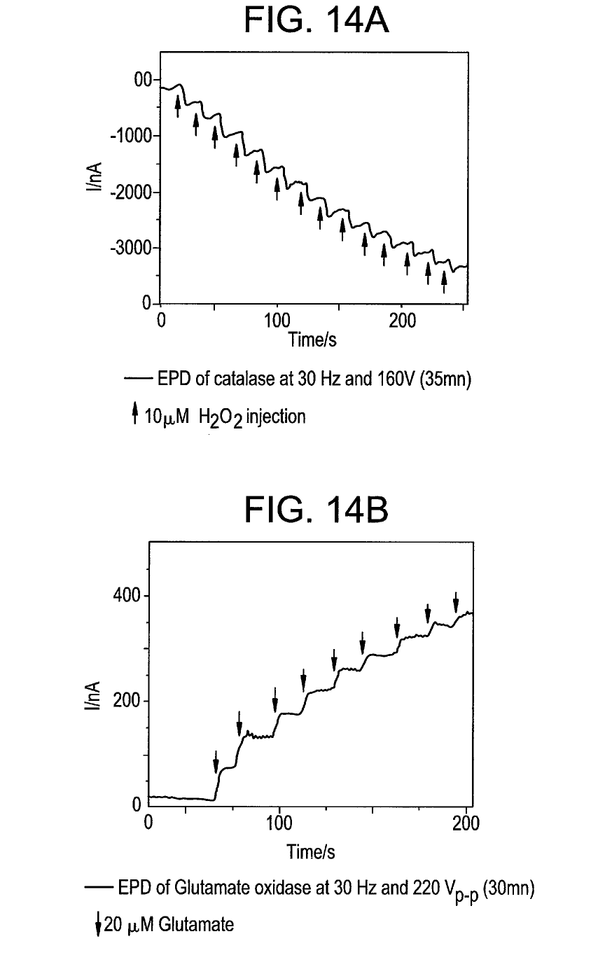

0.005 grams of catalase from bovine liver were dissolved in 0.5 mL of mixture of ultrapure water with NaOH conductivity lower than 30 μS/cm. A platinum deposition electrode (surface area of 0.78 mm²) and a platinum counter electrode are immersed in a small glass tube, positioned as parallel as possible and leaving a distance between the two electrodes at around 10 mm. The unbalanced (asymmetrical) triangular AC signal (FIG. 2A) at 30 Hz and 160 Vₚ₋ₚ was applied for 35 min between the deposition electrode and the counter electrode. The deposition electrode was then rinsed delicately with ultrapure water. For the testing of the activity of the deposited enzyme, hydrogen peroxide was used and the test was carried out in 5 mL phosphate buffer solution pH 7.4, by injecting 10 μM hydrogen peroxide (H₂O₂) from a freshly prepared solution. The polarization potential for the testing of this sensor is set at −0.1 V vs. AgCl/Ag. FIG. 14A illustrates a typical example of the current response to 10 μM hydrogen peroxide injections for a catalase modified electrode prepared as indicated above. It should be noticed that our experiments showed that no hydrogen peroxide is reduced at this polarization potential. Catalase is an enzyme which converts hydrogen peroxide into oxygen and water. Therefore, in our case, when 10 μM hydrogen peroxide is injected, it is immediately transformed by catalase into oxygen and water. Oxygen is an electroactive species, which in contact with platinum electrode polarized at −0.1 V vs. AgCl/Ag will be reduced to hydrogen peroxide. Consequently, a jump in the current is observed as is shown in FIG. 14A. In addition, the sensor shows good linearity.

### Deposition of Glutamate Oxidase

1 unit of glutamate oxidase from streptoyces sp was purchased from Sigma-Aldrich and was dissolved in 0.5 mL of ultrapure water. A platinum deposition electrode (surface area of 0.78 mm²) and a platinum counter electrode are immersed in a small glass tube, positioned as parallel as possible and leaving a distance between the two electrodes at around 10 mm (FIG. 1). The unbalanced (asymmetrical) triangular AC signal (FIG. 2A) at 30 Hz and 220 Vₚ₋ₚ was applied for 30 min between the deposition electrode and the counter electrode. The deposition electrode was then rinsed delicately with ultrapure water and tested in 5 mL phosphate buffer solution pH 7.4, by injecting 20 μM glutamate (Glu) from a freshly prepared solution. The polarization potential for the testing of this sensor is set at 0.6 V vs. AgCl/Ag. FIG. 14B shows a typical example of the current response to 20 μM glutamate injections for a glutamate sensor prepared as indicated above. A glutamate sensor is based on the conversion of the glutamic acid or glutamate into glutaraldehyde by glutamate oxidase. In the same time, oxygen is reduced to hydrogen peroxide by the electrons generated by the previous reaction, which in contact with platinum electrode polarized at 0.6 V vs. AgCl/Ag, the generated hydrogen peroxide oxidized into oxygen. If we compare to the commercialized glutamate sensor such as from Pinnacle Technology Inc. for example where, only a few nA are observed for 10 μM glutamate injection, the present sensor shows a much higher current response.

### Example 3

### Deposition of saccharomyces cerevisiae Cells

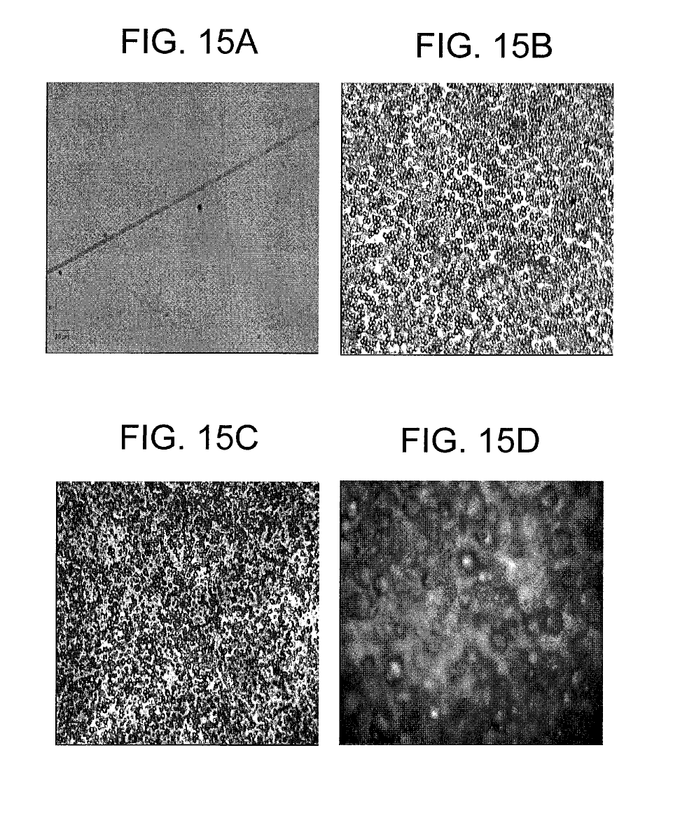

Bread yeast cells (Saccharomyces cerevisiae) are used as a demonstration system for the deposition of cells under AC conditions. 0.1 grams of the commercialized yeast bread were dissolved in a small glass tube containing 0.5 mL ultrapure water and a platinum counter electrode attached on the one side of the glass tube (FIG. 1). The dispersion was stirred delicately for a few minutes, and then a platinum deposition electrode was immersed and attached to the other side of the glass tube. To prevent sedimentation of the cells on the glass bottom, a very small amount of surfactant is useful. The distance between the working electrode and the counter electrode is left at around 10 mm. The unbalanced (asymmetrical) triangular AC signal (FIG. 2A) with 30 Hz and 130 Vₚ₋ₚ was applied for a time t to the dispersion under permanent delicate stirring. The deposition electrode was then disconnected before switching off the amplifier and rinsed carefully with ultrapure water and, dried at ambient temperature. For the characterization of the modified electrode, an optical microscope is used for that purpose. FIG. 15B and FIG. 15C show two pictures of the formed films under the microscope for t=10 and 30 minutes, respectively. For comparison, a picture of the same platinum electrode polished and cleaned abundantly with ultrapure water is taken using the same magnification, which is shown in FIG. 15A. It is obvious from the comparison of FIG. 15B, FIG. 15C and FIG. 15A that saccharomyces cerevisiae are deposited on the platinum electrode. The deposition time is an issue, it can be seen that the deposited film at 30 min is much dense than at the one deposited for 10 min. FIG. 15D shows the film of FIG. 15B under higher magnification. More important, the formed cells film deposited according to the present invention is irreversible, stable and probably active. Vanessa Brisson et al., Biotechnology and Bioengineering, 2002, 77(3), pp. 290-295 have reported that the same cells can be forced to form two dimensional cells clusters using AC-EPD. However, the monolayer arrays are reversible. In other words, the cells do not adhere and deposit on the surface of the electrode. Virtually, any biological cell can be deposited following the process of this present invention. The cells films deposited according to this invention can find applications as cell-based sensors, assays and bioreactors. Particular interests will be given for bacteria and nerve cells modified electrodes, which have major important application in bacteria based bioreactors and nerve cells chips for bioinformatics.

### Example 4

### Deposition of Glucose Oxidase

Enzyme deposition was carried out by the application of the asymmetrical AC signal. The glucose oxidase (GOx) used was crude from aspergillus niger 5.6 units·mg and 200 units/mg. The dispersion for the deposition of enzyme was prepared as follows: 50 mg of GOx (5.6 units/mg) or 5 mg GOx (200 units/mg) was dissolved in a small glass tube containing 0.5 mL (ultrapure water+NaOH, conductivity of 23 μS/cm at 25° C.). The deposition and counter electrode were dipped in the enzyme dispersion and the distance between the two electrodes was around 10 mm. The asymmetrical AC signal was then applied at specific frequency and amplitude over a period of time t. Next, the electrode was rinsed with ultrapure water and then tested in 5 mL phosphate buffer solution pH 7.4 by injecting 10 μl of acetaminophen (0.1 mM), uric acid (0.1 mM), ascorbic acid (0.1 mM) and several injections of glucose (5 mM). The enzyme dispersion was prepared fresh daily. A potentiostat (CMS 100, GAMRY) connected to a computer for the data acquisition was used for testing the sensors (amperometry). AgCl/Ag was used as a reference electrode, and the polarization was set at +0.6 V vs. AgCl/Ag.

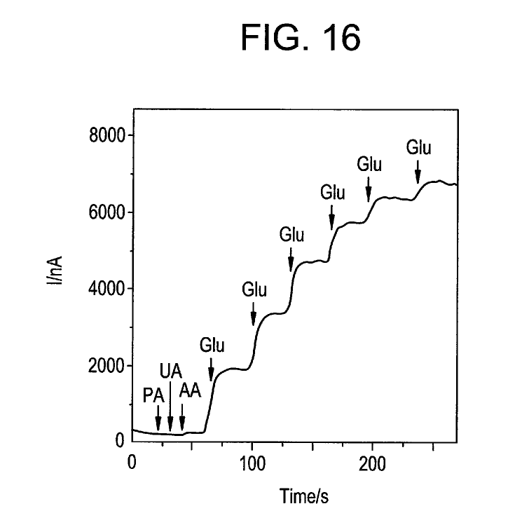

Parameters such as frequency, amplitude, deposition time had an influence on the sensor response vis à vis the glucose and the interferences. Amplitudes above 160 Vₚ₋ₚ, frequencies around 30 Hz and much longer deposition times were found to be optimal for a good sensor response. These parameters gave the highest ration of enzyme activity as measures by the current response due to peroxide oxidation issue from the conversion of the glucose injected. Current response up to 4600 nA/mm² have been observed using a low activity enzyme of 5.6 units/mg. Because the biosensor was monitored at +0.6 V vs. AgCl/Ag, a number of endogenous species such as ascorbate, urate and acetaminophen were electroactive. The selectivity of a biosensor was measured by the ratio of the current response to glucose to the interferences. It was observed that the response to the interferences can be decreased considerably if the enzyme is deposited at the optimal parameters including frequency, amplitude and deposition time as it is shown in FIG. 16, which illustrates the current response to 0.1 mM PA, UA and AA and successive additions of 5 mM glucose. The ratio of the response I_{Glu}/I_{interf} is 559, which is due to the high enzyme activity resulting from AC-EPD of the enzyme. Furthermore, the response was practically linear up to 20 mM glucose without employing any mass transfer limiting outer membrane. This behavior is related to the morphology of the formed GOx film. The thickness of the deposited film regulates the diffusion of the glucose fluxes, hence regulating to some degree the oxygen consumption. Thicker films are known to exclude the interference, but they will also lower the sensitivity to the analyte. In our case, the sensitivity was surprisingly unaffected, on the contrary, the thicker the film, the more the sensitivity increases. Direct electrodeposition of glucose oxidase by means of DC polarization only leads to amperometric responses of a few tenths of nA. compared to a few thousandth of nA observed was the enzyme layers produced according to the present invention.

The thickness of the enzyme layer increased with deposition time. Initially the current response to glucose increases linearly with the applied amplitude up to 160 Vₚ₋ₚ and shows a further slight increase at higher amplitudes. The influence of deposition frequency was investigated at 160 Vₚ₋ₚ and the current response was found to increase strongly up to 30 Hz and then continuously to decrease up to 250 Hz, whereas the response to the interferences exhibited the opposite behaviour. Hence, the optimum value of the applied frequency is about 30 Hz. At frequencies below 30 Hz, AC electrolysis of water takes place which pushes the enzyme from the surface of the electrode.

Contrary to the deposition of enzymes under high DC potentials where denaturalization takes place, our experiments demonstrate that the deposition of the enzyme under high AC potentials surprisingly preserves or possibly enhances the activity of the enzyme. It is no known why AC-EPD influences the activity of the enzyme. The superior sensor performance is due to the ability to deposit a thick compact and active layer of enzyme on the substrate using the coating process according to the present invention.

### Example 5

### Deposition of saccharomyces cerevisiae

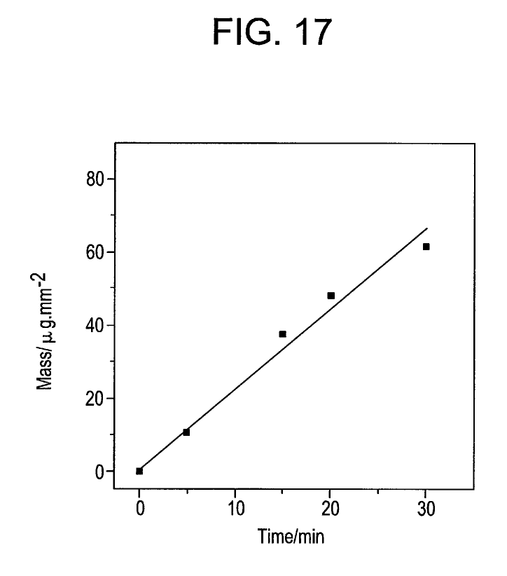

The deposition of saccharomyces cerevisiae (SC) cells was carried out by the application of the asymmetrical AC signal shown in FIG. 2A. The SC cells were first washed with ultrapure water and centrifuged several times to remove the excess salts until the final conductivity was below 20 μS/cm. The cells dispersion was prepared as follows: 0.2 g of the prepared cells was dissolved in a small glass tube containing 1 mL (ultrapure water+NaOH, conductivity of 51 μS/cm at 25° C., total conductivity after the cells addition 82 μS/cm). The final pH of the dispersion was 5.8. The deposition and counter electrode were dipped in the dispersion cell and the distance between the two electrodes was around 10 mm. The asymmetric AC signal is then applied at 30 Hz and 200 Vₚ₋ₚ, which was found to be optimal for the deposition of SC cells, during a time t. The mass of SC cells deposited at 30 Hz and 200 Vₚ₋ₚ on a stainless steel electrode as a function of deposition time is shown in FIG. 17.

Next, the electrode was rinsed with ultrapure water and air dried for 24 hours. To increase the mechanical stability of the immobilized cells and in order to avoid cells from desorption, a thin layer of polyurethane (PU) was applied, which was prepared as follow: 0.200 g polyol was added to 0.224 g isocyanate (BAYDUR 20, Bayer). Without mixing, 13.4 grams of tetrahydrofurane (THF) extra dry (water <50 ppm) and 0.24 gram of dimethylformamide (DMF) were added. The quality of THF and DMF was very important. Anhydrous grades are recommended to allow for a good polymerization of the membrane. Next, the mixture was stirred for two minutes and transferred to a small perfume bottle which was used as a spraying device. The electrode, on which the SC cells were deposited, was fixed at a distance of 15 cm from the spraying bottle and sprayed 1 or 2 times with the freshly prepared PU mixture, which allows a deposition of a very thin layer of PU. The deposition electrode was left to dry at room temperature for 24 hours.

For the mass measurements, a stainless steel electrode with a surface area of ca. 32 mm² was immersed in a dispersion of SC cells (0.2 g/1 mL mixture of ultrapure water and NaOH at conductivity of 51 μS/cm, total conductivity total conductivity after the cells addition 82 μS/cm). The cell deposition was carried out as previously described. The electrode was washed with ultrapure water; oven dried at 40° C. for 1 hour then weighted a second time with the microbalance. The mass of the deposited SC cells was calculated from the difference between the initial mass of the electrode and the mass after the deposition. The average thickness of the cell layer was 89 μm giving a density of 0.816 g/mL indicating a volume fraction of 82%. The amount of deposited SC cells increased linearly with time.

The synthetic culture medium used for the fermentation consisted of (in mg/mL): glucose, 100; (NH₄)₂SO₄ 2; MgSO₄, 12; KH₂PO₃, 1. All media were adjusted to pH 5.5 and autoclaved at 120° C. for 20 min before use. On the one hand, a stainless steel electrode (surface area ca. 32 mm²) was modified with SC cells for 15 min under unbalanced AC-signal. The corresponding deposited mass weighed after drying was 1.14 mg. The electrode was covered with a thin layer of polyurethane and dried at ambient temperature for 24 hours. The modified electrode was then immersed in a small tube containing 500 μL of the fermentation solution. The free and the immobilized SC cells were incubated at 37° C. for more than 40 hours under nitrogen atmosphere. Every few hours, the solution in each tube was mixed and micro-filtration was carried out for the free cells. On the contrary, for the immobilized cells, no filtration was needed. After an induction period of 8 hours in which only 10% of the glucose was transformed into alcohol, compared with 40% for the free SC cells, the activity increased quickly and the fermentation process increased quasi-linearly with time between 8 and 24 hours until all the glucose was exhausted.

### Example 6

### Glucose Microbiosensor Based on Glucose Oxidase Immobilized by AC-EPD

The AC-signal used was composed of two triangular waves of opposite amplitude but with different height and duration. The half-cycle with high amplitude section and low duration time corresponds to the negative part of the AC-signal. However, the area of both triangular waves was equal, so that the signal had no net DC component, i.e. the integral of the AC-signal over one period was zero. Before each experiment, the AC-signal was integrated to verify that the integral of the applied signal over one period was equal to zero.

This electrochemical cell used contained two electrodes, a platinum counter electrode and a working electrode on which the enzyme was deposited and that was later used as a biosensor. The biosensor electrode was connected to the electrode whose polarity with respect to the counter electrode changed positively for a longer time at low amplitude and became negative for a short duration at high amplitude as reported online on Jul. 1, 2009 by M. Ammam et al. in Biosens Bioelectron., volume 25, pages 191-197].

The enzyme deposition was accomplished by the following route: the sensor electrode was immersed in an enzyme solution containing 50 mg GOx dissolved in 0.5 mL aqueous NaOH solution (ultrapure water+NaOH, conductivity of 23 μS/cm, pH 7.64). The total conductivity and pH after addition of GOx is 250 μS/cm and pH 6.98. A platinum wire in the form of a spiral was used as a counter electrode and positioned around the sensor electrode. This configuration permits the electrophoretic deposition of a homogeneous enzyme layer on the cylindrical sensor electrode. The asymmetrical AC-signal is then applied at 30 Hz and 160Vp-p for period of time t [see M. Ammam et al. in Biosens Bioelectron., volume 25, pages 191-197, (2009)]. Next, the sensor is rinsed gently with ultrapure water and then tested in 5 mL phosphate buffer solution pH 7.4 by injecting 10 μL of acetaminophen (0.1 mM), uric acid (0.1 mM), ascorbic acid (0.1 mM) and several injections of glucose (5 mM).

The sensor with an outer layer of polyurethane (PU) is prepared according to the following procedure: after the AC-EPD of GOx, the sensor electrode is rinsed with ultrapure water and air-dried. Next, a polyurethane membrane was applied as follow: under constant stirring, 13.4 g of tetrahydrofuran (THF) extra dry (water <50 ppm) and 0.24 g of dimethylformamide (DMF) were added to 0.424 g of polyurethane. Anhydrous grades of THF and DMF are recommended to allow a good polymerization of the membrane. The mixture is stirred for few minutes and transferred to a small perfume bottle, which was used as a spraying device. The sensor electrode with enzyme layer is fixed at 15 cm from the spraying bottle and sprayed n times with the freshly prepared PU mixture. The sensor electrode is left to dry at room temperature for 24 h. The number of sprays and the time between successive sprays are important features. The time between successive sprays should be as short as possible.

A potentiostat (CMS 100, GAMRY) connected to a computer for data acquisition was used for the testing of the sensors (amperometry). AgCl/Ag was used as a reference electrode, and the polarization was set at +0.6V vs. AgCl/Ag.

### Characteristics of the GOx Electrode

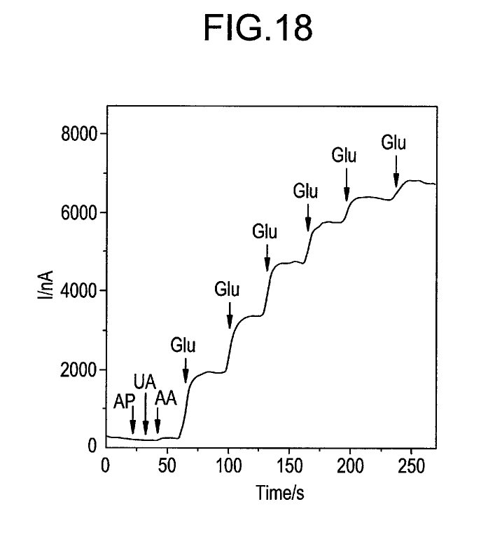

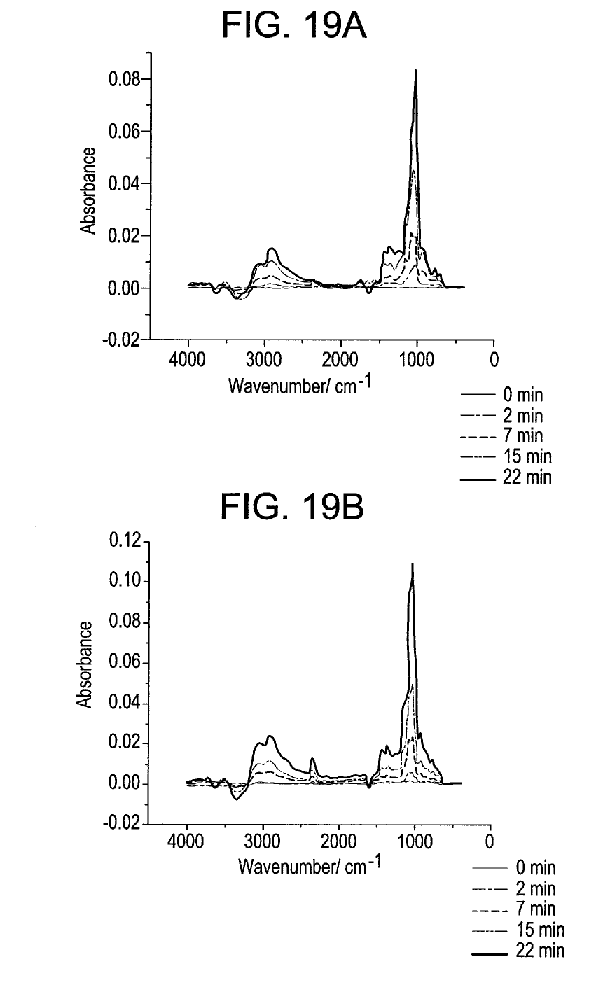

The major aim of this work was to deposit enzymes by means of electrophoresis for sensing purposes. There are two advantages of depositing enzymes by means of asymmetrical AC-EPD, the first is ease and control of the manufacturing process and the second is the formation of thick and active enzyme layers, which eliminates the need of permselective membrane. Parameters such as enzyme concentration, deposition time, amplitude and frequency have been shown to influence the sensor response to glucose and interferences. We found that enzyme concentrations ca. 100 mg/mL, amplitudes around 160Vp-p, frequencies of ca. 30 Hz and deposition times of 10 min or longer to be optimal for a good sensor response [see M. Ammam et al. in Biosens Bioelectron., volume 25, pages 191-197 (2009)]. These parameters yield the highest ratio of current due to glucose to current due to the interferences. As shown in FIG. 18, current responses to glucose of 430 nA/mM mm² have been observed using a low-activity enzyme (5.6 U/mg). In comparison, direct electrodeposition of glucose oxidase by DC electrodeposition leads to amperometric responses of only a few tens of (nA/mM mm²) as reported in 2002 by X. Chen et al. in Anal. Chem., volume 74, pages 368-372; in 1996 by M. C. Shin et al. in Biosens. Bioelectron., volume 11, pages 161-169 and 171-178. S. H. Lim et al. reported in 2005 in Biosens. Bioelectron., volume 20, pages 2341-2346, and Y. C. Tsai et al. reported in 2006 in Biosens. Bioelectron, volume 22, pages 495-500, several methods to increase the current response such as simultaneous electrodeposition of enzyme and platinum, gold or palladium nanoparticles or carbon nanotubes. However, the deposition process is more complicated. Here, using only the enzyme, large currents are obtained. This is due to the formation of thick enzyme layer and to the preservation of the enzyme activity. Mass measurements carried out with a microbalance showed that the mass increase on the platinum electrode after 20 min was 2.88 μg/mm2 when the optimal parameters were used and the estimated thickness in these conditions from scanning electron microscopy was ca. 7 μm [see M. Ammam et al. in Biosens Bioelectron., volume 25, pages 191-197 (2009)]. The activity towards glucose oxidation of the deposited enzyme was compared to the same amount of free enzyme by FT-IR and the results are shown in FIG. 19. After a few minutes, several characteristic peaks appear whose intensities increase with time. The peaks situated at about 3529-3079 cm⁻¹ and 1364 cm⁻¹ (—OH str.) are characteristics of d-glucono-1,5-lactone, d-gluconic acid and hydrogen peroxide and the peaks situated at 2910 cm⁻¹ (OH— str. or C—H str.), 1740-1653 cm⁻¹ (C—O str.), 1460-1100 cm⁻¹ (CH₂, COH and CCH bending modes) [see M. Hineno, Carbohydr. Res., volume 56, pages 219-229 (1977) and J. J. Cael et al., Carbohydr. Res., volume 32, pages 79-91 (1974)], 1100-900 cm⁻¹ (C—O str.), 779-705 cm⁻¹ (C—H str. or O—H str.) are characteristics of either d-glucono-1,5-lactone or d-gluconic acid [see H. A. Tajimir-Riahi et al., Can. J. Chem., volume 67, pages 651-654 (1989), H. A. Tajimir-Riahi, Bull. Chem. Soc. Jpn., volume 62, pages 1281-1286 (1989) and K. Kamali et al., Anal. Biochem., volume 333, pages 320-327 (2004)]. The two weak transmission peaks situated at 3334 and 1682 cm-1 are characteristics for hydrogen peroxide. The strong similarity between both figures, both in peak position and peak height, strongly indicate that the deposited GOx behaves very similar to the free GOx enzyme and that the activity of the deposited enzyme is not affected by the AC-deposition.

Because the biosensor is monitored at +0.6V vs. AgCl/Ag, a number of endogenous species such as ascorbate, urate and acetaminophen are electroactive. The selectivity of a biosensor is measured by the ratio of the current response to glucose to the current response to interferences. It is observed that the response to the interferences can be decreased considerably if the enzyme is deposited using appropriate conditions. This is seen in FIG. 18, which shows the current response to 0.1 mM AP, UA and AA and successive additions of 5 mM glucose. The ratio of the response IGlu/Interfis 559, which is due to the high activity of the deposited enzyme and to the exclusion of a substantial amount of the endogenous interferences. We found that the sensitivity and selectivity increase with increasing thickness of the enzyme layer [see M. Ammam et al. in Biosens Bioelectron., volume 25, pages 191-197 (2009)]. This happens because more hydrogen peroxide is produced by the enzymatic reaction as the film becomes thicker. The electroactive species for glucose detection is the H₂O₂ issued from the enzymatic conversion of glucose within the GOx film and this conversion occurs everywhere inside the film. In other words, glucose does not need to cross the entire film to be converted to H₂O₂, which, due to its smaller size, has a much higher diffusion coefficient. However, the oxidation of the interferences at the polarized electrode implies their diffusion across the entire film. It was also observed that the current due to interferences decreases exponentially with increasing thickness [see M. Ammam et al. in Biosens Bioelectron., volume 25, pages 191-197 (2009)]. While thicker films will limit the diffusion of the interferences through the film, the rejection of the interferences is too high to be caused only by the increase of thickness of the enzyme film. Hence, we need to assume that the diffusion coefficient of the interferences inside the film is 500 times lower than estimated from literature or that the diffusion coefficient of interferences depends on the thickness of the film, perhaps because the film becomes more compact as its thickness increases.

As shown in FIG. 18, the sensor has also a fast response time, reaching 95% of the final value in less than 10 s. However, it was observed that the response time increases with deposition time. For example, for 10, 20 and 35 min deposition times, the response time of the sensor is 6, 10 and 19 s, respectively. As the thickness of the GOx deposit increases linearly with the deposition time [see M. Ammam et al. in Biosens Bioelectron., volume 25, pages 191-197 (2009)], the diffusion through the film becomes more difficult as the film becomes thicker and perhaps also more compact.

The detection limit of the glucose sensor prepared by AC-EPD is less than 0.1 mM, and is mostly determined by the precision of the potentiostat. However, it is important to note that glucose, typically measured in the brain or interstitial fluid of the subcutaneous tissue, is present at high concentration (mM) and therefore do not pose detection limit problems. Because the concentration is high, the oxygen supply is not sufficient to support the enzymatic reaction. Tissue oxygen concentrations are an order of magnitude below that of glucose, which leads to a moderate linear range. This problem was addressed with the deposition of a polymer layer on top of the enzyme, which reduces the flux of glucose, whereas the flux of oxygen is not affected. FIG. 18 shows that the sensor prepared by AC-EPD without employing any outer polymer layer is linear up to 20 mM glucose. This behavior is probably related to the morphology of the GOx film. The thickness and the compactness of the deposited film regulate the diffusion of the glucose fluxes, hence regulating the oxygen consumption.

### Stability of the GOx Electrode

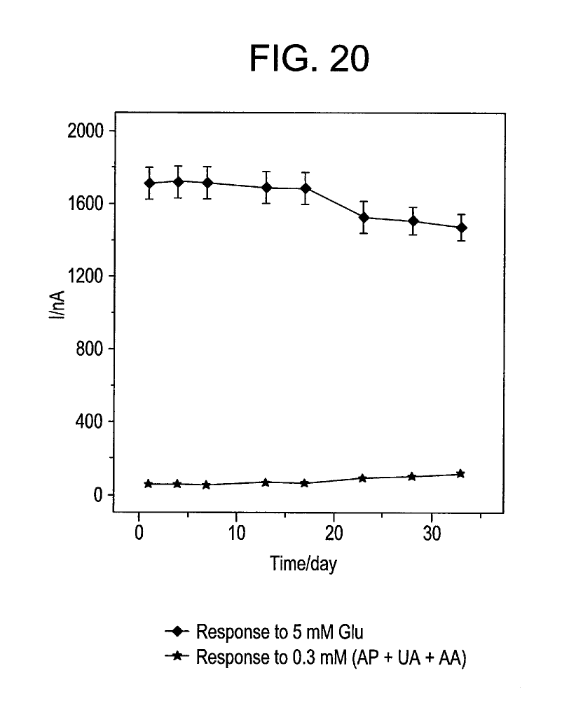

FIG. 20 shows the response of the sensors to glucose and interferences for a period of 30 days. These sensors have no mass transfer-limiting PU membrane and therefore show how the activity of the enzyme layer varies with time. The response to glucose and interferences is quasi-stable during the first 3 weeks but shows a continuous decrease during the last week. The response to the interferences is almost constant during the first 2 weeks and slowly increases during the last 2 weeks. This is understandable since no outer membrane was used for the stabilization of the enzyme layer; the immobilized enzyme suffers from a continuous dissolution after each supplementary testing in the buffer solution.

### Evaluation of the GOx Electrode in Human Serum and in Blood of Diabetic Rabbits

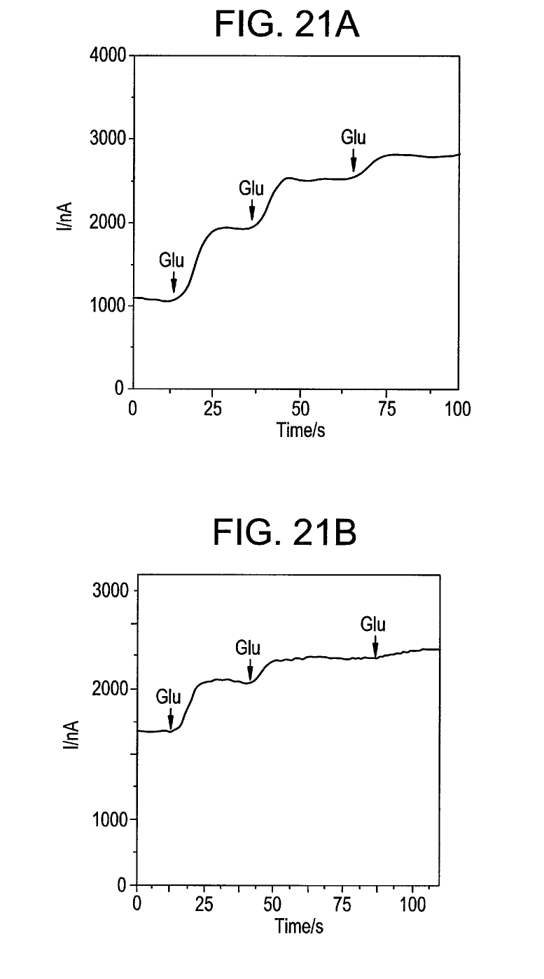

In order to evaluate the performance of the sensor made by AC-EPD for in vivo use, it was tested in human serum at 37° C. and in blood of diabetic rabbits. The glucose concentration of the human serum (Sigma-Aldrich, product H4522) is 4.89 mM. Under permanent stirring, the GOx electrode and a reference AgCl/Ag were immersed in 5 mL human serum at 37° C. or in 200 μL rabbit blood just taken from the neck vein. The GOx electrode was polarized at +0.6V vs. AgCl/Ag and successive injections of 5 mM glucose were carried out once a stable background current was obtained (variation of the response was less than 20 nA over 1 min). Since the background current and response to the interferences of the Gox electrodes manufactured according to the process of AC-EPD are negligible compared to the response to glucose (FIG. 18), it is possible to do the measurements without subtracting the currents due to the background and interferences. Therefore, it will be possible to evaluate the glucose level in human serum and in rabbit blood according to the obtained values of the background currents in these media, which are mostly due to the presence of glucose. By comparing the latter to the current values of 5 mM glucose injections (calibration points), it will be possible to estimate the glucose concentration in human serum and in blood. For that the linearity is an issue because the calibration values depend on it. FIG. 21A shows the amperometric response of the sensor in human serum at 37° C. The background current after stabilization was about 1060 nA. After the first injection of 5 mM glucose, the current jumps to 1928 nA. Further injections of 5 mM glucose lead to progressively smaller current steps. Compared to the currents obtained in buffer solution (FIG. 18) the current response to glucose is half of its value in buffer solution and the linearity is decreased from about 20 mM to around 10-15 mM. The estimated glucose value from FIG. 21A using two calibration points (the two first injections of 5 mM glucose) is 5.6 mM. Thus there is an error of about 15% between the real and estimated values. This error is mainly attributed to the decrease in the linearity.

The evaluation of the GOx electrode in blood of diabetic rabbits is practically similar to the response in human serum (FIG. 21B). However, the current response to 5 mM glucose and the linearity is lower in blood than in human serum. Similar reductions of sensor sensitivity were reported in 1989 by J. M. Elbicki et al. in Biosensors, volume 4, pages 251-257; in 2007 by G. S. Wilson et al. in FEBS J., volume 274, pages 5452-5461; in 2006 by R. Gifford et al. in Biomaterials, volume 27, pages 2587-2598; and in 2001 by M. Gerritsen et al. in J. Biomed. Mater. Res., volume 54, pages 69-75. The reasons for these reductions are not fully understood, but evidence points to small molecules as the culprit. These include proteins fragments that are presumably products of the acute inflammatory response. These molecules restrict the diffusion of glucose into the enzyme layer. In fact, we have observed that the sensor recovers most of its sensitivity when it was removed from the blood or human serum and tested in buffer solution. The decrease in the linearity might be related to the decrease in the oxygen concentration in rabbit blood. Compared to buffer solution where the partial pressure of oxygen is around 150 Torr, in blood the partial pressure is around 100 Torr. The estimated blood glucose concentration for the sick rabbit used for this study is 10.4 mM (determined with a glucose meter Hemocue glucose 201+). From FIG. 21B, it can be seen that the concentration of the glucose is around 10 mM because the background current response is more than double of the current response due to the first injection of 5 mM glucose. Using one calibration point (the first injection of 5 mM glucose), the estimated glucose concentration for this sick rabbit is about 13.2 mM. Consequently, the difference between the two measurements is around 21%. This large difference is mainly due to the decrease in the linearity of the glucose sensor, which is less than 15 mM due to the lower oxygen concentration in blood.

In summary, GOx electrodes without an outer membrane prepared by AC-EPD process maybe used for the determination of the glucose concentration in a healthy rabbit, where the blood glucose concentration is around 5 mM. However, for sick rabbits where the concentration of glucose might be more than 30 mM, an outer membrane is needed to increase the linear range of the sensor.

Performance of the Glucose Sensor with an Outer Layer of Polyurethane

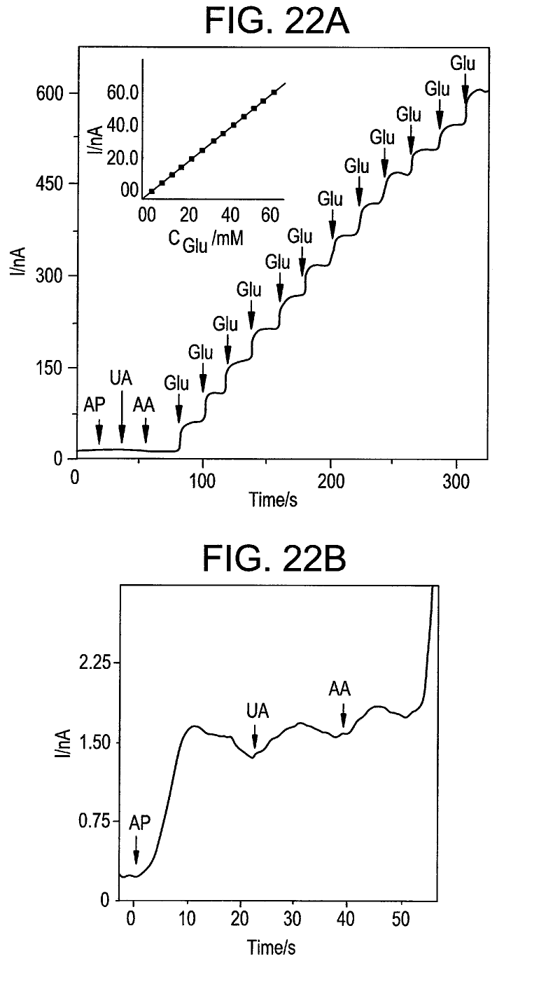

As shown in FIG. 18, the linearity of the glucose sensor made by the AC-EPD of GOx is satisfactory up to 15-20 mM glucose (in buffer solution), but drops to 10-15 mM when the sensor was tested in human serum or in blood. In order to optimize the linearity, stability and biocompatibility, an outer membrane of polyurethane is applied by spray-coating. After the AC-EPD of GOx, the electrode was fixed at a distance d from the nozzle and sprayed n times. Our results showed that as the number of sprays increases, the linearity increases and the sensitivity decreases. By increasing the number of sprays, it is possible to find a thickness that combines good linearity with reasonable sensitivity. FIG. 22A shows a typical current time curve for a biosensor with an outer PU membrane upon the injection of glucose and various electroactive interferences. The response to 0.1 mM AP, UA and AA were essentially negligible (FIG. 22B). Contrary to the sensor without PU outer layer where the current response to ascorbic acid was much higher than the current response to uric acid and acetaminophen (FIG. 18), the current response to acetaminophen is almost twice the response to ascorbic acid and uric acid when a polyurethane layer is present. This might be related to the hydrophobicity of the polyurethane membrane. Because acetaminophen is more hydrophobic than ascorbic acid and uric acid, it will diffuse more easily through the membrane. FIG. 22A also shows that the response to glucose is linear up to 60 mM, which is two times larger than glucose sensors reported in 2002 by M. C. Rodriguez et al. in Anal. Chem., volume 34, pages 1829-1840, and in 1998 by A. Guerrieri et al. in Biosens. Bioelectron., volume 13, pages 103-112. Surprisingly, the response time is around 6 s, which is lower than the response time without PU membrane (FIG. 18).

This might be due to a decrease in the film thickness after application of the PU outer layer. The PU layer might exercise some kind of pressure on the soft deposited GOx film. Therefore, the diffusion of the produced hydrogen peroxide will be much fast to reach the electrode and oxidized. In other words, by reducing the GOx film thickness resulting from the pressure applied by the PU outer layer, the traveling time of the produced H₂O₂ within the film to reach the electrode and oxidized will also be reduced. Furthermore, the sensitivity of this biosensor is around 13 nA/(mM mm²), which is slightly higher than what was reported in 2002 by X. Chen et al. in Anal. Chem., volume 74, pages 368-372, and in S. K. Jung et al. in 1996 in Anal. Chem., volume 68, pages 591-596, for biosensors with an outer membrane. In addition, the sensitivity can be increased significantly by decreasing the thickness of the PU layer, at the expense of linearity. Table 4 below gathers the main characteristics of the sensor shown in FIG. 22A.

TABLE 4

| Area | 0.78 | mm2 |
|---|---|---|
| Sensitivity | 46.8 ± 3.2 nA/5 mM Glu | |
| Linearity | 0.1-60 | mM |
| Response time | 6 ± 1 | s |
| Interferences (AP + UA + AA) | 1.67 ± 0.2 nA/0.3 mM | |
| Detection limit | <0.1 | mM Glu |

### Influence of Oxygen Concentration on Sensor Performance

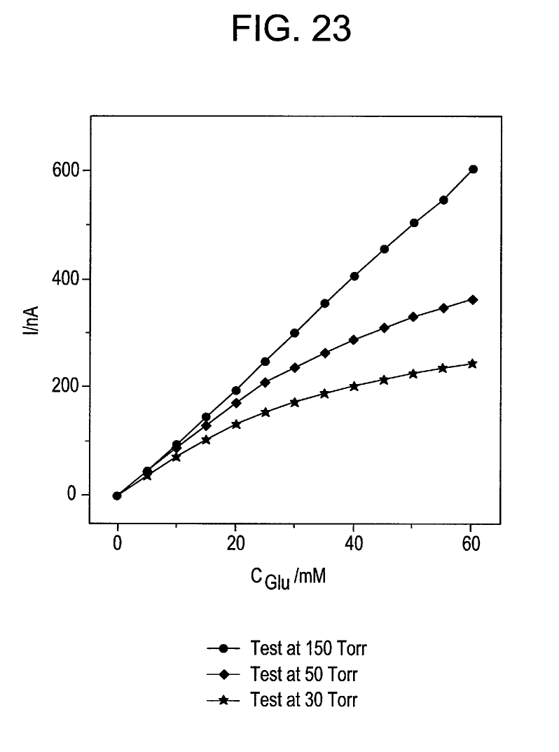

Since the oxidase-based sensor requires oxygen as the co-substrate, the effect of oxygen concentration on the sensor response was investigated. This gives an idea about the limitation of the sensor for implantation or for studies under ischemic conditions where the oxygen concentrations are very low. In vitro measurements were performed in a closed electrochemical cell with a glucose and oxygen sensor in the same buffer solution (pH 7.4). FIG. 23 shows the relationship between the current response to successive additions of 5 mM glucose vs. the concentration of glucose at oxygen partial pressures of 30, 50 and 150 Torr. It will be noted that the sensor maintains more than 90% of its response up to 20 mM glucose when the oxygen concentration was over 50 Torr. When the oxygen partial pressure decreased to 30 Torr, more than 70% of response is retained and the response to glucose is linear up to 20 mM glucose. The sensor becomes oxygen dependent when the oxygen partial pressure is below 50 Torr, especially at glucose concentrations over 20 mM. This is understandable because of the high sensitivity of the sensors obtained with this process as reported in 1993 by Y. Zhang et al. in Anal. Chim. Acta, volume 281, pages 513-520.

Stability and Reproducibility of the Sensor with PU Outer Layer

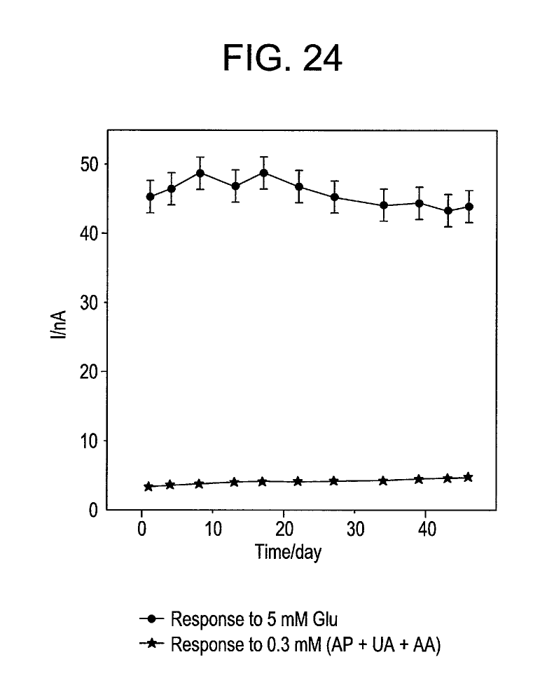

The stability of the glucose sensor with PU outer layer was investigated over a period of 45 days. The sensor was stored under air at room temperature and the response to glucose and interferences was checked every 3-4 days. FIG. 24 illustrates the stability of the sensor to the sum of the interferences and glucose during this period. The response to glucose initially slightly increased, then reaches a relatively stable value. The response to the sum of interferences shows a slight increase which may be due to the partial deterioration of the PU membrane. The stability of this sensor can be attributed to two points: on the one hand, a large amount of enzyme has been deposited on the surface of the electrode and this leads to a higher stability. On the other hand, the denaturation of the enzyme is prevented because the deposition conditions during AC-EPD are not aggressive for the enzyme to leak out of the structure. The reproducibility of the complete biosensor response can be estimated ca. 90%. The good reproducibility of the sensors are due to the reproducibility of the AC-EPD manufacturing process which is entirely automated and to the reproducible thickness of the PU layer deposited with the spray system.

Evaluation of the Glucose Sensor with PU Outer Layer in Human Serum and Blood of Diabetic Rabbits

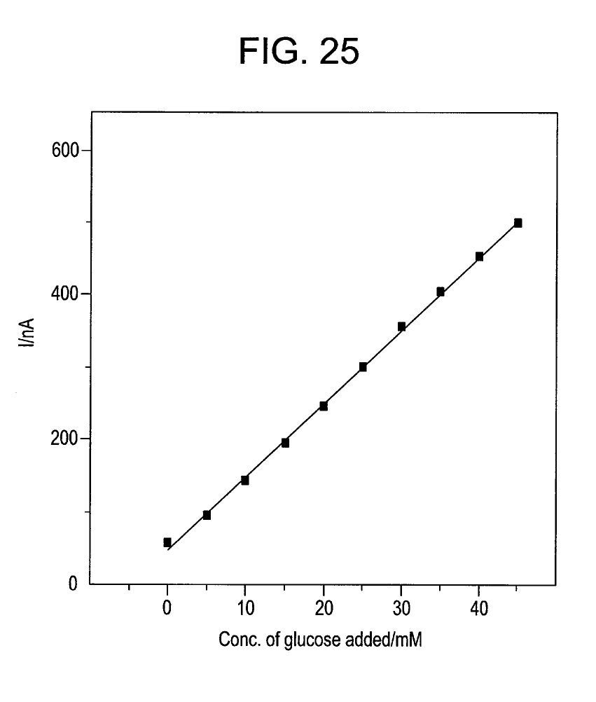

FIG. 25 shows a calibration curve of glucose concentration in human serum using the standard addition method of a sensor manufactured using AC-EPD (160Vp-p, 30 Hz, 20 min) and covered with a PU outer layer (15 sprays). The initial amperometric response in human serum after stabilization of the background was 57±2 nA, and the amperometric response to the successive injections of 5 mM glucose are very close to this background current. It can be seen that the sensor is linear up to 45 mM glucose. The average value of the glucose concentration of the human serum used for this study obtained from four different sensors was 5.2±0.5 mM. As the glucose concentration in the human serum given by Sigma-Aldrich (product H4522) is 4.89 mM, the error of the sensor with the outer layer of PU is less than 6% which compares favorably to the error found without PU layer (15%).

The complete sensor with PU outer layer was used to monitor the glucose concentration in two sick rabbits. Table 5 compares the glucose concentration measured by a commercial instrument (Hemocue glucose 201+) and that measured using the glucose sensor manufactured as reported for FIG. 22A in blood of two different sick rabbits.

TABLE 5

| Rabbit | Glucose meter/mM | Glucose sensor/mM |
|---|---|---|
| 1 | 11.00 | 11.57 |
| 2 | 22.20 | 21.35 |

The results from the glucose sensor are within 5% error of the values obtained with the commercial glucose meter. Hence we believe that the sensor is a good candidate for the real time monitoring of glucose in biological samples.

The presence of the outer polyurethane layer results in a considerable improvement of the linearity and sensitivity. The PU layer increases the linearity, which permits the determination of higher glucose concentrations, i.e. in critically ill diabetic patients or in sick rabbits where the glucose concentration can be more than 30 mM. Also, with the PU layer, the sensitivity of the sensor in buffer solution was almost the same as in human serum or blood (decrease <7 nA). The biocompatible nature of the polyurethane membrane minimizes the adsorption of proteins as reported in 2007 by G. S. Wilson et al. in FEBS J., volume 274, pages 5452-5461, which otherwise blocks the diffusion of glucose and reduces the sensitivity of the sensor.

### Example 7

### Two-Enzyme Lactose Biosensor Based on β-Galactosidase and Glucose Oxidase Deposited by AC-EPD

The AC-signal was composed of two triangular, sine or square waves of opposite amplitude but with different height and duration as shown in FIG. 1. The half-cycle with high amplitude section and low duration time corresponded to the negative part of the AC-signal. However, the area of both waves was equal, so that the signal had no net DC component, i.e. the integral of the AC-signal over one period was zero. Before each experiment, the AC-signal was integrated to verify that the integral of the applied signal over one period was equal to zero. The biosensor electrode was connected to the electrode whose polarity with respect to the counter electrode changed positively for a longer time at low amplitude and became negative for a short duration at high amplitude.

The enzymes deposition was accomplished by the following route: the sensor electrode was immersed in an enzyme solution containing (10 mg GOx+90 mg β-Gal) dissolved in 1 mL ultrapure water. A platinum wire in the form of a spiral was used as a counter electrode and positioned around the sensor electrode. This configuration permitted the electrophoretic deposition of a homogeneous bi-enzyme layer on the cylindrical sensor electrode. The asymmetrical AC-signal was then applied at 30 Hz and 120 Vₚ₋ₚ for period of 30 min. Next, the sensor was rinsed gently with ultrapure water and then tested in 5 mL phosphate-citrate buffer solution at various pHs and temperatures by injecting 10 μL of lactose (1.4 mM).

A potentiostat (CMS 100, GAMRY) connected to a computer for data acquisition was used for the testing the sensors (amperometry). AgCl/Ag was used as a reference electrode, and the polarization was set at +0.65 V vs. AgCl/Ag.

### Lactose Sensor Based on AC-EPD of β-Gal and GOx

The high ratio of β-Gal needed for the enzyme mixture can also be related to the low activity of β-Gal enzyme used in this study. Compared to literature where high β-Gal activities (>260 units/mg) were used [see I. Eshkenazi et al. in J. Dairy Sci. 83 (2000) 1939-1945; H. Gulce et al. in Analytical Sciences 18 (2002) 147-150; C. Loechel in Z. Lebensm Unters Forsch A 207 (1998) 381-385; Y. Xu et al. in Enzyme Microb. Technol. 12 (1990) 104-108; and N. Adanyi at al. in Eur. Food Res. Technol. 209 (1999) 220-226], in this study the activity of β-Gal was only 9 units/mg. On the other hand, the low applied amplitude of 120 Vₚ₋ₚ used for deposition compared to the optimal value of 160 Vₚ₋ₚ reported for Gox by M. Ammam et al. in Biosensors and Bioelectronics 25 (2009) 191-197; and in Sensors and Actuators B: Chemical, 145 (2010) 46-53] was due to the presence of a high amount of salts in β-Gal. These salts increased the conductivity of the bi-enzyme solution thereby increasing the electrolytic decomposition of water (AC-electrolysis), which in turn resulted in a low deposition rate.

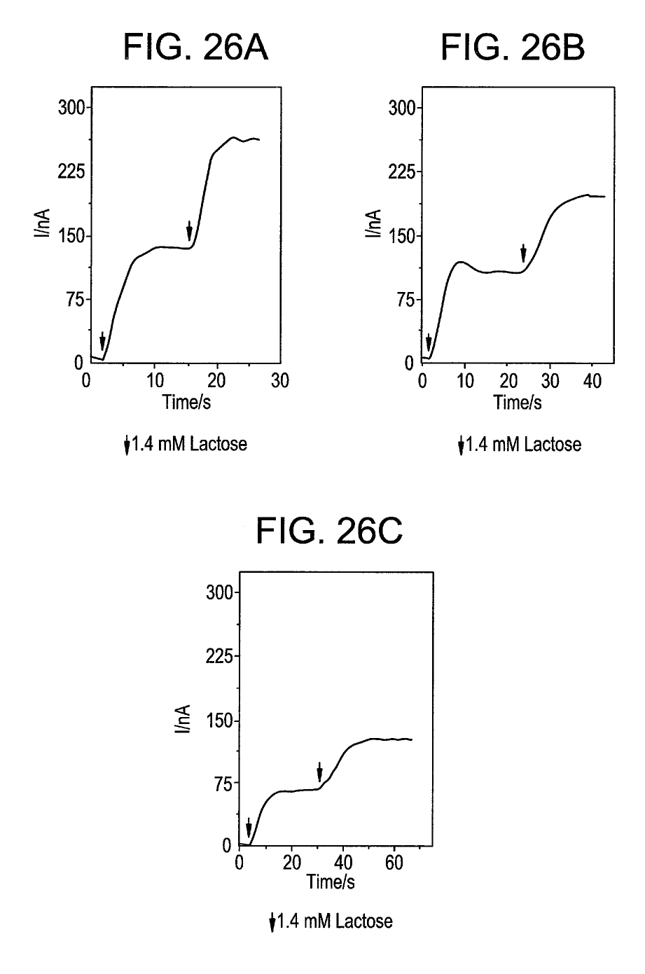

M. Ammam et al reported in Biosensors and Bioelectronics 25 (2009) 191-197, that asymmetry in the triangular AC waveform was an important parameter for the electrophoretic mobility as well as for deposition of the enzyme on the substrate. Two other asymmetrical AC waves (sine and square) are shown in FIGS. 1B and 1C in the amperometric response of the prepared electrodes. FIG. 26 shows a comparison between the current response to 1.4 mM lactose of the bi-enzyme layer deposited on a platinum substrate at 30 Hz, 120 Vₚ₋ₚ for 30 min using triangular, sine and square AC waves. It will be noted that under the same conditions, the amperometric response of the bi-enzyme electrode manufactured using the triangular wave was higher than that prepared using a sine wave, and the electrode prepared with square wave also exhibited a lower sensitivity. The deposition rate for each electrode was also measured using a microbalance and the results are gathered in Table 6.

TABLE 6

| AC waveform | Triangular | Sine | Square |
|---|---|---|---|
| (β-Gal + GOx) mass deposited on | 3.74 | 3.05 | 2.53 |
| platinum substrate [μg · mm⁻²] | | | |

Table 6 shows that the deposition rates follow the order of values of the amperometric responses observed in FIG. 26. In other words, the deposition rate using triangular wave was higher than that obtained with sine wave, which in turn was higher than the rate obtained using a square wave. This may be due to AC-electrolysis. During deposition, excessive gas bubble formation on the electrodes was observed when sine and square waves were applied. This excessive electrolytic decomposition of water may decrease the deposition rate and denaturize some of the deposited enzymes, leading to a low amperometric response. In order to keep the highest current response of the bi-enzyme electrode, the asymmetrical triangular wave was used for the rest of the study.

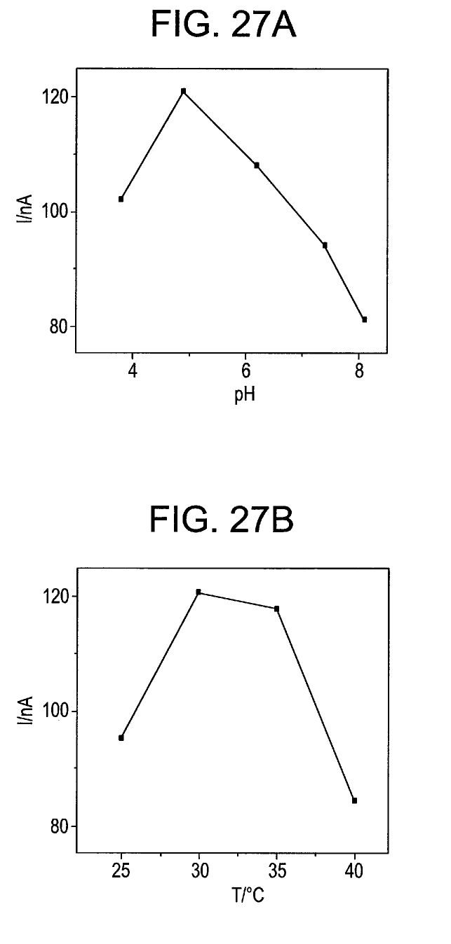

For each of the two enzymes present on the electrode, there was an optimal pH and temperature: for β-Gal it was pH 4.5 at 30° C. and for GOx it was pH 5.1 at 35° C. To determine the optimal pH and temperature for the combination of the two enzymes, the pH of the testing solution was varied from 3.9 to 8.2, and the temperature was varied between 25 and 40° C. The current response of the sensor manufactured under the optimal conditions indicated above versus pH and temperature of the testing buffer solution are shown in FIGS. 27A and 27B respectively. As can be seen at ˜pH 4.5 to pH 5 and temperature of 30 to 35° C., the reactions generated the highest current response. Therefore, pH 4.9 and 30° C. were selected as optimal testing parameters.

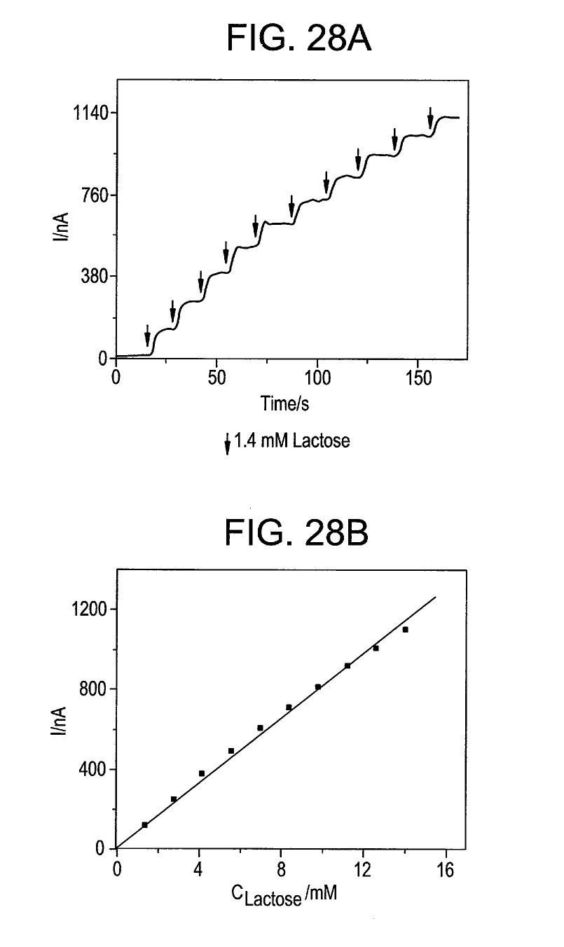

The deposition of the two enzymes β-Gal and GOx and testing of the sensors under the above optimal parameters led to high response of the bi-enzyme electrode to lactose. FIG. 28A shows the amperometric response of the sensor to several injections of 1.4 mM lactose. The current response to lactose of ˜111 nA/mM·mm² can be obtained with these electrodes. Compared to the sensitivities reported in literature [see I. Eshkenazi et al. in J. Dairy Sci. 83 (2000) 1939-1945; H. Gulce et al. in Analytical Sciences 18 (2002) 147-150; C. Loechel in Z. Lebensm Unters Forsch A 207 (1998) 381-385; Y. Xu et al. in Enzyme Microb. Technol. 12 (1990) 104-108; and N. Adanyi at al. in Eur. Food Res. Technol. 209 (1999) 220-226], this sensitivity is high considering the low activity of the enzymes employed in this study (9 units/mg for β-Gal and 5.6 units/mg for GOx), compared to literature where at least 260 units/mg was used [see I. Eshkenazi et al. in J. Dairy Sci. 83 (2000) 1939-1945; H. Gulce et al. in Analytical Sciences 18 (2002) 147-150; C. Loechel in Z. Lebensm Unters Forsch A 207 (1998) 381-385; Y. Xu et al. in Enzyme Microb. Technol. 12 (1990) 104-108; and N. Adanyi at al. in Eur. Food Res. Technol. 209 (1999) 220-226]. This sensitivity also demonstrates as pointed out before that the rate determining reaction is the hydrolysis of lactose by β-Gal because, as M. Ammam et al. reported in Biosensors and Bioelectronics 25 (2009) 191-197; and in Sensors and Actuators B: Chemical, 145 (2010) 46-53, using only GOx the obtained current responses are much higher. On the other hand, this reasonable sensitivity has a good impact on the linearity of the biosensor. As shown in FIG. 28B, the response of the sensor without employing any outer polymer layer to regulate the diffusion of lactose and oxygen fluxes was linear up to 14 mM lactose. This linearity was 3-4 times higher than that reported in the literature [see I. Eshkenazi et al. in J. Dairy Sci. 83 (2000) 1939-1945; H. Gulce et al. in Analytical Sciences 18 (2002) 147-150; C. Loechel in Z. Lebensm Unters Forsch A 207 (1998) 381-385; Y. Xu et al. in Enzyme Microb. Technol. 12 (1990) 104-108; N. Adanyi at al. in Eur. Food Res. Technol. 209 (1999) 220-226; and S. K. Sharma et al in Biosensors and Bioelectronics 20 (2004) 651-657]. This extended linearity is probably due to the reasonable sensitivity. Since the current response to 1.4 mM was not too high, the available dissolved oxygen around the sensing part of the electrode was consumed slowly. As displayed in FIG. 28A, the sensor also had a fast response time, reaching 95% of the final value in less than 10 s. The detection limit of the lactose sensor prepared by AC-EPD was less than 0.1 mM (S/N=3). However, it is important to note that lactose, typically measured in milk and dairy products, is present at high concentration (>100 mM) and therefore does not pose detection limit problems. Finally, in regard to selectivity of this biosensor, since each diary product possesses different interferences, it would be more appropriate to adjust the sensor fabrication for each product. The main characteristics of the bi-enzyme electrode (β-Gal+GOx) biosensor shown in FIG. 28A are given in Table 7.

TABLE 7

| area | 0.78 | mm² |
|---|---|---|
| sensitivity | 111 ± 2 nA/1 mM lactose | |
| Linearity | 0.1 to 14 | mM lactose |
| response time | 8 ± 1 | s |
| detection limit | <0.1 | mM lactose |

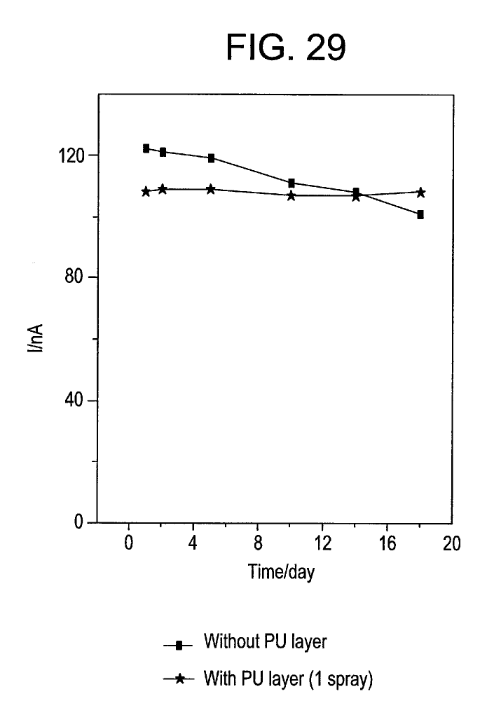

FIG. 29 shows the current response to lactose of the biosensor without stabilizing polymer or outer membrane for a period of 3 weeks. The sensor was stored in air at room temperature and the response to lactose was checked every 2 to 5 days. The absence of stabilizing polymer or outer membrane layer enables the activity of the bi-enzyme layer itself to be evaluated as a function of time. The response to lactose was quasi-stable during the first week but showed a continuous decrease during the last two weeks. This may be attributed to the continuous dissolution of the deposited bi-enzyme layer after each supplementary test in the buffer solution. FIG. 29 shows that the stability of the sensor could be improved by applying a thin layer of polyurethane (PU) prepared by the procedure reported by M. Ammam et al. in Sensors and Actuators B: Chemical, 145 (2010) 46-53; and in Biosensors and Bioelectronics 25 (2010) 1597-1602. However, with PU outer layer present (1 spray) the sensitivity of the sensor decreased slightly from ˜111 to ˜98 nA/mM·mm². The PU outer layer may be useful if the sensor is used for continuous measurements, but is not necessary if the sensor is used for 1 or 2 tests. The reproducibility of the biosensor response was estimated to be ˜85%, which is due to the automated manufacturing process.

### Determination of Lactose in Milk Samples

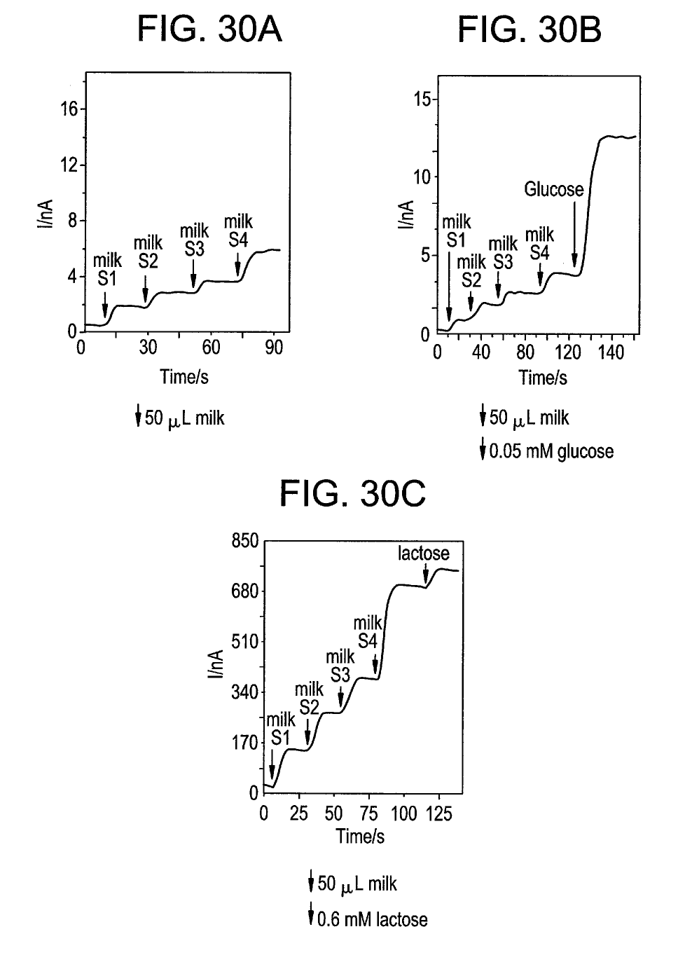

The performance of the lactose sensor manufactured using AC-EPD techniques was evaluated using different milk samples. Since the sensor was to be use only once, no outer layer of PU was necessary. The presence of electroactive species such as uric acid, ascorbic acid or others in milk may generate a current response due to polarization of the Pt electrode at +0.65 V vs. AgCl/Ag. Therefore, the milk samples were first tested on a polarized Pt electrode. With continuous stirring, the clean Pt electrode and a reference AgCl/Ag were immersed in a 5 mL buffer solution pH 4.9 at 30° C. The Pt electrode was polarized at +0.65 V vs. AgCl/Ag and injection of 50 μL milk from each sample was carried out once a stable background current had been obtained. FIG. 30A shows the current response to 50 μL whole, skimmed, semi-skimmed and whole extra concentrated milk, respectively on the clean unmodified polarized Pt electrode. As can be seen, 1-2 nA current increase was observed for each sample, meaning that some electroactive species were present in the milk samples. In addition, it can also be seen that the extra concentrated milk (S4) contained relatively high amounts of interferences compared to the other samples. However, since the current response was very low (less than 2 nA), the effect of interferences on lactose determination will be negligible because of the relatively high sensitivity of the biosensor towards lactose (˜111 nA/mM·mm²). Furthermore, M. Ammam et al. in Sensors and Actuators B: Chemical, 145 (2010) 46-53 reported that the enzyme layer deposited by means of AC-EPD screens out a large part of the interferences, and since the concentration of the interferences in the milk samples was very low, the bi-enzyme layer will probably entirely screen them out. The second potential interference to be considered is the presence of glucose traces in milk samples and, because the bi-enzyme layer contains GOx, it will respond to glucose. In order to obtain a better idea about the current response to the interference glucose present in milk samples, GOx was deposited at the same concentration as that used for deposition of the two enzymes (10 mg/mL) and under the same applied parameters of 30 Hz, 120 Vₚ₋ₚ for 30 min. The Pt modified GOx was then immersed in 5 mL buffer under the same conditions as previously described, and injections of 50 μL milk samples were carried out followed by an injection of 0.05 mM glucose for calibration. The results are shown in FIG. 30B. Ammam et al. in Sensors and Actuators B: Chemical 145 (2010) 46-53 previously showed that glucose sensors manufactured using the AC-EPD procedure exhibited extended linearity up to 20 mM without an outer layer of polyurethane. Therefore, at such low concentrations, linearity does not pose problems and one calibration point would be enough to estimate the glucose level in milk samples. As can be seen in FIG. 30B, the amperometric response was low (<1 nA), meaning that the concentration of glucose in milk samples was low. The concentrations of glucose estimated from FIG. 30B for the different milk samples, assuming the entire rejection of the interferences by the bi-enzyme layer, are given in Table 8. These concentrations are close to the glucose concentrations in milk samples reported by V. Rajendran et al, in J. Diary Sci. 85 (2002) 1357-1361. The estimated glucose concentrations are very low to interfere with the lactose measurements. However, for more accurate determination of lactose, it is possible to subtract these values from the concentrations estimated by the bi-enzyme (GOx+β-Gal) electrode. The concentration of lactose can be accurately determined by the bi-enzyme modified Pt electrode, after examining the current responses to the two main interferences (acids and glucose). FIG. 30C shows the current response to 50 μL whole (S1), skimmed (S2), semi-skimmed (S3) and whole extra concentrated milk (S4) respectively, followed by an injection of 0.6 mM lactose as a calibration point. It can be seen that the current response to the three first injections (whole (S1), skimmed (S2), semi-skimmed (S3)) are practically equal, indicating a similar level of lactose in these samples. However, the level of lactose in the last sample (whole extra concentrated milk (S4)) appears to be much higher. The estimated concentrations of glucose and lactose in the different milk samples purchased from SPAR supermarket and Nutroma and laboratory reference for lactose concentrations from FIG. 30C are given in Table 8.

TABLE 8

| | glucose concentration | Lactose concentration | Laboratory |
|---|---|---|---|
| | determined with glucose | determined with | reference for |
| Milk sample | sensor [mM] | lactose sensor [mM] | lactose [mM] |
| Whole milk (S1) | 0.50 | 141.45 | 139.81 |
| Skimmed milk(S2) | 0.41 | 139.17 | 142.90 |
| Semi-skimmed milk (S3) | 0.46 | 137.62 | 142.91 |
| Whole milk extra concentrated (S4) | 0.75 | 326.25 | 321.06 |

It can be seen that the lactose concentration values are very close to the laboratory lactose concentrations provided by the producers. The good agreement between the data indicates the reliability of the present sensor for lactose determination in real milk samples.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

All patents, patent applications, patent application publications, and other publications (including any manufacturer's specifications, instructions etc.) cited or referred to in this specification are herein incorporated by reference to the same extent as if each independent patent, patent application, patent application publication or publication was specifically and individually indicated to be incorporated by reference. There is no admission that any document cited is indeed prior art of the present invention.

What is claimed is:

1. A coating process comprising the steps of:
a) immersion of a conductive substrate in an aqueous dispersion with a conductivity lower than 100 μS/cm, said aqueous dispersion containing at least one biological agent, and
b) application of an unbalanced (asymmetrical) AC signal between a counter electrode and said conductive substrate at defined frequency and amplitude between said counter electrode and said conductive substrate to induce said at least one biological agent to migrate electrophoretically, accumulate and form a bioactive deposit or bioactive coating on said conductive substrate over a period of time, wherein said bioactive deposit or bioactive coating is a biologically active film with a stacking of more than one monolayer.

2. The process according to claim 1, whereby said counter electrode is immersed in said aqueous dispersion.

3. The process according to claim 1, whereby the unbalanced (asymmetrical) AC signal is a signal that has no net DC component or of which the net DC component is lower than the threshold value for the electrolytic decomposition of water.

4. The process according to claim 1, whereby the net DC component of the applied unbalanced (asymmetrical) AC-signal over one period is in absolute value lower than 1.23 V in order not to decompose the water.

5. The process according to claim 1, whereby the integral of the unbalanced (asymmetrical) AC-signal over one period is zero or almost zero or of which the DC component is lower than the threshold value for the electrolytic decomposition of water.

6. The process according to claim 1, whereby the unbalanced (asymmetrical) AC signal is a signal wherein the negative part of the signal is different from the positive part but of which the integral of the AC-signal over one period is zero or almost zero.

7. The process according to claim 1, whereby the unbalanced (asymmetrical) AC signal does not cause electrolysis or decomposition of water in an extent to disturb the formation of a smooth coating.

8. The process according to claim 1, whereby said biologically active film has an average thickness above 100 nm.

9. The process according to claim 1, whereby said biologically active film has an average thickness in the μm scale for instance more than 10 μm.

10. The process according to claim 1, whereby the very low conductivity is no more than 50 μS/cm or no more than 30 μS/cm.

11. (canceled)

12. The process according to claim 1, whereby the applied frequency is in a range of 15 to 80 Hz or in the range of 30 to 50 Hz.

13. (canceled)

14. The process according to claim 1, whereby the applied amplitude is in a range of 80 to 300 Vₚ₋ₚ or in the range of 160 to 200 Vₚ₋ₚ.

15. (canceled)

16. The process according to claim 1, whereby the AC signal is been applied for over a period of time of 20 to 40 minutes to achieve more than one monolayer on said substrate.

17. The process according to claim 1, whereby said conductive (deposition) substrate is a non corrosive metal.

18. The process according to claim 1, whereby said conductive (deposition) substrate is a platinum electrode.

19. The process according to claim 1, whereby said conductive (deposition) substrate is a biosensor electrode.

20. The process according to claim 1, whereby said at least one biological agent is a biomolecule, a living cell or a component thereof, or at least one enzyme.

21-22. (canceled)

23. The process according to claim 20, whereby said at least one enzyme is glucose oxidase, or β-galactosidase and glucose oxidase.

24. (canceled)

25. The process according to claim 1, whereby 50 mg of Gox 5.6 units/mg enzyme is dissolved per 0.5 mL NaOH-water at conductivity lower than 100 μS/cm.

26. The process according to claim 1, whereby the thickness of the deposit is controllable.

27. The process according to claim 1, wherein said process further comprises the provision of a polyurethane coating of controllable thickness.

28. The process according to claim 27, wherein said polyurethane coating is provided by using a polyurethane spray.

29. An EPD system for electrocoating a conductive substrate, said system comprising a power supply connected to a signal generator to generate an unbalanced (asymmetrical) alternating current (AC) signal with a frequency in the range of 15 to 80 Hz and an amplitude of 80 to 300 Vₚ₋ₚ and preferably with a frequency in the range of 30 to 50 Hz and an amplitude of 160 to 200 Vₚ₋ₚ and, furthermore comprises a control system connected to signal generator for determining the parameters of the unbalanced (asymmetrical) AC, wherein said system is for electrocoating a conductive substrate with at least one bioactive layer, or bioactive coating comprising at least one type of a biological agent at a controllable average thickness above 100 nm, from a suspension in a aqueous working medium of one or more type of biological agents.

30. The system according to claim 29, whereby said control system is connected to said signal generator for determining the frequency or amplitude of the unbalanced (asymmetrical) AC.

31. The system according to claim 29, whereby said biological agent is a living cell or biomolecule.

32. The system according to claim 29, whereby said control system comprises a function generator and an amplifier (amp).

33. (canceled)

34. The system according to claim 29, whereby the system further comprises a sensor system for transmitting information regarding the electrophoretic deposition response to the unbalanced (asymmetrical) alternating current in the electrophoretic deposition aqueous medium, and a pump system acting in response to the information communicated to the pump system to deliver a responsive dose of appropriate cells, biological agents, biomolecules or a responsive of a dose of an appropriate conductivity regulating agent in the electrophoretic deposition aqueous medium.

35. An EPD system for electrocoating a conductive substrate, said system comprising a amplifier connected to a function generator to generate an unbalanced (asymmetrical) alternating current (AC) signal with a frequency in the range of 15 to 80 Hz and an amplitude of 80 to 300 Vₚ₋ₚ and, preferably with a frequency in the range of 30 to 50 Hz and an amplitude of 160 to 200 Vₚ₋ₚ and furthermore comprises a control system connected to signal generator for determining the parameters of the unbalanced (asymmetrical) AC, wherein said system is for electrocoating a conductive substrate with a stacking of more than one bioactive monolayer comprising at least one type of a biological agent at a controllable thickness from a suspension in a aqueous working medium comprising one or more type of biological agents.

36. The system according to claim 35, whereby said control system is connected to said signal generator for determining the frequency or amplitude of the unbalanced (asymmetrical) AC.

37. The system according to any of claim 35, whereby said biological agent is a living cell or biomolecule.

38. The system according to claim 35, whereby said signal generator is an auxiliary electrode that is powered by the power supply under control of the control system generating the asymmetric electrical potential, without electrolysing the aqueous working solution between the conductive working substrate between said the auxiliary electrode in an extend to disturb the deposition of smooth layers.

39. The system according to claim 35, whereby said control system comprises a function generator and an amplifier (amp).

40. (canceled)

41. The system according to claim 35, whereby the system further comprises a sensor system for transmitting information regarding the electrophoretic deposition response to the unbalanced (asymmetrical) alternating current in the electrophoretic deposition aqueous medium, and a pump system acting in response to the information communicated to the pump system to deliver a responsive dose of appropriate cells, biological agents, biomolecules or a responsive of a dose of an appropriate conductivity regulating agent in the electrophoretic deposition aqueous medium.

42. A method of forming smooth deposits of at least one biological agent on a conductive substrate, for instance an implant, said smooth deposits having no visible defects and having a surface with a Ra of 10 to 50 μm, preferably a Ra of 10 to 10000 nm, more preferably a Ra of 10 to 500 nm, and most preferably a Ra of 10-200 nm, said method using a coating process comprising the steps of: a) immersion of a conductive substrate in an aqueous dispersion with a conductivity lower than 100 μS/cm, said aqueous dispersion containing at least one biological agent, and b) application of an unbalanced (asymmetrical) AC signal between a counter electrode and said conductive substrate at defined frequency and amplitude between said counter electrode and said conductive substrate to induce said at least one biological agent to migrate electrophoretically, accumulate and form a bioactive deposit or bioactive coating on said conductive substrate over a period of time, wherein said bioactive deposit or bioactive coating is a biologically active film with a stacking of more than one monolayer; or using an EPD system for electrocoating a conductive substrate, said system comprising a amplifier connected to a function generator to generate an unbalanced (asymmetrical) alternating current (AC) signal with a frequency in the range of 15 to 80 Hz and an amplitude of 80 to 300 Vₚ₋ₚ and, preferably with a frequency in the range of 30 to 50 Hz and an amplitude of 160 to 200 Vₚ₋ₚ and furthermore comprises a control system connected to signal generator for determining the parameters of the unbalanced (asymmetrical) AC, wherein said system is for electrocoating a conductive substrate with a stacking of more than one bioactive monolayer comprising at least one type of a biological agent at a controllable thickness from a suspension in a aqueous working medium comprising one or more type of biological agents.

43. The method according to claim 42, wherein said substrate is selected from the group consisting of a cardiovascular implants [for instance cathether or stent (e.g. a self-expandable, balloon-expandable stent or heart valve)] and blood contacting implants (e.g. a continuous blood glucose sensor).

44. The method according to claim 42, wherein said biological agent prevents fibrosis formation or the development of excess fibrous connective tissue and said biological agent is selected from the group consisting of enzymes, organic catalysts, ribozymes, organometallics, proteins, glycoproteins, peptides, polyamino acids, antibodies, nucleic acids, steroidal molecules, antibiotics, antimycotics, cytokines, carbohydrates, oleophobics, lipids, viruses, and prions.

45. The method according to claim 42, wherein said biological agent is a bone-morphogenic protein.

46. The method according to claim 42, wherein said biological agent is a bioabsorbable biological agent such as heparin, fibrin, fibrinogen, cellulose, starch, and collagen.

47. The method according to claim 42, wherein said biological agent is a biological agent which enhances the biocompatibility of said conductive substrate or prevents a pathological tissue reaction after implantation.

48. The method according to claim 42, wherein said biological agent promotes endothelial cell spreading or retention.

49. The method according to claim 42, wherein said biological agent promotes endothelial cell spreading or retention and said biological agent is selected from the group consisting of Arg-Gly-D, Arg-Glu-D-Val, fibrin, fibronectin, laminin, gelatin, collagen, basement membrane proteins, and partial sequences of fibrin, fibronectin, laminin, gelatin, collagen, and basement membrane proteins.

50. The method according to claim 42, wherein said biological agent is a biological agent for recruiting cells circulating in the blood stream of a subject to the blood contacting coating.

51. The method according to claim 42, wherein said biological agent is a biological agent for the recruitment of endothelial progenitor cells to implant surfaces.

52. The method according to claim 42, wherein said biological agent is a biological agent for the recruitment of endothelial progenitor cells to implant surfaces whereby the biological agents is selected from the group consisting of ligands that bind to CD34, CD133, polysaccharides, KDR (VEGFR-2), P-selectin, E-selectin, αvp3, glycophorin, CD4, integrins, lectins and VE-I Cadherin.

53. The method according to claim 42, wherein said biological agent is a biological agent that prevents thrombosis or chronic instability, such as calcification, of the implant surface.

54. The method according to claim 42, wherein said biological agent is a biological agent that prevents restenosis.

55. The method according to claim 42, wherein said conductive substrate is a sensor electrode and said biological agent is an enzyme and said thereby coated sensor electrode is used for detecting an analyte.

56. The method according to claim 42, wherein electrodes of a biobattery are coated.

57. A method of manufacturing a biobattery, said method using a coating process comprising the steps of: a) immersion of electrodes in an aqueous dispersion with a conductivity lower than 100 μS/cm, said aqueous dispersion containing at least one biological agent, and b) application of an unbalanced (asymmetrical) AC signal between a counter electrode and said conductive substrate at defined frequency and amplitude between said counter electrode and said conductive substrate to induce said at least one biological agent to migrate electrophoretically, accumulate and form a bioactive deposit or bioactive coating on said electrodes over a period of time thereby providing electrodes of said biobattery, wherein said bioactive deposit or bioactive coating is a biologically active film with a stacking of more than one monolayer; or using an EPD system for electrocoating electrodes, said system comprising a amplifier connected to a function generator to generate an unbalanced (asymmetrical) alternating current (AC) signal with a frequency in the range of 15 to 80 Hz and an amplitude of 80 to 300 Vₚ₋ₚ and, preferably with a frequency in the range of 30 to 50 Hz and an amplitude of 160 to 200 Vₚ₋ₚ and furthermore comprises a control system connected to signal generator for determining the parameters of the unbalanced (asymmetrical) AC, wherein said system is for electrocoating electrodes with a stacking of more than one bioactive monolayer comprising at least one type of a biological agent at a controllable thickness from a suspension in a aqueous working medium comprising one or more type of biological agents, thereby providing electrodes of said biobattery.

58. A method of manufacturing a sensor, said method using a coating process comprising the steps of: a) immersion of a conductive substrate in an aqueous dispersion with a conductivity lower than 100 μS/cm, said aqueous dispersion containing at least one biological agent, and b) application of an unbalanced (asymmetrical) AC signal between a counter electrode and said conductive substrate at defined frequency and amplitude between said counter electrode and said conductive substrate to induce said at least one biological agent to migrate electrophoretically, accumulate and form a bioactive deposit or bioactive coating on said conductive substrate over a period of time thereby providing a coated sensor electrode, wherein said bioactive deposit or bioactive coating is a biologically active film with a stacking of more than one monolayer, said at least one biological agent is at least one enzyme and said coated sensor electrode is used for detecting an analyte; or using an EPD system for electrocoating a conductive substrate, said system comprising a amplifier connected to a function generator to generate an unbalanced (asymmetrical) alternating current (AC) signal with a frequency in the range of 15 to 80 Hz and an amplitude of 80 to 300 Vₚ₋ₚ and, preferably with a frequency in the range of 30 to 50 Hz and an amplitude of 160 to 200 Vₚ₋ₚ and furthermore comprises a control system connected to signal generator for determining the parameters of the unbalanced (asymmetrical) AC, wherein said system is for electrocoating a conductive substrate with a stacking of more than one bioactive monolayer comprising at least one type of a biological agent at a controllable thickness from a suspension in a aqueous working medium comprising one or more type of biological agents thereby providing a coated sensor electrode, wherein said at least one biological agent is at least one enzyme and said coated sensor electrode is used for detecting an analyte.

59. The method according to claim 58, wherein said analyte is monitored in real-time.

60. The method according to claim 59, wherein said analyte is measured in a biological sample.

61. The method according to claim 60, wherein said biological sample is an animal sample.

62. The method according to claim 61, wherein said animal sample is taken from a healthy or a sick animal.

63. (canceled)

64. A sensor comprising an electrode with a electrophoretically deposited enzyme layer on said surface thereof and a layer of polyurethane coating in this order, wherein said electrophoretic deposition is realised with an unbalanced (asymmetrical) AC signal between a counter electrode and said electrode at defined frequency and amplitude between said counter electrode and said conductive substrate.

65. The sensor according to claim 64, wherein said sensing enzyme layer is a layer of glucose sensing enzyme with an average thickness of at least 10 micrometer, said sensor electrode has an activity response that exceeds 4600 nA/mm² for a 5 mM glucose injection (according to the test described in U.S. Pat. No. 6,814,845 B2), and has a maintained selectivity stability after being repeatedly used for glucose sensing (e.g. 100 times a day), having a selectivity stability of up to about ±90% relative to the initial selectivity of the sensor for a period of at least 45 days.

66. The sensor according to claim 65, whereby said sensing enzyme layer has been electrocoated on said electrode.

67. The sensor according to claim 65, which has a response time of 5 seconds or less.

68. The sensor of claim 65, which is bio compatible and non toxic.

69. The sensor of claim 65, which can maintain more than 90% of its response up to 20 mM glucose when the oxygen concentration is over 50 torr.

70. The sensor of claim 65, which has a response time of 5 seconds or less and can maintain more than 90% of its response up to 20 mM glucose when the oxygen concentration is over 50 torr.

71. The sensor according to claim 64, wherein said enzyme is glucose oxidase and said sensor is a glucose microbiosensor.

72. The sensor according to claim 64, wherein said enzyme layer comprises glucose oxidase.

73. The sensor according to claim 64, wherein said sensor is a glucose microbiosensor or a lactose microbiosensor.

74-76. (canceled)
